(19) United States
(12) Patent Application Publication
(10) Pub. No.: US 2024/0340314 A1
(43) Pub. Date: Oct. 10, 2024

(54) SYSTEM FOR GENERATING SAMPLES TO GENERATE MACHINE LEARNING MODELS TO FACILITATE DETECTION OF SUSPICIOUS DIGITAL IDENTIFIERS

(71) Applicant: Lookout, Inc., Boston, MA (US)

(72) Inventors: Aungon Nag Radon, Toronto (CA); Fatin Ridwan Haque, Kitchener (CA)

(21) Appl. No.: 18/486,995

(22) Filed: Oct. 13, 2023

Related U.S. Application Data
(63) Continuation-in-part of application No. 18/295,766, filed on Apr. 4, 2023.

(51) Int. Cl. H04L 9/40; G06N 20/00

(52) U.S. Cl. CPC H04L 63/1483; G06N 20/00; H04L 63/1425

(57) ABSTRACT

A system for generating samples to generate machine learning models to detect suspicious digital identifiers is disclosed. The system creates a novel balanced-categorized sample generation mechanism for building machine learning models so that the samples are balanced and not biased to any particular class label, such as suspicious or non-suspicious. The system initiates training of a machine learning model and obtains a labeled dataset containing samples verified as suspicious or non-suspicious. The system computes, based on a configuration to generate a balanced labeled dataset, a sampling weight for the samples. Using the computed sampling weight, the system performs sampling on the suspicious and non-suspicious samples over a time period. The system merges the sampled suspicious and non-suspicious samples to form a balanced labeled dataset and generates categorized labeled samples therefrom. The categorized labeled samples are utilized to train machine learning models to identify whether a digital identifier is suspicious.

### RELATED APPLICATIONS

The present application is a continuation in part of U.S. patent application Ser. No. 18/295,766 filed Apr. 4, 2023, the entire disclosure of which application is hereby incorporated herein by reference.

### FIELD OF THE TECHNOLOGY

At least some embodiments disclosed herein relate to machine learning technologies, cybersecurity technologies, intrusion detection technologies, machine learning model selection technologies, network technologies, and more particularly, but not limited to, a machine learning system for generating samples to generate machine learning models to facilitate detection of suspicious digital identifiers.

### BACKGROUND

With society becoming increasingly reliant on technology to conduct business, communications, and other activities, the various forms of technologies that facilitate such activities have become increasingly under attack by malicious actors. Malicious actors deploy a variety of cyberattacks including, but not limited to, denial-of-service attacks, phishing attacks, spoofing attacks, social engineering attacks, malware attacks, zero-day exploits, among other attacks to gain control of accounts, financial resources, identities, and the like. As a specific example, phishing attacks, which often involve the use of suspicious uniform resource locators (URLs) or fully qualified domain names (FQDNs) to deceive users, are some of the most common mechanisms that malicious actors use to execute a cyberattack. A URL, for example, can be a web address that serves as a reference to a resource (e.g., web resource) that specifies the resource's location on a communications network and the mechanism by which the resource is accessed or retrieved. An exemplary URL would be http://www[.]exampleurl[.]com/index.html, where http indicates the protocol, www[.]exampleurl[.]com is the hostname, and index.html is the filename. A FQDN, for example, can include the complete address of a website, computer, or other entity that can be accessed by various systems, devices, and programs. An FQDN (e.g., www[.]samplefqdn[.]com) can include a hostname (e.g., www), a second-level domain name (e.g., samplefqdn), and a top-level domain name (e.g., com). In a typical attack, a malicious actor manually or programmatically adjusts the URL of a website to make the URL to appear as the URL for the legitimate website that can have online resources of interest to a user. Such adjustments to a URL can involve a simple spelling change (e.g., CocaKola.com), font change, extension change, or a permutation or combination of numerous changes that malicious actors have at their disposal. In certain scenarios, such changes are detectable to the naked eye, however, malicious actors have begun to utilize increasingly sophisticated techniques to deceive users more readily into interacting with harmful URLs, FQDNs, or other means for accessing content. Such techniques, for example, include typosquatting and URL shortening, which are nearly impossible to detect with the naked eye. Recently, hackers have developed generative artificial intelligence platforms to automatically generate malicious links and FQDNs.

Typosquatting is a technique utilized by malicious actors that typically involves generating a deceptive URL to appear as a legitimate URL to a user seeking to access digital resources. For example, the deceptive URL can contain a misspelling based on a typographical error, a common misspelling, a plural version of the text in the legitimate URL, adding strings to the legitimate URL, utilizing a different top-level domain, appending terms to the legitimate URL, among other types of deceptive modifications. URL shortening, on the other hand, is another technique in which a URL is made shorter than the legitimate URL by a malicious actor, but instead of directing the user to the intended digital resource redirects the user to a potentially-malicious resource. When users click on URLs made via techniques such as typosquatting or URL shortening, the users can become victims of cyberattacks. For example, when a user unwittingly clicks on a deceptive URL instead of the legitimate URL, the user can be redirected to a malicious website posing as the legitimate website. Once the user is redirected to the malicious website, the user can be deceived into providing personally-identifiable information, username and password combinations, financial information, and other private information. Malicious actors can then utilize such information to compromise user identities, take over bank accounts, apply for credit, and perform a variety of other malicious acts.

Currently, certain technologies and mechanisms exist to assist in the detection of malicious attacks, however, such technologies and mechanisms are not robust enough to thwart a sophisticated attacker. Additionally, while existing technologies provide various benefits, existing technologies often enable malicious attackers to alter URLs, FQDNs, or other mechanisms for accessing systems, content, or devices that effectively bypass such existing technologies. Furthermore, existing technologies are often constrained in their ability to adapt to changing techniques utilized by attackers. Based on at least the foregoing, technologies can be enhanced to provide enhanced suspicious URL detection capabilities, reduced ability for attackers to circumvent safeguards, and increased network and user device security, such as by using machine learning capabilities, while providing an enhanced user experience and a variety of other benefits.

### BRIEF DESCRIPTION OF THE DRAWINGS

The embodiments are illustrated by way of example and not limitation in the figures of the accompanying drawings in which like references indicate similar elements.

FIG. 1 illustrates an exemplary machine learning system for providing automated detection of suspicious digital identifiers according to embodiments of the present disclosure.

FIG. 2 illustrates an exemplary architecture to provide automated detection of suspicious digital identifiers for use with the system of FIG. 1 according to embodiments of the present disclosure.

FIG. 3 illustrates an exemplary architecture of a training pipeline service for use with the architecture of FIG. 2 according to embodiments of the present disclosure.

FIG. 4 illustrates an exemplary architecture of a sample generator for generating samples to create machine learning models to detect suspicious digital identifiers according to embodiments of the present disclosure.

FIG. 5 illustrates an exemplary architecture of an inference pipeline service for use with the architecture of FIG. 2 according to embodiments of the present disclosure.

FIG. 6 illustrates an exemplary architecture of a ranker for ranking suspicious digital identifiers for use with the architecture of FIG. 2 according to embodiments of the present disclosure.

FIG. 7 illustrates an exemplary list of characters confusable with each other and can be utilized to determine whether a uniform resource locator associated with an address associated with content is suspicious according to embodiments of the present disclosure.

FIG. 8 illustrates an exemplary list of kerning confusables that can be utilized to create a canonical kerning confusables uniform resource locator copy for matching to determine a degree of suspiciousness of a uniform resource locator according to embodiments of the present disclosure.

FIG. 9 illustrates an exemplary method for providing automated detection of suspicious digital identifiers using a machine learning system according to embodiments of the present disclosure.

FIG. 10 illustrates an exemplary method for generating samples to create machine learning models to facilitate detection of suspicious digital identifiers according to embodiments of the present disclosure.

FIG. 11 illustrates an exemplary method for providing automated model detection to facilitate detection of suspicious digital identifiers using a machine learning system according to embodiments of the present disclosure.

FIG. 12 illustrates a schematic diagram of a machine in the form of a computer system within which a set of instructions, when executed, can cause the machine to provide automated detection of suspicious digital identifiers according to embodiments of the present disclosure.

### DETAILED DESCRIPTION

The following disclosure describes various embodiments for a system 100 and accompanying methods for providing automated detection of suspicious digital identifiers (or simply identifiers) to mitigate cyberattacks and thwart malicious actors. The system 100 and methods utilize clients (e.g., phishing and content classifiers) to initiate requests to determine if digital identifiers, such as, but not limited to, addresses (e.g., web addresses), URLs, FQDNs, representations referencing web resources (e.g., visual, picture, image, perceptible, or other representations), or other mechanisms for accessing resources, that a user is attempting to access are suspicious. In certain embodiments, digital identifiers can also include resources, anything referenced by an identifier (e.g., devices, systems, programs, etc.), or a combination thereof. In certain embodiments, an identifier can be suspicious if the identifier directs a user to a web page that is malicious and/or fraudulent, the identifier is utilized to compromise a system, device, and/or program, the identifier is utilized by a malicious actor and/or system to execute a phishing attack, the identifier is utilized to compromise a network, the identifier is utilized to steal financial and/or login credentials (e.g., username and password) of a user and/or a user's contacts, the identifier is utilized to access personal or organizational information, the identifier is utilized to compromise and recruit a user device to participate in an attack (e.g., denial-of-service attack), the identifier is utilized to sign a user up for unwanted services (e.g., subscribe the user to spam or fraudulently charge and subscribe the user to services and products), the identifier is utilized to gain access to and/or control a user's device and/or devices communicatively linked to the user's device, the identifier is utilized for any other suspicious activity, or a combination thereof. In certain embodiments, the system 100 and methods can include providing the requests to an automated suspicious URL/FQDN detection system that includes an inference pipeline service and training pipeline service to facilitate the detection of suspicious digital identifiers, such as, but not limited to addresses, URLs, FQDNs, and/or other access mechanisms. In certain embodiments, the training pipeline service generates and trains machine learning models based on training data. When a request comes into the automated suspicious URL/FQDN detection system, the system 100 and methods, such as by utilizing the inference pipeline service, can include selecting a machine learning model from a model registry to perform the assessment as to whether the digital identifier is suspicious. The system 100 and methods can include computing or loading corresponding features (e.g., identifier features) associated with the digital identifier into the automated suspicious URL/FQDN detection system, and then execute the machine learning model using the identifier features to make the suspiciousness determination. In certain embodiments, the automated suspicious URL/FQDN can generate a response (e.g., an indication) indicating whether the digital identifier is suspicious and provide the response to the requesting client, such as by utilizing the inference pipeline service. In certain embodiments, if the digital identifier is determined to be suspicious, a user attempting to access a resource associated with or referenced by the digital identifier can be prevented from accessing the resource. In certain embodiments, the determination as to suspiciousness can be forwarded to experts, other systems, or a combination thereof, to verify the determination relating to the suspiciousness of the digital identifier. In certain embodiments, a suspiciousness score for the digital identifier can be generated to provide further context.

In certain embodiments, the machine learning models generated by the system 100 and methods can be trained over time, such as by utilizing the training pipeline service, to enhance the suspiciousness determination capability and other functionality of the machine learning models of the system 100. In certain embodiments, training pipeline service can receive labeled data (e.g., “class label” for a particular digital identifier (e.g., URL/FQDN)) from a database verified by an in-house security expert, researchers, and/or systems, or, in certain embodiments, can be gathered from any crowdsourced individuals, systems, or a combination thereof. In certain embodiments, the label for a digital identifier in the dataset can include a label indicating whether the digital identifier (or other data) is benign or suspicious, the suspiciousness score (e.g., degree of suspicion, which can be represented between 0 to 1 or any other scale) of the identifier, a type(s) of malicious attack associated with the digital identifier, an identity of a malicious actor and/or system associated with the digital identifier, any other labels, or a combination thereof. In certain embodiments, the training pipeline service can obtain labeled data (e.g., for a supervised machine learning technique) from the database or any such source in order to perform a training task and develop the machine learning models, which would be utilized by the inference pipeline service. In certain scenarios, it can be that not all decisions can be correct and hence, in certain embodiments, the system 100 and methods can utilize feedback from the human experts and/or other systems to verify or reject the decisions made by the system 100 and methods, such as those provided by the inference pipeline service of the system 100.

In certain embodiments, obtaining the feedback from human experts, systems, or a combination thereof, can be an automatic process. In certain embodiments, the training pipeline service can obtain the correct label of historical samples (e.g., samples of identifiers including, but not limited to, training samples, validation samples, and test samples) for which the decision can have been wrong in the past. In certain embodiments, the system 100 and methods can deploy a sampling strategy that can be configured to be utilized by the system 100 and methods to fetch new samples from the database in order to automatically retrain the system 100, and produce a new machine learning model without any human intervention in the model retraining process. In certain embodiments, the training process utilized by the training pipeline service obtaining a labeled dataset from the database and based on a suitable sampling strategy, data samples such as training samples, validation samples, and test samples can be computed from the original labeled dataset. In certain embodiments, the sampling strategy can comprise utilizing any number of training samples, validation samples, and/or test samples in the training process. In certain embodiments, the sampling strategy can include selecting only certain types of the samples for the training process. In certain embodiments, the sampling strategy can comprise utilizing only certain subsets of the samples in the labeled dataset. In certain embodiments, the sampling strategy can comprise utilizing only samples having certain types of features. In certain embodiments, the sampling strategy can be changed automatically based on time intervals, types of data present in new labeled datasets, and/or at will. In certain embodiments, the computed samples can be persisted into a sample store. Then, in certain embodiments, features (e.g., training features, such as, but not limited to, lexical, host based, image-based, content-based, and/or other features, such as those present in the labeled dataset) corresponding to each sample type can be computed and the features (e.g., training featureset, validation featureset and test featureset) can also be persisted into a feature store, such as for reusability purposes. Once features computation is completed using the system 100 and methods, a suitable supervised learning technique can be utilized to find the optimal model based on use-case-specific optimization criteria targeting selected evaluation metrics. In certain embodiments, the generated machine learning model can then be persisted in a model registry, along with useful metadata describing the machine learning model.

In certain embodiments, a system for providing automated detection of suspicious activities by utilizing machine learning is provided. In certain embodiments, the system can include a memory that stores instructions and a processor configured to execute the instructions to cause the processor to be configured to perform various operations to facilitate the detection. In certain embodiments, for example, the system can be configured to receive a request to determine whether an identifier (e.g., a web address, link, URL, FQDN, or other access or input mechanism) associated with a resource attempting to be accessed by a device associated with a user is suspicious. In certain embodiments, the resource can include, but is not limited to, a web page, content (e.g., video content, streaming content, audio content, virtual reality content, augmented reality content, haptic content, any type of content, or a combination thereof), digital documents, digital files, programs, systems, devices, any type of resource, or a combination thereof. In certain embodiments, the system can be configured to access, in response to the request, a machine learning model to facilitate determination of whether the identifier associated with the resource is suspicious. In certain embodiments, the system can be configured to load identifier features extracted from the identifier associated with the resource attempting to be accessed. In certain embodiments, the system can be configured to determine whether the identifier associated with the resource attempting to be accessed is suspicious based on execution of the machine learning model using the plurality of first features. In certain embodiments, the identifier can be configured to be determined to be suspicious if training features of the machine learning model are determined to have a similarity with the identifier features of the identifier. For example, in certain embodiments, the similarity can comprise having a direct match between the training features and the identifier features (e.g., identifier feature matches a training feature that is known to be suspicious, identified as suspicious, and/or labeled as suspicious), having a partial match (e.g., a threshold amount of matching) between the features and the identifier features, characters (e.g., numbers, punctuation, symbols, etc.) in the identifier features match characters known as suspicious (or benign) in the training features, protocols in the identifier features match protocols associated with the training features, domains of the identifier features match domains associated with the training features, strings in the identifier match strings associated with the training features, a characteristic of the identifier features matches a characteristic of the training features, the resource referenced by the identifier matches a resource associated with a training feature, any other feature matching a feature or label in the training features, or a combination thereof. In certain embodiments, the system can be configured to provide, in response to the request, an indication (or response) that the identifier is suspicious. In certain embodiments, the system can be configured to verify the indication based on feedback received relating to the indication to generate a verified indication that the address is suspicious. For example, the verified indication can confirm that the identifier is suspicious based on an assessment by a human expert, a separate machine learning system, an oracle, or a combination thereof. In certain embodiments, the system can be configured to output the verified indication and store the verified indication, which can then be incorporated into a labeled dataset to train the machine learning models of the system 100.

In certain embodiments, the system can be configured to determine a suspiciousness score for the identifier associated with the resource attempting to be accessed by the device. In certain embodiments, the system can be configured to reject the indication if the feedback received relating to the indication does not verify the indication that the identifier is suspicious, confirms that the identifier is not suspicious, or a combination thereof. In certain embodiments, the system can be configured to assign a label to the identifier indicating that the identifier is not suspicious if the indication is rejected. In certain embodiments, the system can be configured to persist the labeled identifier in a database. In certain embodiments, persisting an identifier (or other item or data of interest) can include storing an identifier (e.g., in a database, memory, etc.), keeping the identifier even after the determination and/or verification processes are conducted (or other process using the identifier is completed), maintaining the identifier in a program, system, or device, or a combination thereof. In certain embodiments, the system can be further configured to select (e.g., automatically) the machine learning model from a plurality of machine learning models to facilitate determination of whether the identifier associated with the resource is suspicious based on a type of the identifier, based on a type of the resource, based on an identity of the user, based on features extracted from the identifier, or a combination thereof. For example, information associated with the identity of the user can indicate that the user accesses or has accessed suspicious identifiers on a more frequent basis than other users, that the user typically accesses or has accessed suspicious resources (e.g., malicious websites or other content, etc.), that the user has a history of connecting to suspicious devices, systems, and/or programs, that the user has conducted suspicious activities in the past, or a combination thereof. Such information, in certain embodiments, can factor in the selection process utilized for selecting a machine learning model, determining whether an identifier is suspicious, or a combination thereof. In certain embodiments, the system can be configured to sample at least one labeled dataset from a database in accordance with a sampling strategy. In certain embodiments, the system can be configured to compute at least one training sample (e.g., a sample utilized to facilitate training and/or creation of a machine learning model), at least one validation sample (e.g., a sample for use in a process to evaluate a developed or updated machine learning model with a testing dataset), at least one test sample (e.g., a sample for testing a machine learning model's performance in achieving the desired functionality), or a combination thereof, from the at least one labeled data set. In certain embodiments, the system can be further configured to persist the at least one training sample, the at least one validation sample, the at least one test sample, or a combination thereof, in a sample store. In certain embodiments, a portion of the samples sampled from a labeled data set can be dedicated for training, a portion of the samples can be dedicated for validation, and a portion of the samples can be dedicated for testing. In certain embodiments, the training samples and the training features of the training samples can be utilized to train the machine learning models of the system 100. In certain embodiments, the machine learning models can be trained with samples that are known, identifier, or labeled as suspicious and with samples that are known, identified, or labeled as not suspicious (or harmless or benign). In certain embodiments, based on features that are labeled, known, or identified as being suspicious that are included in the training samples, the machine learning models can be trained to determine that an identifier, having identifier features having a similarity with the training features that are labeled, known, or identified as being suspicious, are suspicious.

In certain embodiments, the system can be further configured to compute at least a portion of the identifier features (e.g., a subset of the features) based on the at least one training sample, the at least one validation sample, the at least one test sample, or a combination thereof. In certain embodiments, a remaining portion of the identifier features can have already been computed or can already exist in the system 100, such as in a feature store. In certain embodiments, a portion of the identifier features can be a subset of the identifier features that can include one or more identifier features. In certain embodiments, the system can be further configured to utilize a supervised learning technique to build or develop the machine learning model and update the machine learning model based on the portion of the identifier features, case-specific optimization criteria targeting a selected evaluation metric, or a combination thereof. In certain embodiments, the system can be further configured to generate metadata describing one or more characteristics of the machine learning model. In certain embodiments, the system can be configured to persist the machine learning model and the metadata in a model registry. In certain embodiments, the identifier features can include, but are not limited to, a lexical feature (e.g., word length, frequency, language, density, complexity, formality, any feature that distinguishes a malicious identifier from a benign identifier, other lexical feature, or a combination thereof), a host-based feature (e.g., host feature as described in the present disclosure), a webpage screenshot feature (e.g., an image of a resource that the identifier references), a word character feature (e.g., symbols, letters, punctuation and/or other characters in the identifier), a number feature (e.g., numbers present in the identifier), a protocol feature (e.g., a protocol associated with the identifier), a domain feature (e.g., a type of the domain, the specific domain present in the identifier, and/or the characters present in the domain), another type of feature, or a combination thereof. In certain embodiments, the system can be configured to train the machine learning model based on a verification of the indication. In certain embodiments, the verification of the indication can be based on feedback associated with the indication that confirms whether the identifier is suspicious. In certain embodiments, the system can be further configured to rank the identifier relative to a plurality of other ranked identifiers based on a suspiciousness score calculated for the identifier and the plurality of other ranked identifiers.

In certain embodiments, a method for providing automated detection of suspicious identifiers if provided. In certain embodiments, the method can be configured to be performed by a processor executing instructions from a memory of a device. In certain embodiments, the method can include receiving a request to determine whether an identifier associated with resource attempting to be accessed by a device associated with a user is suspicious. In certain embodiments, the method can include selecting, in response to the request, a machine learning model to facilitate determination of whether the identifier associated with the content is suspicious. In certain embodiments, the method can include loading identifier features extracted from the identifier associated with the resource attempting to be accessed. In certain embodiments, the method can include determining whether the identifier associated with the resource attempting to be accessed is suspicious based on execution of the machine learning model using the identifier features. In certain embodiments, the identifier can be determined to be suspicious if training features of the machine learning model are determined to have a similarity with the identifier features. In certain embodiments, the method can include providing, in response to the request, an indication that the identifier is suspicious. In certain embodiments, the method can include confirming performance of the machine learning model based on feedback on feedback verifying the indication, an accuracy of the indication, a speed of the machine learning model in determining whether the identifier is suspicious, an uptime of the machine learning model, a latency of the machine learning model, or a combination thereof.

In certain embodiments, the method can include outputting an alert to the device associated with the user indicating that the identifier is suspicious. In certain embodiments, the method can include enabling the device associated with the user to access the resource via the identifier if the identifier is determined to not be suspicious. In certain embodiments, the method can include redirecting the device of the user to a different resource if the identifier associated with the resource is determined to be suspicious. In certain embodiments, the method can include verifying that the indication that the identifier is suspicious is accurate. In certain embodiments, the method can include storing a labeled dataset based on the verifying that the indication that the identifier is suspicious is accurate. In certain embodiments, the method can include updating and/or training the machine learning model(s) based on the labeled dataset. In certain embodiments, the method can include comparing characters of the identifier to a list of confusable characters or other kinds of lexical characters. In certain embodiments, the method can include determining that the identifier is suspicious if one or more characters of the characters of the address match a type of character in a list of confusable characters (or other lexical characters) not expected to be in the identifier. In certain embodiments, the method can include determining whether a character in the identifier matches a type of character not expected to be in the identifier. In certain embodiments, the method can include generating, if the character matches the type of character not expected to be in the identifier, a copy of the identifier by replacing the character with an expected character. In certain embodiments, the method can include comparing the copy of the identifier to a list of authoritative strings. In certain embodiments, the method can include raising a suspiciousness score or degree of suspiciousness associated with the identifier if the copy of the identifier matches a string in the list of authoritative strings.

In certain embodiments, a non-transitory computer readable medium comprising instructions, which, when loaded and executed by a processor, cause the processor to be configured to perform a plurality of operations. In certain embodiments, the processor can be configured to receive a request to determine whether an identifier for accessing a resource is suspicious. In certain embodiments, the processor can be configured to select, in response to the request, a machine learning model to facilitate determination of whether the identifier for accessing the resource is suspicious. In certain embodiments, the processor can be configured to load identifier features extracted from the identifier for accessing the resource. In certain embodiments, the processor can be configured to determine whether the identifier for accessing the resource is suspicious based on execution of the machine learning model using the identifier features. In certain embodiments, the identifier can be determined to be suspicious if training features of the machine learning model are determined to have a similarity with the identifier features. In certain embodiments, the processor can be configured to provide, if the identifier features of the identifier are determined to have the similarity with the training features, an indication that the identifier is suspicious. In certain embodiments, the processor can be further configured to prevent accessing of the identifier, the resource, or a combination thereof, based on the indication that the identifier is suspicious.

In certain embodiments, another system for providing automated detection of suspicious identifiers is provided. In certain embodiments, the system can include a memory that stores instructions and a processor that is configured to execute the instructions to cause the processor to be configured to perform a variety of operations. In certain embodiments, the system can be configured to obtain labeled datasets that comprise data verified as suspicious or not suspicious, extract training features from the labeled datasets (e.g., extracted from samples of the labeled datasets), and train machine learning models using the training features extracted from the labeled datasets. In certain embodiments, the system can be configured to receive a request to determine whether an identifier associated with a resource attempting to be accessed by a device associated with a user is suspicious. In certain embodiments, the system can be configured to access, in response to the request, at least one machine learning model to facilitate determination of whether the identifier associated with the resource is suspicious. In certain embodiments, the system can be configured to load identifier features extracted from the identifier associated with the resource attempting to be accessed. In certain embodiments, the system can be configured to determine whether the identifier associated with the resource attempting to be accessed is suspicious based on execution of the machine learning model using the identifier features. In certain embodiments, the identifier can be determined to be suspicious if training features of the machine learning model have a similarity to identifier features of the identifier. In certain embodiments, the system can be configured to provide, in response to the request, an indication that the identifier is suspicious.

In certain embodiments, various features and functionality of the systems and methods provided herein can be described in greater detail and further enhanced. In certain embodiments, for example, developing and/or training the machine learning models that perform the suspiciousness detections of the digital identifiers can be enhanced by utilizing novel sample generation techniques that result in labeled, balanced, and categorized samples that reduce bias towards a specific class of sample and result in higher quality suspiciousness determinations from machine learning models trained with such samples. In certain embodiments, the categorized labeled samples can be utilized by other componentry of the training pipeline service, such as the feature extractor, to extract features, which can be used to train trainable machine learning models and/or trained machine learning models to perform suspiciousness determinations for digital identifiers. In certain embodiments, a system for generating samples to create machine learning models to detect suspicious digital identifiers can be provided. In certain embodiments, the system can be configured to initiate, based on triggering of a training process, training of a trainable machine learning model. In certain embodiments, the system can be configured to obtain, during the training process, a labeled dataset comprising labeled samples that are verified as either suspicious samples or non-suspicious samples. In certain embodiments, the system can be configured to compute, based on a configuration to facilitate generation of a balanced labeled dataset, a sampling weight for the suspicious samples and the non-suspicious samples. In certain embodiments, the system can be configured to perform, based on the sampling weight, sampling for the suspicious samples and the non-suspicious samples over a time period to provide a first set of suspicious samples and a second set of non-suspicious samples.

In certain embodiments, once the sampling is performed, the system can be configured to merge the first set of suspicious samples and the second set of non-suspicious samples to form the balanced labeled dataset. In certain embodiments, the system can be configured to generate categorized labeled samples from the balanced labeled dataset. In certain embodiments, the system can be configured to train, by utilizing the categorized labeled samples from the balanced labeled dataset, the trainable machine learning model to generate a trained machine learning model for identifying whether identifiers are suspicious.

In certain embodiments, the system can be configured to modify the original configuration (or subsequent configuration) to create a modified configuration with different minimum and/or maximum sample sizes and/or different fraction of suspicious samples specified for creating the balanced labeled dataset. In certain embodiments, the system can be configured to compute a new sampling weight for use in sampling based on the modified configuration. In certain embodiments, the system can be configured to specify a first split ratio for training samples to be split from the balanced labeled dataset, a second split ratio for validation samples to be split from the balanced labeled dataset, and a third split ratio for testing sample to be split from the balanced labeled dataset. In certain embodiments, a split ratio can be the percentage of a particular type of category of sample to be obtained from the balanced labeled dataset. In certain embodiments, the system can then split the training samples in accordance with the first split ratio, the validation samples in accordance with the second split ratio, and the testing samples in accordance with the third split ratio.

In certain embodiments, the system can be configured to receive a first request to determine whether a first identifier associated with a resource attempting to be accessed is suspicious. In certain embodiments, the system can be configured to determine whether the first identifier is suspicious. In certain embodiments, the system can be configured to generate first information associated with determining whether the first identifier is suspicious. In certain embodiments, the verified information of the first information can be utilized for providing the suspicious samples, the non-suspicious samples, or a combination thereof, of the labeled dataset. In certain embodiments, the system can be configured to receive a second request to determine whether a second identifier associated with a resource attempting to be accessed is suspicious. In certain embodiments, the system can be configured to determine, by utilizing the trained machine learning model, whether the second identifier is suspicious. In certain embodiments, the system can be configured to enable access to the resource if the first identifier is determined to be non-suspicious. In certain embodiments, the system can be configured to prevent access to the resource if the first identifier is determined to be suspicious.

In certain embodiments, the system can be configured to receive an indication of a storage location (e.g., memory location) to obtain the labeled dataset and when to initiate and terminate sampling of the labeled dataset. In certain embodiments, the system can be configured to obtain the labeled dataset from the storage location (e.g., memory location) associated with the indication. In certain embodiments, a memory location can be a specific location within a memory device at which the labeled dataset or at least a portion of the labeled dataset can be stored. In certain embodiments, the storage location can be a location within a database or other storage device. In certain embodiments, the storage location can be a location in a hard drive, a flash drive, any storage medium, or a combination thereof. In certain embodiments, the storage location can be a virtual storage location that can be located via a virtual address that is mapped to an address of a memory location of a memory device. In certain embodiments, the system can be configured to define the configuration to facilitate generation of the balanced labeled dataset. In certain embodiments, the configuration can specify parameters, such as, but not limited to, a minimum sample size, a maximum sample size, a required fraction of suspicious samples for the balanced labeled dataset, a required split ratio for categorized labeled datasets (or samples) to be split from the balanced labeled dataset, a time period, a specific definition for what constitutes as suspicious, any other configuration parameter, or a combination thereof. In certain embodiments, the configuration parameters can be modified and/or new configuration parameters can also be utilized as desired. In certain embodiments, the configuration can specify a required fraction of suspicious samples, and wherein the processor is further configured to compute the sampling weight based on the required fraction of suspicious samples. In certain embodiments, the system can be configured to persist the non-suspicious samples and the suspicious samples in separate in-memory data structures of a memory.

In certain embodiments, the system can be configured to determine whether the sampling over the time period fails to satisfy a minimum sample size requirement associated with the configuration. In certain embodiments, the system can be configured to perform, if the sampling over the time period fails to satisfy the minimum sample size requirement, an additional sampling over a different time period greater than the time period for the suspicious samples and the non-suspicious sample. In certain embodiments, the additional sampling can involve utilizing additional samples from a third-party database (e.g., from databases from outside the system 100 that can have samples that can be in the same time periods as samples from the system 100), additional samples from a crowdsourced database (e.g., a database containing data from a variety of data sources and/or repositories), additional samples from other types of databases, or a combination thereof. In certain embodiments, the system can be configured to generate the categorized labeled samples from the balanced labeled dataset by splitting the balanced labeled dataset into categories of samples comprising training samples, validation samples, testing samples, or a combination thereof. In certain embodiments, the training samples, the validation samples, and the testing samples can be split from the balanced labeled dataset in accordance with a constraint of preserving a suspicious to non-suspicious ratio. In certain embodiments, the system can be configured to preserve the suspicious to non-suspicious ratio by utilizing a stratified sampling technique and/or other sampling technique.

In certain embodiments, the system can be configured to persist the categorized labeled samples from the balanced labeled dataset into a sample store accessible by a feature extractor configured to extract features from the categorized labeled samples to train the trainable machine learning model. In certain embodiments, the system can be configured to obtain an updated labeled dataset from a PCP database, and rebalance the balanced labeled dataset based on the updated labeled dataset.

In certain embodiments, a method for generating samples to create machine learning models to detect suspicious digital identifiers can be provided. In certain embodiments, the method can include initiating training of a trainable machine learning model. In certain embodiments, the method can include obtaining, during the training, a labeled dataset comprising labeled samples verified as either suspicious samples or non-suspicious samples. In certain embodiments, the method can include computing, based on a configuration to facilitate generation of a balanced labeled dataset, a sampling weight for the suspicious samples and the non-suspicious samples. In certain embodiments, the method can include performing, based on the sampling weight, sampling for the suspicious samples and the non-suspicious samples over a time period to provide first set of suspicious samples and a second set of non-suspicious samples. In certain embodiments, the method can include combining the first set of suspicious samples and the second set of non-suspicious samples to form the balanced labeled dataset. In certain embodiments, the method can include generating categorized labeled samples from the balanced labeled dataset. In certain embodiments, the method can include training, by utilizing the categorized labeled samples from the balanced labeled dataset, the trainable machine learning model to generate a trained machine learning model for identifying whether identifiers are suspicious.

In certain embodiments, the method can include receiving a request to determine whether a first identifier associated with a resource attempting to be accessed is suspicious. In certain embodiments, the method can include determining, by utilizing the trained machine learning model, whether the first identifier associated with the resource attempting to be accessed is suspicious. In certain embodiments, the method can include determining whether the performance of the trained machine learning model satisfies an expectation. For example, with regard to an expectation, the method can include determining whether the trained machine learning model has a threshold speed for determining whether an identifier is suspicious, utilizes no more than a threshold number of and/or types of computing resources when making a suspiciousness determination, a threshold accuracy of a suspiciousness determination, any other performance metric and/or evaluation measure, or a combination thereof. In certain embodiments, if the expectation relating to performance of the trained machine learning model is satisfied, the method can proceed to performing suspiciousness determinations in response to receiving a request to determine whether an identifier associated with a resource attempting to be accessed is suspicious. If, however, the performance expectation is not satisfied, the method can trigger the training process to further train the trained machine learning model and the training can continue until the performance expectation is satisfied. In certain embodiments, the method can include specifying a minimum sample size, a maximum sample size, a fraction of suspicious samples, or a combination thereof, for the configuration. In certain embodiments, the method can include grouping suspicious samples and the non-suspicious samples from the labeled dataset into separate in-memory data structures and/or storage locations. In certain embodiments, the categorized labeled samples can include training samples, validation samples, testing samples, or a combination thereof. In certain embodiments, the categorized balanced labeled samples can include any other types of samples. For example, the categorized balanced labeled samples can include production samples (e.g., samples to facilitate production of the machine learning model), crowdsourced samples (e.g., samples that can be obtained from a variety of different sources that can be utilized to facilitate generation of the machine learning model), open-source samples (e.g., samples that can be provided via an open source fashion for use in generating machine learning models), any other types of samples, or a combination thereof. In certain embodiments, the method can include splitting the categorized balanced labeled samples from the balanced labeled dataset in accordance with a constraint of preserving a suspicious to non-suspicious ratio. In certain embodiments, any number of categories of samples can be split from the balanced labeled dataset and any number of split ratios (e.g., n number of split ratios or even zero split ratios) can be utilized for splitting the categorized samples from the balanced labeled dataset. In certain embodiments, the balanced labeled dataset can be split into or partitioned into categorized balanced labeled datasets. In certain embodiments, the method can include determining whether the labeled samples from the labeled dataset are imbalanced. In certain embodiments, the method can include performing the sampling by utilizing stratified sampling.

In certain embodiments, another method for generating samples to develop and/or train machine learning models to perform suspiciousness determinations for digital identifiers can be provided. In certain embodiments, the system can be configured to trigger training of a trainable machine learning model. In certain embodiments, the system can be configured to obtain, in response to the triggering, a labeled dataset comprising labeled samples verified as either suspicious samples or non-suspicious samples. In certain embodiments, the system can be configured to calculate, based on a configuration to facilitate generation of a balanced labeled dataset, a sampling weight for the suspicious samples and the non-suspicious samples. In certain embodiments, the system can be configured to conduct, based on the sampling weight, sampling for the suspicious samples and the non-suspicious samples over a time period to provide a first set of suspicious samples and a second set of non-suspicious samples. In certain embodiments, the system can be configured to combine the first set of suspicious samples and the second set of non-suspicious samples to form the balanced labeled dataset. In certain embodiments, the system can be configured to generate categorized labeled samples from the balanced labeled dataset. In certain embodiments, the system can be configured to train, by utilizing the categorized labeled samples from the balanced labeled dataset, the trainable machine learning model to generate a trained machine learning model for identifying whether identifiers are suspicious.

In certain embodiments, the features and functionality of the systems and methods provide herein can be described in greater detail and further enhanced. In certain embodiments, for example, when a request comes into the automated suspicious URL/FQDN detection system, the system 100 and methods, such as by utilizing the inference pipeline service, can include selecting a machine learning model from a model registry to perform the assessment as to whether the digital identifier is suspicious. The process of selecting the optimal machine learning model to process the request can be facilitated by the training pipeline service, which can analyze the request and factor the analysis into selection of the optimal machine learning model. In certain embodiments, for example, the learner of the training pipeline service can generate and/or determine the optimal machine learning model by focusing on optimizing based on user-provided and/or system-provided model evaluation measures. For example, the evaluation measures can include, but are not limited to, precision capability, recall capability, accuracy capability, F-measure capability, speed capability (e.g., how fast the predictions are made by the machine learning model), resource-usage (e.g., processor, network, and/or memory usage), any other evaluation measures, or a combination thereof (discussed in further detail below). Such evaluation measures are discussed in further detail below. In certain embodiments, the optimal machine learning model can be a machine learning model developed from training a machine learning algorithm on a labeled dataset that satisfies performance metrics (e.g., performance metrics specified by a user and/or the system) associated with the evaluation measures.

In certain embodiments, a system for providing automated machine learning model selection to facilitate detection of suspicious identifiers can be provided. In certain embodiments, the system can include a memory that stores instructions and a processor that is configured to execute the instructions to perform operations. In certain embodiments, the system can be configured to perform an operation that includes training, such as during a training process, a plurality of trainable machine learning models (or machine learning algorithms) with a labeled dataset containing data verified as suspicious or non-suspicious to generate a plurality of trained machine learning models. In certain embodiments, the system can be configured to receive a first request to determine whether a first identifier associated with a resource attempting to be accessed by a device is suspicious. In certain embodiments, a determination can be made regarding whether the first identifier associated with the first request is suspicious, such as by using a trained machine learning model. In certain embodiments, first information from or associated with the determination can be generated. In certain embodiments, such information can include a verification of whether the first identifier is suspicious or not, such as a verification made by an expert, a system, or a combination thereof. In certain embodiments, the first information can also include metadata associated with processing of the first request, such as, but not limited to, the amount of time it took to process the request, the level of suspiciousness of the identifier, a type of attack associated with the identifier, any other information, or a combination thereof.

In certain embodiments, the system can be configured to determine or identify the optimal machine learning model from the plurality of trained machine learning models. In certain embodiments, the first information can be utilized to assist in the determination and/or identification process. In certain embodiments, the trained machine learning models can be trained using the first information, which may be obtained from any one or more of the databases of the system 100. In certain embodiments, the optimal machine learning model (or machine learning algorithm) can have an optimal hyperparameter combination and the optimal machine learning model can have an optimal model parameter combination (e.g., combination of weights, biases, etc.) that is learned via the training process using the optimal hyperparameter combination. In certain embodiments, the optimal machine learning model having the optimal model parameter combination can have a highest performance for suspiciousness determination according to a specified performance metric associated with an evaluation measure(s) when compared to other trained machine learning models of the plurality of trained machine learning models. In certain embodiments, the system can be configured to receive a second request to determine whether a second identifier associated with a resource attempting to be accessed by a device is suspicious. In certain embodiments, the system can be configured to select the optimal machine learning model, such as from a model registry, to determine whether the second identifier is suspicious. In certain embodiments, the system can be configured to determine whether the second identifier is suspicious by utilizing the optimal machine learning model. In certain embodiments, in response to the second request, the system can provide an indication of whether the second identifier is suspicious. In certain embodiments, the indication of whether the second identifier is suspicious can be verified by an expert, a system, or a combination thereof, and information associated with the verified suspiciousness determination can be utilized to further train the trained models (or trainable models) to enhance determination of suspiciousness for subsequent requests.

In certain embodiments, the system can be configured to perform additional functionality and operations. In certain embodiments, the system can be further configured to activate, via a control signal, a training pipeline service of the system to conduct the training process to train the trainable machine learning models (or algorithms) using the labeled dataset and to produce the trained machine learning models (or algorithms). In certain embodiments, the system can be further configured to receive, via the training pipeline service, a plurality of feature matrices for a plurality of samples from a feature store. In certain embodiments, the system can be further configured to train the plurality of trainable machine learning models (or algorithms) using the plurality of feature matrices. In certain embodiments, the system can be further configured to search for and/or identify the optimal machine learning model (or algorithm) from the plurality of trained machine learning models (or algorithms) using a blended search strategy, a randomized direct search strategy, a Bayesian search strategy, other search strategy, or a combination thereof. In certain embodiments, the system can be further configured to identify the optimal combination of hyperparameters (e.g., a parameter having a value that is used to control the machine learning process and can be utilized to determine the values of machine learning model parameters that a learning algorithms learns and/or a top-level parameter that controls the learning process and the model parameters that result from the learning process) for the optimal machine learning model, such as by conducting tuning of a plurality of hyperparametric combinations for the trainable machine learning models.

In certain embodiments, the system can be further configured to determine an amount of time to train the optimal machine learning model, the trainable machine learning models, and/or the trained machine learning models. In certain embodiments, the system can be further configured to determine a time(s) when a training pipeline service of the system for training the optimal machine learning model, trainable machine learning models, and/or trained machine learning models was activated. In certain embodiments, the system can be further configured to generate metadata including the amount of time for training the machine learning models, the time when the training pipeline service was activated, or a combination thereof. In certain embodiments, the system can be further configured to persist the metadata and the optimal machine learning model into a model registry. In certain embodiments, the system can be further configured to activate the training pipeline service to train the plurality of trainable machine learning models and/or trained machine learning models in response to a trigger. In certain embodiments, the system can be further configured to transmit a completion signal to a process, a user, or a combination thereof, that triggered activation of the training pipeline service of the system after the plurality of trainable machine learning models, the trained machine learning models, or a combination thereof, are trained.

In certain embodiments, the system can be configured to activate the training pipeline service of the system. In certain embodiments, the system can be configured to obtain, using the training pipeline service, the labeled dataset (e.g., including data labeled as suspicious or non-suspicious) from a database. In certain embodiments, the system can be further configured to compute at least one training sample, at least one validation sample, at least one test sample, or a combination thereof, from the at least one labeled dataset to facilitate training of at least one of the plurality of trainable machine learning models to produce model parameters for the trained machine learning models. In certain embodiments, the system can be further configured to persist the at least one training sample, the at least one validation sample, the at least one test sample, or a combination thereof, in a sample store.

In certain embodiments, the system can be further configured to obtain the at least one training sample, the at least one validation sample, the at least one test sample, or a combination thereof, from the sample store. In certain embodiments, the system can be configured to compute feature matrices for the at least one training sample, the at least one validation sample, the at least one test sample, or a combination thereof. In certain embodiments, the system can be configured to persist the feature matrices in a feature store. In certain embodiments, the system can be further configured to obtain the feature matrices from the feature store. In certain embodiments, the system can be further configured to train the plurality of trainable machine learning models to generate the plurality of trained machine learning models by utilizing the feature matrices and based on the specified performance metrics. In certain embodiments, the system can be further configured to provide, in response to the first request, an indication of whether the first identifier is suspicious. In certain embodiments, the first information can be utilized to train the trained machine learning models, where the first information can include a verification of the indication regarding suspiciousness of the first identifier and metadata (as described herein) to enhance a future determination of whether a future identifier associated with a future request is suspicious. In certain embodiments, the system can be further configured to train the plurality of trained machine learning models using the first information associated with the verification of the indication regarding the suspiciousness of the identifier associated with the request. In certain embodiments, the system can be further configured generate second information from a determination of whether the second identifier is suspicious. In certain embodiments, the system can be further configured to determine a new optimal machine learning model based on the second information from the plurality of trained machine learning models. In certain embodiments, the system can be further configured to determine whether the second identifier is suspicious based on the performance metric, a characteristic of the second identifier, or a combination thereof. In certain embodiments, the system can be configured to receive a third request to determine whether a third identifier associated with a resource attempting to be accessed is suspicious. In certain embodiments, the system can be configured to determine, such as by utilizing the new optimal machine learning model, whether the third identifier associated with a resource attempting to be accessed via the third request is suspicious.

In certain embodiments, a method for providing automated model selection to facilitate detection of suspicious identifiers can be provided. In certain embodiments, the method may include training, such as during a training process, a plurality of trainable machine learning models using a labeled dataset containing data verified as suspicious or non-suspicious to generate a plurality of trained machine learning models. In certain embodiments, the method can include receiving a first request to determine whether a first identifier associated with a resource attempting to be accessed by a device is suspicious. In certain embodiments, the method can include generating first information from a determination of whether the first identifier is suspicious to determine the optimal machine learning model from the trained machine learning model set. In certain embodiments, the method can include determining an optimal machine learning model from the plurality of trained machine learning models to determine whether the identifier associated with the request is suspicious, such as by utilizing the first information. In certain embodiments, the optimal machine learning model can be generated during the training process by an optimal machine learning algorithm selected from a plurality of candidate machine learning algorithms. In certain embodiments, the optimal machine learning model can have an optimal hyperparameter combination and the optimal machine learning model can have an optimal model parameter combination learned via the training process using the optimal hyperparameter combination. In certain embodiments, the optimal machine learning model can have a highest performance for suspiciousness determination according to a performance metric(s) when compared to other trained machine learning models of the plurality of trained machine learning models. In certain embodiments, the method can include receiving a second request to determine whether a second identifier is suspicious. In certain embodiments, the method can include selecting the optimal machine learning model from the model registry. In certain embodiments, the method can include determining, by utilizing the optimal machine learning model, whether the second identifier is suspicious. In certain embodiments, the method can include providing, in response to the second request, an indication of whether the second identifier is suspicious. In certain embodiments, second information associated with the determination of whether the second identifier is suspicious can be generated and utilized to further train the trained machine learning models to enhance suspiciousness determinations for subsequent requests.

In certain embodiments, the method can include determining a level of suspiciousness for an identifier if the identifier is determined to be suspicious. In certain embodiments, the method can include monitoring a current state associated with training the trainable machine learning models and/or trained machine learning models during the training process. In certain embodiments, the current state associated with training can be stored and/or provided to a training orchestrator of the training pipeline service, and can indicate what data was used to train a machine learning model, the last time the machine learning model was trained, when the next training is to occur, any information associated with the training of the machine learning model, or a combination thereof. In certain embodiments, the state can indicate whether training failed, the specific part in the training process that the training process is currently on, the performance of the machine learning model, or a combination thereof. In certain embodiments, the method can include persisting the current state of the training process, such as in any of the components of the system and/or training pipeline service.

In certain embodiments, the method can include determining whether the training process has been interrupted, an exception has occurred, or a combination thereof. In certain embodiments, the method can include restarting the training based on the current state if the training has been determined to be interrupted, the exception has occurred, or a combination thereof. In certain embodiments, the method can include training the plurality of trained machine learning models using information (e.g., first or second information or subsequent information generated by the system 100) associated with the verification of the indication regarding the suspiciousness of the identifier in response to the request. In certain embodiments, the method can include receiving an additional request to determine whether a different identifier is suspicious and determining a new optimal machine learning model from the plurality of trained machine learning models based on the performance metric(s), a characteristic(s) of the identifier, or a combination thereof, to determine whether the different identifier is suspicious. In certain embodiments, the method can include estimating the optimal model parameters for the optimal machine learning model by utilizing the optimal hyperparameter combination.

In certain embodiments, yet a further system for providing automatic model selection to facilitate detection of suspicious identifiers is provided. In certain embodiments, the system can be configured to train, during a training process, a plurality of trainable machine learning models using a labeled dataset containing data verified as suspicious or non-suspicious to generate a plurality of trained machine learning models. In certain embodiments, the system can be configured to receive a first request to determine whether a first identifier associated with a resource attempting to be accessed by a device is suspicious. In certain embodiments, first information can be generated from the determination of whether the first identifier associated with the first request is suspicious. In certain embodiments, the first information can be utilized to train the trained machine learning models further. Using the first information and/or evaluation measures, the system 100 can determine the optimal machine learning model from the plurality of trained machine learning models to perform suspiciousness determinations.

In certain embodiments, the optimal machine learning model can be generated by an optimal machine learning algorithm selected from the plurality of candidate machine learning algorithms. In certain embodiments, the optimal machine learning model can have an optimal hyperparameter combination and the optimal machine learning model can have an optimal model parameter combination that is learned via the training process using the optimal hyperparameter combination. In certain embodiments, the optimal model parameter model can have a highest performance for suspiciousness determination according to a performance metric(s) when compared to other trained machine learning models learned during the training process. In certain embodiments, the system can receive a second request to determine whether a second identifier attempting to be accessed is suspicious. In certain embodiments, the system can be configured to determine, by utilizing the optimal machine learning model, whether the second identifier is suspicious. In certain embodiments, the system can be configured to train the plurality of trained machine learning models based on second information associated with or corresponding to a verification of an indication of whether the identifier is suspicious that is generated by the system 100. In certain embodiments, the system can be configured to select, after training the plurality of trained machine learning models, a new optimal machine learning model from the trained machine learning models to determine whether another identifier associated with a subsequent or further request is suspicious.

Based on at least the foregoing, the systems and methods provided in the present disclosure can be utilized to detect suspicious types of identifiers, such as, but not limited to, addresses (e.g., web addresses), URLs, FQDNs, and/or other access mechanisms for accessing content, applications, and/or systems. Additionally, the systems and methods can incorporate expert and/or system feedback to rectify potential misjudgments of suspiciousness or lack of suspiciousness by the systems. In certain embodiments, the systems and methods can be utilized to automatically retrain a machine learning system to avoid problems, such as, but not limited to, concept drift. In certain embodiments, the systems and methods can incorporate different features during detection of suspiciousness of the identifier, such as an address, URL, FQDN, and/or other access mechanism. In certain embodiments, the systems and methods can be configured to automatically select the optimal machine learning model during the model training process and/or at other times. In certain embodiments, the system and methods can be configured to sample labeled data to avoid or reduce problems associated with imbalanced data. In certain embodiments, the systems and methods can utilize any types of machine learning or artificial intelligence algorithms to support the functionality provided by the present disclosure. In certain embodiments, the system and methods can significantly enhance the user's experience as it relates to interacting with identifiers to obtain access to various types of resources of interest. The system and methods can be configured to operate such that determinations of whether an identifier is suspicious are done in real-time to ensure that the user has a smooth and uninterrupted experience while interacting with identifiers. The system and methods can also be configured to provide suspiciousness detections and access (or prevention of access to) to resources associated with identifiers significantly faster than existing technologies, while also having greater performance (e.g., lower use of computer resources, enhanced determinations over time as the machine learning models are trained with labeled datasets, enhanced security, among other performance enhancements).

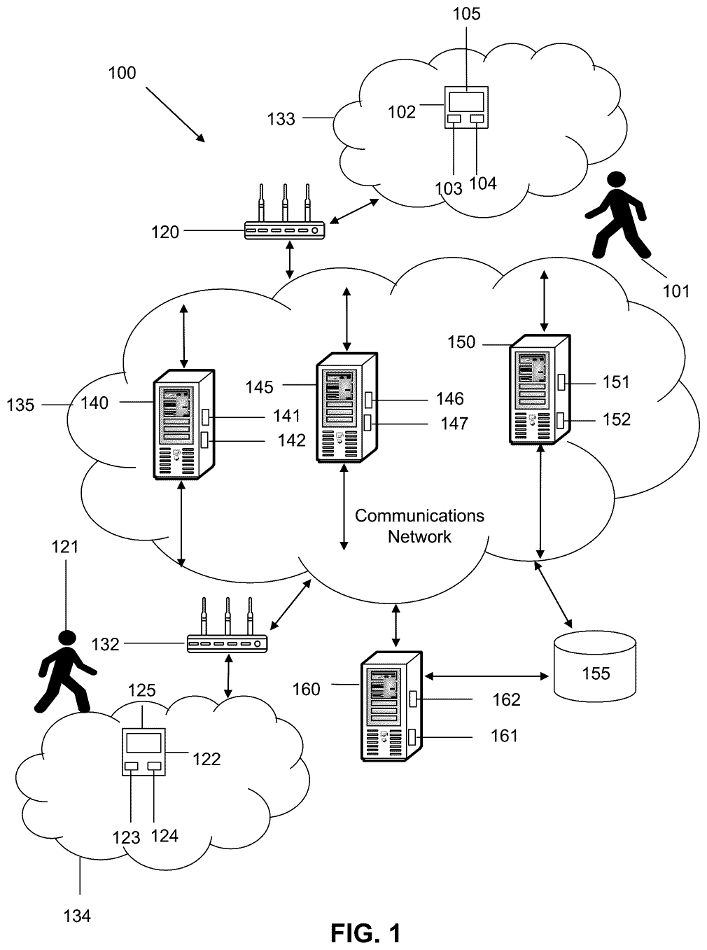

As shown in FIGS. 1-7, a system 100 for providing automated detection of suspicious identifiers (e.g., digital identifiers) utilizing machine learning is provided. Notably, the system 100 can be configured to support, but is not limited to supporting, cybersecurity systems and services, monitoring and surveillance systems and services, phishing and content protection classification systems and services, ranking systems and services, SASE systems and services, cloud computing systems and services, privacy systems and services, firewall systems and services, data analytics systems and services, data collation and processing systems and services, artificial intelligence services and systems, machine learning services and systems, neural network services, autonomous vehicle applications and services, mobile applications and services, alert systems and services, content delivery services, satellite services, telephone services, voice-over-internet protocol services (VoIP), software as a service (SaaS) applications, platform as a service (PaaS) applications, gaming applications and services, social media applications and services, operations management applications and services, productivity applications and services, and/or any other computing applications and services. Notably, the system 100 can include a first user 101, who can utilize a first user device 102 to access data, content, and services, or to perform a variety of other tasks and functions. As an example, the first user 101 can utilize first user device 102 to transmit signals to access various online services and content, such as those available on an internet, on other devices, and/or on various computing systems. In certain embodiments, the first user 101 can utilize the first user device 102 to access services, applications, and/or content, such as by interacting with uniform resource locators (URLs), fully qualified domain names (FQDNs), links, and/or other mechanisms for accessing services, applications, and/or content. As another example, the first user device 102 can be utilized to access an application, devices, and/or components of the system 100 that provide any or all of the operative functions of the system 100.

In certain embodiments, the first user 101 can be a person, a robot, a humanoid, a program, a computer, any type of user, or a combination thereof, that can be located in a particular location or environment. In certain embodiments, the first user 101 can be a person that can want to utilize the first user device 102 to conduct various types of activities and/or access content. For example, an activity can include, but is not limited to, accessing digital resources, such as, but not limited to, website content, application content, video content, audio content, haptic content, audiovisual content, virtual reality content, augmented reality content, any type of content, or a combination thereof. In certain embodiments, other activities can include, but are not limited to, accessing various types of applications, such as to perform work, create content, experience content, communicate with other users, transmit content, upload content, download content, or a combination thereof. In certain embodiments, other activities can include interacting with links for accessing and/or interacting with devices, systems, programs, or a combination thereof.

In certain embodiments, the first user device 102 can include a memory 103 that includes instructions, and a processor 104 that executes the instructions from the memory 103 to perform the various operations that are performed by the first user device 102. In certain embodiments, the processor 104 can be hardware, software, or a combination thereof. The first user device 102 can also include an interface 105 (e.g., screen, monitor, graphical user interface, etc.) that can enable the first user 101 to interact with various applications executing on the first user device 102 and to interact with the system 100. In certain embodiments, the first user device 102 can be and/or can include a computer, any type of sensor, a laptop, a set-top-box, a tablet device, a phablet, a server, a mobile device, a smartphone, a smart watch, a voice-controlled-personal assistant, a physical security monitoring device (e.g., camera, glass-break detector, motion sensor, etc.), an internet of things device (IoT), appliances, an autonomous vehicle, and/or any other type of computing device. Illustratively, the first user device 102 is shown as a computer in FIG. 1. In certain embodiments, the first user device 102 can be utilized by the first user 101 to control, access, and/or provide some or all of the operative functionality of the system 100.

In addition to using first user device 102, the first user 101 can also utilize and/or have access to any number of additional user devices. As with first user device 102, the first user 101 can utilize the additional user devices to transmit signals to access various online services and content and/or access functionality provided by an enterprise. The additional user devices can include memories that include instructions, and processors that executes the instructions from the memories to perform the various operations that are performed by the additional user devices. In certain embodiments, the processors of the additional user devices can be hardware, software, or a combination thereof. The additional user devices can also include interfaces that can enable the first user 101 to interact with various applications executing on the additional user devices and to interact with the system 100. In certain embodiments, the first user device 102 and/or the additional user devices can be and/or can include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors can include, but are not limited to, cameras, motion sensors, acoustic/audio sensors, pressure sensors, temperature sensors, light sensors, any type of sensors, or a combination thereof.

The first user device 102 and/or additional user devices can belong to and/or form a communications network 133. In certain embodiments, the communications network 133 can be a local, mesh, and/or other network that enables and/or facilitates various aspects of the functionality of the system 100. In certain embodiments, the communications network can be formed between the first user device 102 and additional user devices through the use of any type of wireless or other protocol and/or technology. For example, user devices can communicate with one another in the communications network by utilizing any protocol and/or wireless technology, satellite, fiber, or any combination thereof. Notably, the communications network can be configured to communicatively link with and/or communicate with any other network of the system 100 (e.g., communications network 135) and/or outside the system 100.

In certain embodiments, the first user device 102 and additional user devices belonging to the communications network 133 can share and exchange data with each other via the communications network 133. For example, the user devices can share information relating to the various components of the user devices, information associated with images, links, and/or content accessed and/or attempting to be accessed by the first user 101 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 133, information identifying devices being added to or removed from the communications network 133, any other information, or any combination thereof.

In certain embodiments, the system 100 can include an edge device 120, which the first user 101 can access to gain access to various resources, devices, systems, programs, or a combination thereof, outside the communications network 133. In certain embodiments, the edge device 120 can be or can include, network servers, routers, gateways, switches, media distribution hubs, signal transfer points, service control points, service switching points, firewalls, routers, nodes, computers, proxy device, mobile devices, or any other suitable computing device, or any combination thereof. In certain embodiments, the edge device 120 can connect with any of the devices and/or componentry of the communications network 135. In certain embodiments, the edge device 120 can be provided by and/or be under the control of a service provider, such as an internet, television, telephone, and/or other service provider of the first user 101. In certain embodiments, the edge device 120 can be provided by and/or be under control of an enterprise. In certain embodiments, the system 100 can operate without the edge device 120 and the first user device 102 can operate as an edge device, such as for communications network 135.

In addition to the first user 101, the system 100 can also include a second user 121. In certain embodiments, the second user 121 can be similar to the first user 101 and can seek to access content, applications, systems, and/or devices, such as by interacting with an identifier, such as, but not limited to, a web address, a link, a URL, a FQDN, and/or other interactable mechanism capable of connecting the second user 121 with content, applications, systems, and/or devices. In certain embodiments, the second user device 122 can be utilized by the second user 121 to transmit signals to request various types of resources, content, services, and data provided by and/or accessible by communications network 135 or any other network in the system 100. In further embodiments, the second user 121 can be a robot, a computer, a vehicle (e.g., semi or fully-automated vehicle), a humanoid, an animal, any type of user, or any combination thereof. In certain embodiments, the second user 121 can be an expert who can verify or reject suspiciousness determinations made by the automated suspicious URL/FQDN detection system 206. In certain embodiments, the second user 121 can be a hacker or malicious actor attempting to compromise the first user 101 or other users and/or devices. The second user device 122 can include a memory 123 that includes instructions, and a processor 124 that executes the instructions from the memory 123 to perform the various operations that are performed by the second user device 122. In certain embodiments, the processor 124 can be hardware, software, or a combination thereof. The second user device 122 can also include an interface 125 (e.g., screen, monitor, graphical user interface, etc.) that can enable the first user 101 to interact with various applications executing on the second user device 122 and, in certain embodiments, to interact with the system 100. In certain embodiments, the second user device 122 can be a computer, a laptop, a set-top-box, a tablet device, a phablet, a server, a mobile device, a smartphone, a smart watch, an autonomous vehicle, and/or any other type of computing device. Illustratively, the second user device 122 is shown as a mobile device in FIG. 1. In certain embodiments, the second user device 122 can also include sensors, such as, but are not limited to, cameras, audio sensors, motion sensors, pressure sensors, temperature sensors, light sensors, humidity sensors, any type of sensors, or a combination thereof. In certain embodiments, the second user 121 can also utilize additional user devices as well.

In certain embodiments, the second user device 122 and additional user devices belonging to the communications network 134 can share and exchange data with each other via the communications network 134. For example, the user devices can share information relating to the various components of the user devices, information associated with images, links, and/or content accessed and/or attempting to be accessed by the second user 121 of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network 134, information identifying devices being added to or removed from the communications network 134, any other information, or any combination thereof. In certain embodiments, the system 100 can include edge device 132, which can be utilized by the second user device 122 and/or additional user devices to communicate with other networks, such as communications network 135, and/or devices, programs, and/or systems that are external to the communications network 134, such as communications network 133.

In certain embodiments, the user devices described herein can have any number of software functions, applications and/or application services stored and/or accessible thereon. For example, the user devices can include applications for controlling and/or accessing the operative features and functionality of the system 100, applications for controlling and/or accessing any device of the system 100, artificial intelligence and/or machine learning applications, cybersecurity applications, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications can support the functionality provided by the system 100 and methods described in the present disclosure. In certain embodiments, the software applications and services can include one or more graphical user interfaces so as to enable the first and/or second users 101, 121 to readily interact with the software applications. The software applications and services can also be utilized by the first and/or second users 101, 121 to interact with any device in the system 100, any network in the system 100, or any combination thereof. In certain embodiments, user devices can include associated telephone numbers, device identities, network identifiers (e.g., IP addresses, etc.), and/or any other identifiers to uniquely identify the user devices.

The system 100 can also include a communications network 135. The communications network 135 can include resources (e.g., data, web pages, content, documents, computing resources, applications, and/or any other resources) that can be accessible to the first user 101 and/or second user 121. The communications network 135 of the system 100 can be configured to link any number of the devices in the system 100 to one another. For example, the communications network 135 can be utilized by the second user device 122 to connect with other devices within or outside communications network 135. Additionally, the communications network 135 can be configured to transmit, generate, and receive any information and data traversing the system 100. In certain embodiments, the communications network 135 can include any number of servers, databases, or other componentry. The communications network 135 can also include and be connected to a neural network, a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 can be part of a single autonomous system that is located in a particular geographic region, or be part of multiple autonomous systems that span several geographic regions.

Notably, the functionality of the system 100 can be supported and executed by using any combination of the servers 140, 145, 150, and 160. The servers 140, 145, and 150 can reside in communications network 135, however, in certain embodiments, the servers 140, 145, 150 can reside outside communications network 135. The servers 140, 145, and 150 can provide and serve as a server service that performs the various operations and functions provided by the system 100. In certain embodiments, the server 140 can include a memory 141 that includes instructions, and a processor 142 that executes the instructions from the memory 141 to perform various operations that are performed by the server 140. The processor 142 can be hardware, software, or a combination thereof. Similarly, the server 145 can include a memory 146 that includes instructions, and a processor 147 that executes the instructions from the memory 146 to perform the various operations that are performed by the server 145. Furthermore, the server 150 can include a memory 151 that includes instructions, and a processor 152 that executes the instructions from the memory 151 to perform the various operations that are performed by the server 150. In certain embodiments, the servers 140, 145, 150, and 160 can be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 can be communicatively linked to the communications network 135, any network, any device in the system 100, or any combination thereof.

The database 155 of the system 100 can be utilized to store and relay information that traverses the system 100, cache content that traverses the system 100, store data about each of the devices in the system 100 and perform any other typical functions of a database. In certain embodiments, the database 155 can be connected to or reside within the communications network 135, any other network, or a combination thereof. In certain embodiments, the database 155 can serve as a central repository for any information associated with any of the devices and information associated with the system 100. Furthermore, the database 155 can include a processor and memory or can be connected to a processor and memory to perform the various operations associated with the database 155. In certain embodiments, the database 155 can be connected to the servers 140, 145, 150, 160, the first user device 102, a second user device 122, the communications network 133, the communications network 134, the communications network 135, a server 140, a server 145, a server 150, a server 160, edge devices 120, 132, and a database 155, the additional user devices, any devices in the system 100, any process of the system 100, any program of the system 100, any other device, any network, or any combination thereof.

The database 155 can also store information and metadata obtained from the system 100, store metadata and other information associated with the first and second users 101, 121, store profiles for the networks of the system, store telemetry data, indications that indicate whether an identifier, such as, but not limited to, a link, URL, FQDN, and/or other interactable mechanism is suspicious or not, information identifying the networks of the system 100, store suspiciousness scores determined for identifiers, such as, but not limited to, links, URLs, FQDNs, and/or other interactable mechanisms, store machine learning models, store training data and/or information utilized to train the machine learning models (e.g., labeled datasets, training samples, validation samples, testing samples, etc.), store algorithms supporting the functionality of the machine learning models, store verifications of indications that an identifier, such as, but not limited to, a link, URL, FQDN, and/or interactable mechanism is suspicious or not, store alerts outputted by the system 100, store features utilized by the machine learning models to make determinations, store data shared by devices in the networks, store configuration information for the networks and/or devices of the system 100, store user profiles associated with the first and second users 101, 121, store device profiles associated with any device in the system 100, store communications traversing the system 100, store user preferences, store information associated with any device or signal in the system 100, store information relating to patterns of usage relating to the user devices, store any information obtained from any of the networks in the system 100, store historical data associated with the first and second users 101, 121, store device characteristics, store information relating to any devices associated with the first and second users 101, 121, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 can be configured to process queries sent to it by any device in the system 100.

Notably, as shown in FIG. 1, the system 100 can perform any of the operative functions disclosed herein by utilizing the processing capabilities of server 160, the storage capacity of the database 155, or any other component of the system 100 to perform the operative functions disclosed herein. The server 160 can include one or more processors 162 that can be configured to process any of the various functions of the system 100. The processors 162 can be software, hardware, or a combination of hardware and software. Additionally, the server 160 can also include a memory 161, which stores instructions that the processors 162 can execute to perform various operations of the system 100. For example, the server 160 can assist in processing loads handled by the various devices in the system 100, such as, but not limited to, receiving requests to determine whether an identifier, such as, but not limited to, an address, link, URL, FQDN and/or other interactable mechanism for accessing resources is suspicious or not; accessing and/or obtaining machine learning models to determine whether the identifier, such as an address, link, URL, FQDN, and/or other interactable mechanism is suspicious; loading features (e.g., identifier features) extracted from or are associated with the identifier, such as an address, link, and/or other interactable mechanism; determining whether the identifier, such as an address, link, URL, FQDN, and/or other interactable mechanism is suspicious based on execution of the machine learning model using the features; providing an indication that the identifier, such as address, link, URL, FQDN, and/or other interactable mechanism is suspicious; verifying that the indication based on feedback relating to the indication to generate a verified indication that the identifier is suspicious; outputting the verified indication; training models based on the verified indication; preventing access to the resources for which the indication indicates that the identifier, such as an address, link, URL, FQDN, and/or other interactable mechanism is suspicious; and/or performing any other operations of the system 100; and performing any other suitable operations conducted in the system 100 or otherwise. In certain embodiments, multiple servers 160 can be utilized to process the functions of the system 100. The server 160 and other devices in the system 100, can utilize the database 155 for storing data about the devices in the system 100 or any other information that is associated with the system 100. In one embodiment, multiple databases 155 can be utilized to store data in the system 100.

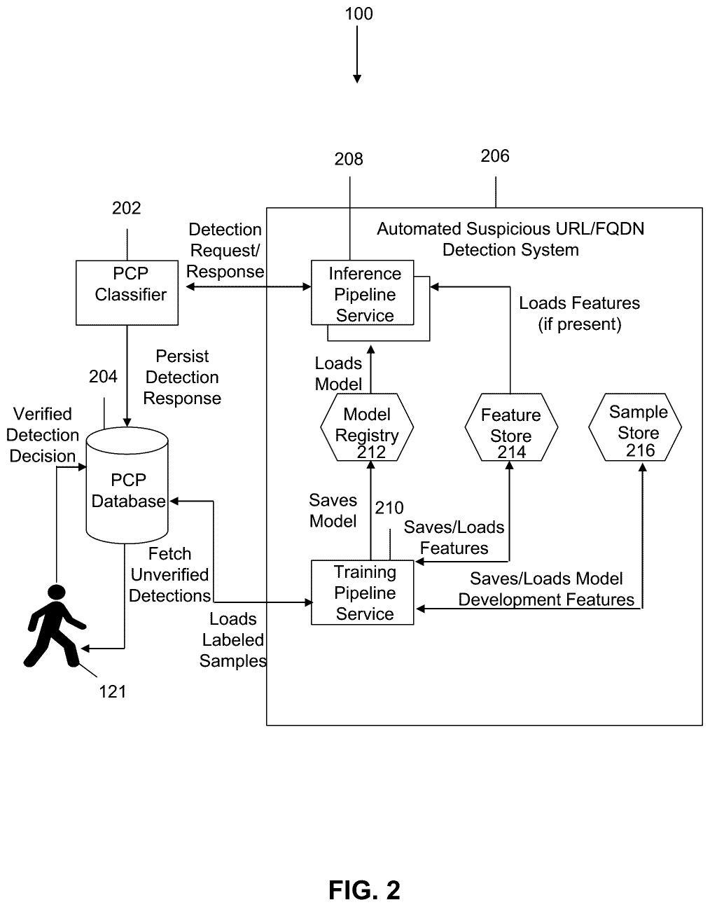

Referring now also to FIG. 2, an exemplary architecture to provide automated detection of suspicious identifiers for use with the system 100 of FIG. 1 according to embodiments of the present disclosure is shown. In certain embodiments, the system 100 can include a phishing and content protection (PCP) classifier 202, a PCP database 204 (e.g., can correlate with database 155), an automated suspicious URL/FQDN detection system 206, or a combination thereof. In certain embodiments, the automated suspicious URL/FQDN detection system 206 can include a plurality of componentry and functionality. For example, in certain embodiments, the automated suspicious URL/FQDN detection system 206 can include an inference pipeline service 208 (which can be configured to process any number of requests in parallel or in other sequences), a training pipeline service 210, a model registry 212, a feature store 214, a sample store 216, and/or any other componentry. In certain embodiments, the componentry of the architecture can comprise hardware, software, or a combination of hardware and software. The functionality provided via the architecture can be performed by utilizing memories and/or processors.

In certain embodiments, the PCP classifier 202 can comprise software, hardware, or a combination of hardware and software. In certain embodiments, the PCP classifier 202 can be configured to serve as a client with respect to the automated suspicious URL/FQDN detection system 206. In certain embodiments, the PCP classifier 202 can be configured to analyze all requests being made by devices, systems, programs, or a combination thereof, being monitored by the PCP classifier 202. In certain embodiments, the PCP classifier 202 can be configured to analyze any requests (e.g., web requests, requests to access online resources, requests to access computing systems, requests to access devices, and/or other requests) before a device, system, and/or program is able to access the content, information, devices, systems, or a combination thereof, that the requests are seeking to access. In certain embodiments, the PCP classifier 202 can be configured to make a preliminary determination regarding the suspiciousness of an identifier (e.g., URL, FQDN, web address, link, or other access mechanism) based on comparing the identifier to a list of identifiers known to be suspicious or not suspicious. In certain embodiments, the PCP classifier 202 can be configured to forward each request directly to the automated suspicious URL/FQDN detection system 206 without making a preliminary determination first so that the automated suspicious URL/FQDN detection system 206 can make the determination regarding suspiciousness of the request and identifier associated with the request. In certain embodiments, the PCP classifier 202 can be configured to classify and/or label requests and/or identifiers as being suspicious based on the determinations (or indications) from the automated suspicious URL/FQDN detection system 206 and persist (or store) the classifications and/or labels in a PCP database 204, which can be database 155 or a different database.

In certain embodiments, the labeled dataset can be utilized by the automated suspicious URL/FQDN detection system 206 to train machine learning models for subsequent determinations relating to suspiciousness. In certain embodiments, the determinations (or indications) from the PCP database 204 can be submitted for further verification, such as by a user 121 and/or by any other componentry of the system 100. If the user 121 or other componentry verifies the determination, the verified determination of suspiciousness can be stored in the PCP database 204 and can then be utilized by the PCP classifier 202 to prevent a device from accessing a resource associated with the identifier (e.g., web address, link, URL, FQDN, or other access mechanism) based on the verified determination of suspiciousness. If the user 121 or other componentry rejects the original determination (or indication), the rejection can be saved in the PCP database 204 and the device can be authorized to interact with the identifier and access the resource that the identifier is directed to.

In certain embodiments, the inference pipeline service 208 can be configured to obtain and/or access machine learning models from the model registry 212, which can be generated and/or trained by the training pipeline service 210. In certain embodiments, the inference pipeline service 208 can receive requests from the PCP classifier 202, which can be configured to detect when a user (e.g., first user 101) of user device (e.g., first user device 102) is attempting to access an identifier (e.g., URL, address, FQDN, access mechanism, and/or link). Upon detection of the access attempt, the PCP classifier 202 can generate a request for the automated suspicious URL/FQDN detection system 206 to determine whether the identifier (e.g., URL) and/or resource referenced by the identifier is suspicious. In certain embodiments, the request can be received by the inference pipeline service 208 of the automated suspicious URL/FQDN detection system 206. Once the request is received, the inference pipeline service 208 can select a machine learning model (e.g., an optimal machine learning model) to process the request to make the determination regarding suspiciousness of the identifier and/or the resource(s) relating thereto. In certain embodiments, the machine learning model can be selected from the model registry 212. In certain embodiments, the machine learning models can be developed and/or trained by the training pipeline service 210, which can persist developed and trained machine learning models in the model registry 212.

In certain embodiments, once a machine learning model is obtained from the model registry 212, such as in response to receipt of a request from the PCP classifier 202, the inference pipeline service 208 can also load the corresponding features from a feature store 214. In certain embodiments, the features that represent an identifier, such as, but not limited to, an address, URL, FQDN, and/or other access mechanism could be of any categories such as lexical, host based, webpage screenshot based, content-based, and/or other categories, which are described herein. The inference pipeline service 208 can be configured to load any of such features from the feature store 214 if the corresponding feature exists, or the inference pipeline service 208 can dynamically compute such features directly from the identifier (e.g., web address, URL, FQDN, or other access mechanism) in question and/or from samples having a correlation to the identifier that can be obtained from the sample store 216 and which can have been originally obtained from the PCP database 204.

In certain embodiments, the inference pipeline service 208 can then be configured to determine whether the particular identifier (e.g., address, URL, FQDN, or other access mechanism) is suspicious or not based on the retrieved model and relevant features. In certain embodiments, the determination can be made by executing the machine learning model using the relevant features. For example, if identifier features of the identifier have a similarity (e.g., a threshold similarity) with training features that the machine learning model has been trained to identify as suspicious, the identifier can be determined to be suspicious. As another example, if certain identifier features have characteristics in common with training features known to be suspicious, such commonality can be utilized to determine that the identifier is suspicious. In certain embodiments, apart from deciding the class label such as suspicious or benign for the identifier (e.g., address, URL, FQDN, or other access mechanism), the inference pipeline service 208 can optionally determine the suspiciousness score of the requested identifier (e.g., address, URL, FQDN, or other access mechanism). For example, the scores can range from 0 to 1 or from 0-100 and the higher the score, the higher the suspiciousness of the identifier. In certain embodiments, for example, the score can be based on the type of risk associated with the identifier (e.g., redirects to mostly harmless advertisements vs. redirecting to a malicious website that is utilized by malicious actors to steal credit card numbers and social security numbers). Once the decision is made about the requested identifier (e.g., address, URL, FQDN, or other access mechanism), the inference pipeline service 208 can provide the determination and/or score in a response back to the PCP classifier 202 in response to the PCP classifier's 202 request. After obtaining the decision about an identifier (e.g., address, URL, FQDN, or other access mechanism), the PCP classifier 202 can persist that information into the PCP database 204.

In certain embodiments, the training pipeline service 210 can be utilized to train and/or develop machine learning models that can be utilized by the inference pipeline service 208 to make suspiciousness determinations. For example, in certain embodiments, the training pipeline service 210 can be configured to receive labeled data (i.e., “class label” which is known for a particular URL/FQDN) from the PCP database 204 verified by in-house security experts or researchers (e.g., second user 121), or the data can be gathered from any crowdsourced people, devices, and/or systems that can be external to the system 100. In certain embodiments, the training pipeline service 208 can obtain labeled data (such as for a supervised machine learning technique) from the PCP database 204 or any such source in order to perform the training task and develop a machine learning model that can be consumed and/or executed by the inference pipeline service 208. In certain scenarios, it can be that not all decisions made by the system 100 can be correct an, as a result, the system 100 can verify such decisions using feedback from a human expert, other systems, devices, and/or artificial intelligence systems about the decisions made by the system 100, and particularly the inference pipeline service 208 of the system 100.

In certain embodiments, the obtaining of the feedback from human experts (or other devices and systems) can be an automatic process, and the training pipeline service 210 can obtain the correct label of historical samples from labeled datasets for which the decision was wrong in the past, such as from the PCP database 204. In certain embodiments, a sampling strategy can be utilized to fetch new samples from the PCP database 204 in order to automatically retrain the system 100 and/or machine learning models, and produce a new machine learning model without any human intervention in the model retraining process. In certain embodiments, the training process inside the training pipeline service 210 can include a plurality of operations. For example, initially, the labeled dataset (which can include previous determinations and/or labeled samples that have been fed into the PCP database 204) can be to be obtained from the PCP database 204, and, based on a selected or random sampling strategy, data samples such as training samples, validation samples and test samples can be computed from the original labeled dataset. In certain embodiments, the computed samples can be persisted into a sample store 216.

Then, in certain embodiments, features (e.g., lexical, host based, content-based, etc.) corresponding to each sample type can be computed and the features (e.g., training featureset, validation featureset and test featureset) can also be persisted into a feature store 214, such as for reusability purposes. Once features computation is completed, one or more supervised learning techniques can be utilized to find the optimal model based on use case specific optimization criteria targeting certain evaluation metrics. Such criteria and/or metrics can relate to the required amount of computer resources that can be used by a model, whether the model is capable of making a determination relating to suspiciousness, whether the model is of a certain size, whether the model has certain functionality, whether the model has a particular machine learning and/or artificial intelligence algorithm, whether the model is capable of provide higher accuracy determinations (e.g., a threshold level), whether the model is more efficient than other models, and/or any other criteria and/or evaluation metrics. In certain embodiments, the developed machine learning model can be persisted in a model registry 212 along with useful metadata about the model. In certain embodiments, the metadata can be utilized to describe the features and/or functionality of the model, the types of algorithms that the model utilizes, the types of determinations that the model is capable of making, the types of features that the model can process, the types of training data utilized to train the model, the datasets utilized to train the model, a version of the model, a last update time of the model, any other information associated with the model, or a combination thereof. Exemplary algorithms that can be utilized by the system 100 can include, but are not limited to, classification algorithms, logistic regression algorithms, support vector machine algorithms, Naive Bayes algorithms, decision trees, ensemble techniques, deep learning algorithms, and/or any other types of algorithms.

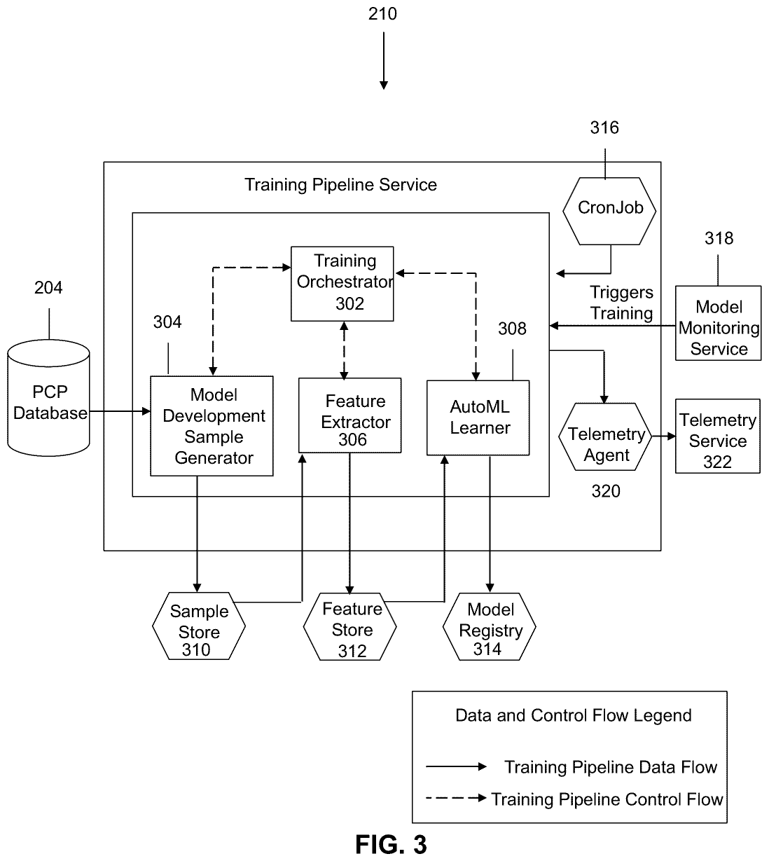

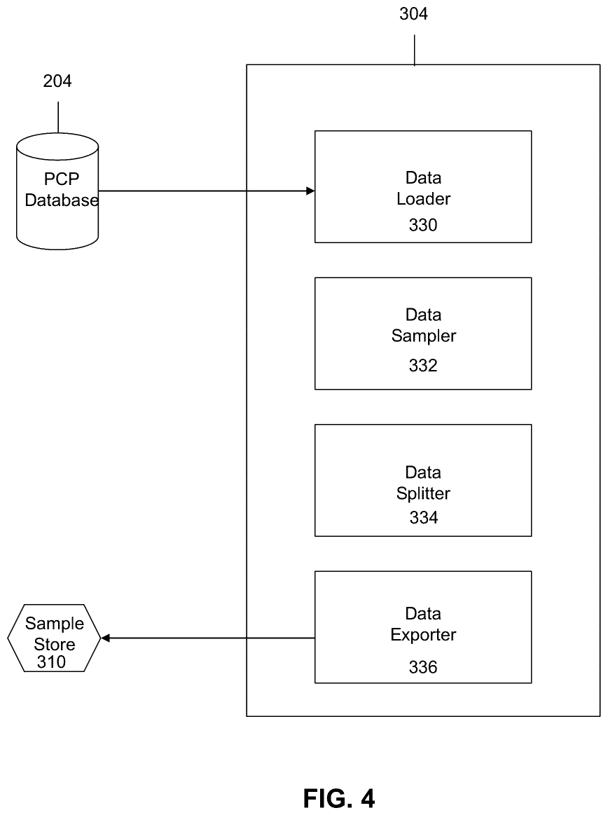

Referring now also to FIGS. 3 and 4, further details relating to exemplary architectures and functionality of the training pipeline service 210 and the inference pipeline service 208 are shown. In certain embodiments, the dashed lines in FIGS. 3-4 can represent control signal flow and the solid lines can represent data flow. In FIG. 3, exemplary componentry of the training pipeline service 210 is shown. In certain embodiments the training pipeline service 210 can be communicatively linked to the PCP database 204, such as to receive labeled datasets (e.g., including data labeled indicating suspicious or not) which can be utilized to train and/or develop models for use by the inference pipeline service 208 to determine suspiciousness of address, URLs, FQDNs, and/or other access mechanisms that a user can be attempting to access to gain access to various online or other resources. In certain embodiments, the training pipeline service 210 can include, but is not limited to including, a training orchestrator 302, a model development sample generator 304, a feature extractor 306, a learner 308 (e.g., an AutoML learner), a sample store 310 (can be the same as sample store 216), a feature store 312 (can be the same as feature store 214), a model registry 314 (can be the same as model registry 212), a CronJob 316, a model monitoring service 318, a telemetry agent 320, a telemetry service 322, any other componentry, or a combination thereof.

In certain embodiments, when developing and/or training a machine learning model, the training pipeline service 210 can be configured to obtain labeled datasets from the PCP database 204, which can have received the labeled datasets from the PCP classifier 202 during operation of the system 100. In certain embodiments, the training orchestrator 302 can transmit a signal activating operation of the model development sample generator 304. In certain embodiments, the model development sample generator 304 can be configured to receive labeled datasets from the PCP database 204 and then generate a plurality of samples from the labeled datasets. For example, in certain embodiments, the model development sample generator 304 can be configured to utilize a sampling strategy to compute data samples from the labeled datasets. In certain embodiments, the data samples can include, but are not limited to, training samples (e.g., samples to train models), validation samples (e.g., samples relating to validation of a determination of suspiciousness and/or samples for use in a process to evaluate a developed or updated machine learning model with a testing dataset), and test samples (e.g., samples to test functionality of the machine learning models). In certain embodiments, the generated samples can be stored in the sample store 310 for use by other componentry of the system 100. In certain embodiments, the model development sample generator 304 can notify the training orchestrator 302 of the generation of the samples from the labeled dataset.

In certain embodiments, the training orchestrator 302 can be configured to transmit a control signal to the feature extractor 306, which can be configured to obtain the samples from the sample store 310. In certain embodiments, the feature extractor 306 can be configured to extract features (e.g., training features, such as, but not limited to, lexical, host-based, content-based, etc.) from the samples provided by the sample store 310. Once the features are extracted, the feature extractor 306 can store the features in feature store 312 so that they can be utilized by various components of the system 100. The feature extractor 306 can notify the training orchestrator 302 that the features have been extracted from the samples, and the training orchestrator 302 can transmit a control signal to the learner 308 to trigger generation and/or training of one or more machine learning models to support the operative functionality of the system 100, such as to make determinations or predictions relating to the suspiciousness of a URL attempting to be accessed by a user. In certain embodiments, the learner 308 can be activated and can generate one or more models based on the samples and/or features, which can be obtained from feature store 312. In certain embodiments, the learner 308 can train an existing model or train a new model using the samples and/or features. In certain embodiments, the learner 308 can develop models and then store them in the model registry 314 for future use, such as by the inference pipeline service 208. The learner 308, once the model(s) are generated, can notify the training orchestrator 302 accordingly.

In certain embodiments, componentry of the training pipeline service 210 can be utilized to trigger training of the machine learning models. For example, the CronJob 316 can trigger training of the machine learning models, which can trigger operation of the training orchestrator 302. In certain embodiments, the model monitoring service 318 can monitor model generation and/or training and can trigger training, such as based on the receipt of requests, based on a schedule, randomly, based on desired features, based on desired tasks, or a combination thereof. As machine learning models are generated, trained, and/or tested (e.g., such as on sample datasets), telemetry data relating to the machine learning models and the training pipeline service 210 can be provided to a telemetry agent 320, which can be configured to communicate with a telemetry service 322. In certain embodiments, the telemetry service 322 can be configured to analyze, from the telemetry data, the performance of machine learning models (e.g., how much computing resources they require), the types of decisions or predictions that each machine learning models is capable of performing, the efficiency of the machine learning models, the algorithms utilized by the machine learning models, the versatility of the machine learning models, the time at which machine learning models have been utilized and/or executed, the training history of the learning models, or a combination thereof. Any types of performance or other metrics associated with operation of the training pipeline service 210 can be included in the telemetry data that can be analyzed by the telemetry service 322. In certain embodiments, the telemetry service 322 can be utilized to make recommendations for modifying machine learning models, incorporating new functionality into machine learning models, replace algorithms utilized by the machine learning models, establish requirements for performance of machine learning models, specify an amount of computing resources within which the machine learning models must perform, or a combination thereof. In certain embodiments, the training pipeline service 210 can be configured to provide one or more machine learning models and/or features for use by the inference pipeline service 208, such as when the inference pipeline service 208 receives requests to determine suspiciousness of URLs/FQDNs from the PCP classifier 202.

Referring now also to FIG. 4, an exemplary architecture of the model development sample generator 304 for generating samples to create machine learning models to detect suspicious digital identifiers according to embodiments of the present disclosure is shown. In certain embodiments, for example, the model development sample generator 304 can be configured to include any number of software modules or components supporting the functionality of model development sample generator 304 and/or the system 100. In certain embodiments, model development sample generator 304 can include a data loader 330, a data sampler 332, a data splitter 334, a data splitter 336, along with any other components. The foregoing components/modules can be utilized to fetch imbalanced labeled data from a PCP database 204 and persist categorized balanced labeled samples in such a way that it is feasible to utilize the balanced labeled categorized samples to build and/or train a machine learning model for identifying suspicious digital identifiers. In certain embodiments, the data loader 330 can comprise software, hardware, or a combination of hardware and software, and can be configured to obtain or fetch labeled dataset containing samples from a PCP database and store the dataset in a memory location. In certain embodiments, the labeled dataset can include suspicious samples and non-suspicious samples that have been verified by an expert, a system, or a combination thereof. In certain embodiments, the labeled dataset can be imbalanced where the number of non-suspicious samples can be significantly greater than the number of suspicious samples or vice versa such that a machine learning model trained on such samples would be biased towards the majority class, thereby resulting in unsatisfactory performance for the machine learning model in terms of accurately performing suspiciousness determinations for digital identifiers. In certain instances, a model trained on an imbalanced dataset could fail to determine a valid suspicious digital identifier and could respond with non-suspicious instead of suspicious. For example, if the PCP database 204 has 1 million samples and 900,000 of them are non-suspicious URLs/FQDNs and, if a general supervised machine learning model is trained using such samples, a production machine learning model could be heavily biased towards non-suspicious URL/FQDN because the dataset has a greater number of non-suspicious URL/FQDNs than suspicious URL/FQDNs.

Creating a balanced dataset, which is unbiased from an imbalanced dataset can be difficult and prone to errors. Several complex criteria can be considered such as the beginning time of sample generation, the size of the sample(s), different weight factor for creating a balanced sample, among other criteria. Moreover, the balanced sample can be categorized as well with ratio preservation before the model training process can be started. The model development sample generator 304 can be configured to create a balanced sample dataset with the ability to further create balanced categorized samples, because most of the common machine learning algorithms are not capable enough to handle an imbalanced dataset. When fetching the dataset containing the samples, the data loader 330 can have configuration information about the location (e.g., information about the location in the PCP database 204) from where to fetch/load labeled data as well as date-range related information (i.e., when to start sampling and when to end sampling).

In certain embodiments, the data sampler 332 of the model development sample generator 304 can be software, hardware, or a combination of software and hardware. In certain embodiments, the data sampler 332 can be configured to create balanced labeled samples from the imbalanced labeled samples in the dataset obtained by the data loader 330. In certain embodiments, configuration information can be defined for the data sampler 332, which can be utilized by the data sampler 332 to create the balanced labeled dataset from the imbalanced labeled dataset. In certain embodiments, for example, the configuration information can include, but is not limited to, a minimum sample size (e.g., where a user and/or the system 100 specifies the minimum samples size (e.g., 1000 records of balanced labeled sample)), maximum sample size (e.g., the user and/or the system 100 specifies the maximum sample size (e.g., 1,000,000 records of the balanced labeled sample)), and the fraction of suspicious samples (e.g., the user and/or the system 100 can specify the fraction of suspicious samples (e.g., 50% of samples should be suspicious in the balanced labeled dataset)).

In certain embodiments, the model development sample generator 304 can be configured to leverage weighted random sampling on a periodic basis (e.g., monthly or other period) with a failover strategy. In certain embodiments, the in-memory imbalanced labeled samples can be grouped into two parts (i.e., suspicious and non-suspicious) and each part can be persisted into a separate in-memory data structure. Then, the sampling weight (i.e., for both suspicious and non-suspicious sample groups) can be computed from the defined fraction of suspicious samples configuration. Based on the sampling weight, a random sampling can be performed per time period (e.g., monthly) for both the suspicious and non-suspicious groups. However, in case the random weight sampling per time period fails to meet the sample size requirement for a balanced sample within a particular group, a random sampling over the entire date range (i.e., a longer time period) can be performed for that particular group. In certain embodiments, samples selected from each group (i.e., both “suspicious” and “non-suspicious”) can be merged together to form the balanced sample set and stored in-memory.

In certain embodiments, data splitter 334 of the model development sample generator 304 can be configured to create categorized labeled samples from the balanced labeled samples generated by the data sampler 334. In certain embodiments, the data splitter 334 can be software, hardware, or a combination of hardware and software. In certain embodiments, the data splitter 334 can be configured to create the categorized labeled samples using a constraint of preserving a ratio of suspicious to non-suspicious samples (or records/points). In certain embodiments, the categories to be split from the balanced labeled dataset can be training samples, validation samples, testing samples, and/or any other types of samples. In certain embodiments, each type of sample can have its own corresponding suspicious to non-suspicious ratio specified for the sample, which can be adjusted over time. Once the categorized labeled samples are created, the categorized labeled samples can be persisted into a sample store 310 for storage so that the samples can be accessed by other components of the system 100, such as, but not limited to, the feature extractor 306. In certain embodiments, the data exporter 336 can be configured to persist the categorized labeled samples into the sample store 310 so that any downstream task in the training process for training a machine learning model can access the categorized labeled samples. In certain embodiments, the data exporter 336 can be provided with configuration information for the location of the sample store 310, where the categorized balanced labeled samples can be persisted or stored.

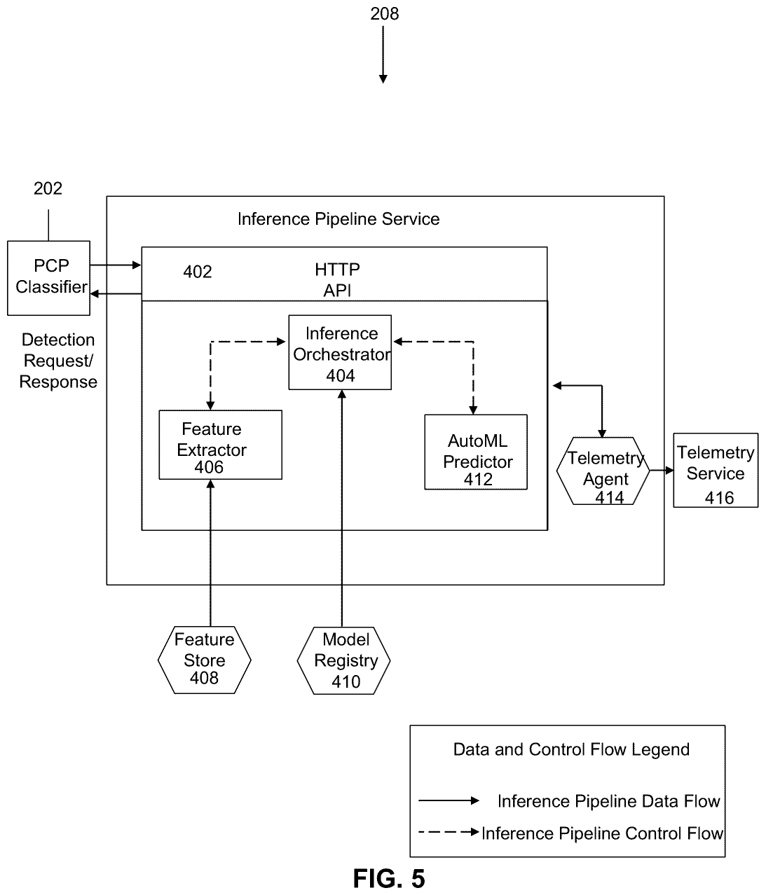

With regard to the inference pipeline service 208, further details relating to the componentry of the inference pipeline service 208 are shown in FIG. 5. In certain embodiments the inference pipeline service 208 can be communicatively linked to the PCP classifier 202, such as to receive requests to determine suspiciousness of an identifier, such as, but not limited to, an address, URLs, FQDNs, and/or other access mechanisms that a user can be attempting to access to gain access to various online or other resources (e.g., a URL, such as www[.]testurl[.]com/content.htm, which can connect a user to a certain resource (e.g., content or functionality)). In certain embodiments, the inference pipeline service 208 can include, but is not limited to including, an API 420, an inference orchestrator 404, a model development sample generator 304, a feature extractor 406, a predictor 412 (e.g., an AutoML predictor), a feature store 408 (can be the same as feature store 214), a model registry 410 (can be the same as model registry 212), a telemetry agent 414 (can be the same as telemetry agent 320 in certain embodiments), a telemetry service 416 (can be the same as telemetry service 322 in certain embodiments), any other componentry, or a combination thereof.

In certain embodiments, the inference pipeline service 208 can be configured to receive requests to determine whether an identifier, such as, but not limited to, an address, URL, FQDN, and/or other access mechanism and/or resources referenced by the foregoing is suspicious. In certain embodiments, a request(s) can be received by the PCP classifier 202, which can initiate the requests for determination of suspiciousness. In certain embodiments, the requests can be received via an HTTP API or other API that can receive the requests. Upon receipt of a request(s), the API 402 can be utilized to notify the inference orchestrator 404 to operate. In certain embodiments, the inference orchestrator 404 can transmit a control signal to the feature extractor 406, which can extract features (e.g., identifier features) from the identifier, such as, but not limited to, an address, URL, FQDN, and/or other access mechanism associated with the request. Once the features are extracted, the features can be stored by the feature extractor 406 into the feature store 408 for future use. In certain embodiments, if the features were already previously computed (e.g., address, URL, FQDN, and/or other access mechanism), such features can be retrieved from the feature store 408. Once the features are obtained, the inference orchestrator 404 can identify, select, access, and/or obtain one or more machine learning models to facilitate the suspiciousness determination from the model registry 410.

Once the features are computed and/or obtained and the one or more machine learning models are selected, the predictor 412 can be utilized to execute the one or more machine learning models using the features to determine the suspiciousness of the identifier (e.g., address, URL, FQDN, and/or other access mechanism). In certain embodiments, for example, if features of the identifier (e.g., address, URL, FQDN, and/or other access mechanism) have a threshold similarity (or match) with features known to be suspicious, such a similarity can cause the predictor 412 to predict that the identifier (e.g., address, URL, FQDN, and/or other access mechanism) is suspicious. In certain embodiments, the predictor 412 can be configured to generate a suspiciousness score for each determination. In certain embodiments, the score can be based on characteristics associated with the identifier (e.g., address, URL, FQDN, and/or other access mechanism). For example, if the machine learning model determines that a URL of a certain type is associated with theft of financial information or a particular type of malicious attacker the score can be higher than for a URL that is associated with auto-subscription to news articles or more benign type of actor.

Once a prediction or determination is made, the predictor 412 can provide the prediction to the inference orchestrator 404 and/or to other componentry of the inference pipeline service 208. In certain embodiments, the inference pipeline service 208 can generate a response including the determination (or indication) relating to suspiciousness of the identifier (e.g., address, URL, FQDN, and/or other access mechanism) of the request and transmit the response to the PCP classifier 202, which can persist the determination with labels relating to suspiciousness and/or score in the PCP database 204. In certain embodiments, telemetry data relating to the operation of the inference pipeline service 208 can be provided to a telemetry agent 414 (e.g., software), which can provide the telemetry data to a telemetry service 416 for analysis. The telemetry data can include, but is not limited to, a time of execution of one or more machine learning models to make determinations or predictions, an identification of the one or more machine learning models, the amount of execution time for executing the one or more machine learning models, the features utilized, the request provided by the PCP classifier 202, and/or any other data. In certain embodiments, the telemetry service 416 can analyze the telemetry data and transmit signals to the system 100 to modify the one or more models, specify specific computer resource usage, the type of functionality necessary for the models, the types of algorithms needed for the models, requirements for the models, whether componentry and/or functionality of the inference pipeline service 208 needs to be changed, any other actions, or a combination thereof.

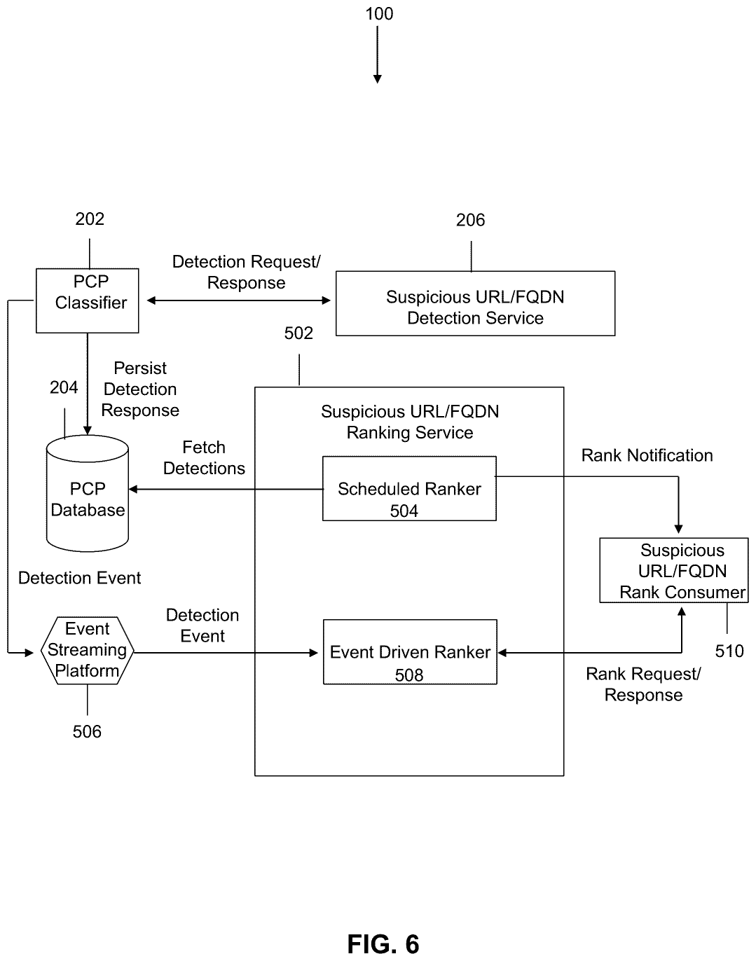

Referring now also to FIG. 6, an exemplary architecture of a suspicious URL/FQDN ranking service 502 for ranking suspicious identifiers (e.g., addresses, URLs, FQDNs, access mechanisms), and/or resources for use with the system 100 according to embodiments of the present disclosure is shown. In certain embodiments, as the suspicious URL/FQDN detection service 206 provides responses in response to requests from the PCP classifier 202, the responses can be labeled (e.g., suspicious or not and/or with any other metadata) and stored in the PCP database 204. In certain embodiments, the suspicious URL/FQDN ranking service 502 can include a plurality of rankers, including a scheduled ranker 504 and an event driven ranker 508. In certain embodiments, the scheduled ranker 504 can be configured to rank identifiers (e.g., addresses, URLs, FQDNs, domains, and/or other access mechanisms), and/or resources relating thereto. In certain embodiments, the scheduled ranker 504 can be configured to run on a schedule (e.g., every few hours or every other day or other interval) and can rank the identifiers (e.g., addresses, URLs, FQDNs, domains, and/or other access mechanisms), and/or resources based on their suspiciousness score. The rankings can be provided via a notification to a suspicious URL/FQDN rank consumer 510, which can store a list of rankings and consume the rankings. In certain embodiments, the event driven ranker 508 can be configured to operate based on events, such as in response to requests for rankings sent by the PCP classifier 202 and/or other componentry of the system 100. The requests can be received by the event streaming platform 506, which can notify the event driven ranker 508. The event drive ranker 508 can be configured to rank identifiers (e.g., addresses, URLs, FQDNs, domains, and/or other access mechanisms), and/or resources based on suspiciousness score and provide the rankings to the suspicious URL/FQDN rank consumer 510 for storage. The rankings can also be provided in a response back to the PCP classifier 202, such as via the event streaming platform 506 and/or other componentry of the system 100. The rankings of identifiers (e.g., addresses, URLs, FQDNs, domains, and/or other access mechanisms), and/or resources can be utilized to adjust how the system 100 reacts to attempts to access identifiers (e.g., addresses, URLs, FQDNs, domains, and/or other access mechanisms), and/or resources. For example, the higher in the list of rankings that a particular URL is, the more restrictive the response can be. As an illustration, the highest ranked identifier can be completed blocked from being accessed and future requests to access the identifier can be preemptively prohibited. However, for an identifier lower on the list, limited access to the resource associated with the identifier can be provided, such as for a fixed duration of time or for only certain types of content.

Although FIGS. 1-6 illustrates specific example configurations of the various components of the system 100, the system 100 can include any configuration of the components, which can include using a greater or lesser number of the components. For example, the system 100 is illustratively shown as including a first user device 102, a second user device 122, a communications network 133, a communications network 134, a communications network 135, a server 140, a server 145, a server 150, a server 160, edge devices 120, 132, a database 155, a PCP classifier 202, a PCP database 204, an automated suspicious URL/FQDN detection system 206, an inference pipeline service 208, a training pipeline service 210, a model registry 212, a feature store 214, a sample store 216, a training orchestrator 302, a model development sample generator 304, a feature extractor 306, an auto machine learning learner 208, a sample store 310, a feature store 312, a model registry 314, a telemetry agent 320, a model monitoring service 318, a telemetry service 322, and/or other componentry. However, the system 100 can include multiple first user devices 102, multiple first user devices 102, multiple second user devices 122, multiple communications networks 133, multiple communications networks 134, multiple communications networks 135, multiple servers 140, multiple servers 145, multiple servers 150, multiple servers 160, multiple edge devices 120, 132, multiple databases 155, multiple PCP classifiers 202, multiple PCP databases 204, multiple automated suspicious URL/FQDN detection systems 206, multiple inference pipeline services 208, multiple training pipeline services 210, multiple model registries 212, multiple feature stores 214, multiple sample stores 216, multiple training orchestrators 302, multiple model development sample generators 304, multiple feature extractors 306, multiple auto machine learning learners 208, multiple sample stores 310, multiple feature stores 312, multiple model registries 314, multiple telemetry agents 320, multiple model monitoring services 318, multiple telemetry services 322, and/or multiple of other componentry, and/or any number of any of the other components inside or outside the system 100. Furthermore, in certain embodiments, substantial portions of the functionality and operations of the system 100 can be performed by other networks and systems that can be connected to system 100.

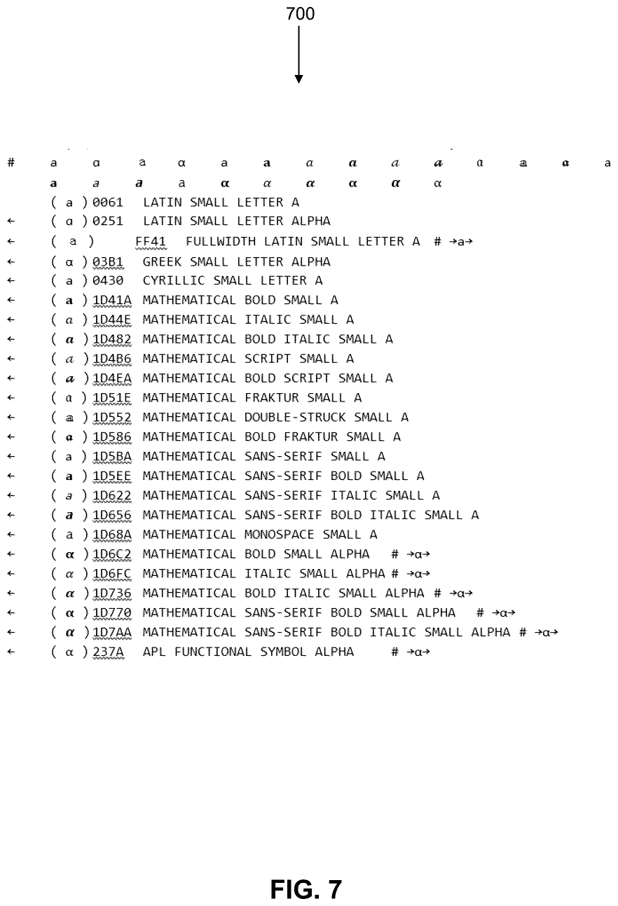

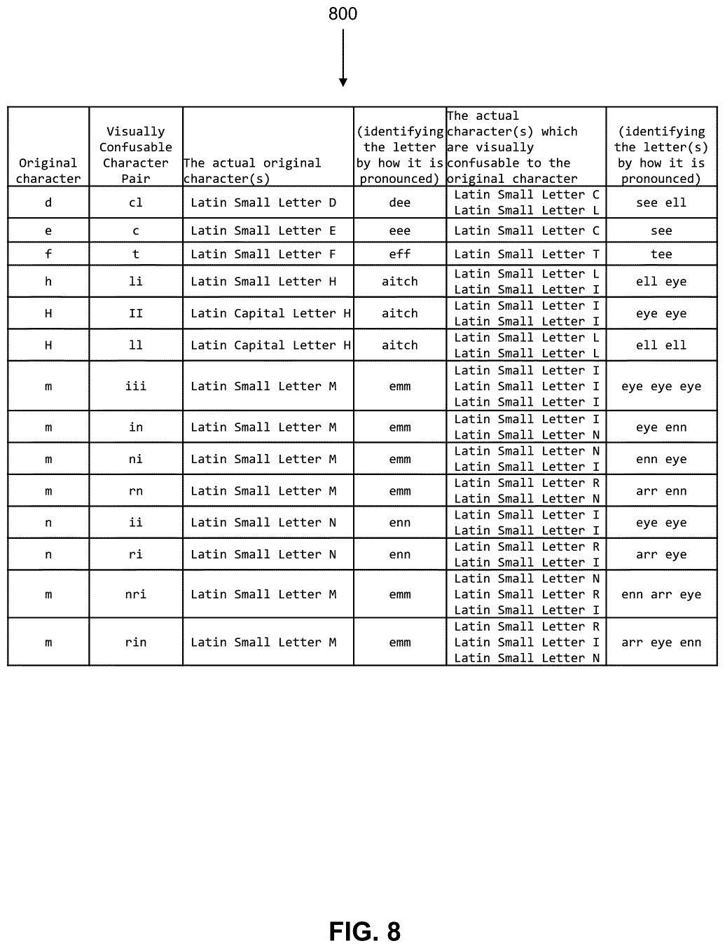

In certain embodiments, the system 100 and methods can incorporate further functionality and features. Notably, the system 100 and methods can be configured to consider a variety of use-case scenarios. An exemplary use-case scenario is in the context of features, such as, but not limited to, confusables, information relating to which is shown in FIGS. 7 and 8. In Unicode there can be many different characters (e.g., code points), which can have glyphs associated with them that look similar to each other. The foregoing creates opportunities for malicious actors to register a domain that visually appears similar to a different domain. As another example, a malicious actor can use these confusable characters within the non-domain parts of a URL in an attempt to deceive a person reading the URL, but to avoid straight-forward comparisons with text strings that can lend a sense of authenticity to a URL. For example, a small section of the “confusablesSummary.txt” available at www[.]unicode[.]org/Public/security/revision-03/confusablesSummary.txt can be examined. As an illustration, for the “Latin Small Letter A”, there are twenty-four different Unicode characters that appear very similar to each other, as shown in the table 700 in FIG. 7. As a result, a malicious actor can have registered a domain atesturl.com (where the first character is the character 0430 CYRILLIC SMALL LETTER A, and not the character 0061 LATIN SMALL LETTER A. Obviously, “atesturl.com” looks similar to “atesturl.com”. However, the foregoing URLs are not the same text string and will not compare as equal, such as when examined by the system 100. As a result, a malicious actor can evade security measures which look for brand impersonation to deceive users into thinking that they are dealing with an authentic entity when, in reality, they are dealing with a website controlled by a malicious actor.

As another example, a malicious actor can also use Unicode confusables in the path portion of a URL. E.g., an attacker can use the URL: www[.]attackerexample[.]com/atestur/security-login/. The word “atesturl” in the path might not be using all of the Unicode Latin Small Letters, but some other Unicode confusables. Indeed, there could be millions, or billions, or even trillions of possible words that use one or more Unicode confusables to look similar to a single word. As a result, a security component which examines the URL can not see a straightforward match with the string “amazon” (which uses all Latin Small Letters). In certain embodiments, for example, a URL can be considered suspicious if the URL contains any characters in the Unicode Confusables list that are not Latin Small Letters or Latin Capital Letters. In certain embodiments, a check by the system 100 can be made to determine whether a URL contains confusably similar strings to a list of authoritative strings. In certain embodiments, for example, a list of authoritative strings could include a list of bank names or the names of payment processing companies. In certain scenarios, a malicious actor can use authoritative strings to deceive a user into thinking that the user is dealing with an authentic website.

As another example, a list of authoritative strings can consist of a list of words associated with concepts, such as “security” or “logon.” In such a scenario, a malicious actor could use confusable Unicode characters to prevent straightforward character matching for detection. In certain embodiments, in order to perform such a check efficiently, the system 100 can generate a copy of the candidate URL for checking by using “canonical” Latin characters (hereafter the “canonical Latin URL copy”). For example, referencing the example above for Unicode confusables for the 0061 LATIN SMALL LETTER A, if any of the characters in the candidate URL are the characters as shown in table 700 of FIG. 7. If so, then in the copy of the candidate URL any such characters can be replaced by 0061 LATIN SMALL LETTER A. In certain embodiments, the copy of the candidate URL (a “canonical Latin URL copy”) can then be checked by the system 100 against a list of authoritative strings efficiently to determine whether there is a match. In certain embodiments, the existence of a match on the canonical Latin URL copy with a list of authoritative strings (i.e., one or more of the authoritative strings occurs within the canonical Latin URL) can raise a suspicion score for the URL. In certain embodiments, a high enough suspicion score can result in a straightforward classification of the URL as suspicious by the system 100

In certain embodiments, the list of possible matches between strings in possibly multiple lists of authoritative strings and the text of the “canonical Latin URL copy” can themselves be features to be used in the system 100 described herein. Lists of authoritative strings can be, for example, a list of names of companies, brands, organizations, governmental agencies, and the like. Lists of authoritative strings can be words that are related to a particular concept. For example, the concept of authentication can have a list that includes the following words: logon, login, signon, signin, log-on, log-in, sign-on, sign-in, logout, log-out, signout, sign-out, logoff, log-off, signoff, sign-off, singlesignon, singlesign-on, single-signon, single-sign-on, sso, password, reset, authenticate, authentication, authorize, authorize, authorization, authorization, auth, authn, authz, register, registration, and/or other related words. In certain embodiments, a URL that contains one or more of the words in the list can appear more authentic and authoritative to a user. This type of deception perpetrated by the malicious actor can be used to entice the user into clicking a link for that URL to arrive at a website under the control of the malicious actor, where the malicious actor can attempt to steal credentials or download malicious software or documents.

In certain embodiments, the system 100 can incorporate and/or utilize any number of lists of authoritative strings for different concepts, such as banking, finance, payments, healthcare, hospitals, insurance, manufacturing, shopping, and/or any other concept. Matches with respect to separate lists of authoritative strings can be used to create separate components of a suspicious score for a URL (which can be subsequently combined with other suspicious scores from other lists, or from other extracted features to create a composite suspicious score which can be used by a security component of the system 100 to allow access to the site at the URL, or to block access to the URL, or to redirect the access to the URL into a security session such as an RBI session (Remote Browsing Isolation), or to trigger a manual and/or automated security investigation of the site at the URL, or a combination thereof), or can themselves can be features used in the determination of suspiciousness process described in the present disclosure.

In certain scenarios, there can be several other notions similar to Unicode confusables that deal with a different type of visual confusion that an attacker might use. For example, another type is “confusable Latin characters” and a further type is “kerning confusables.” With regard to confusable Latin characters, malicious actors can attempt to deceive users by the visual confusion that can occur between different Latin characters. For example, the Latin Small Letter L “1” and the Latin Digit 1 “1”, or the Latin Small Letter “z” and the Latin Digit “2”, the Latin Capital Letter “B” and the Latin Digit “8”. There can be any number of other single character (or multiple character) confusions. This foregoing can be handled in the same way as described above for using a “canonical Latin URL copy”. In certain embodiments, the system 100 can utilize a table of single character Latin character confusables to create a “canonical Latin confusables URL copy” in which, for example, whenever the digit “1” is encountered the digit is canonically replaced by the Latin Small Letter L “1”, and so forth. The canonical approach can enable efficient matching, and the generation of resultant suspicious scores, or the generation of features for use by the system 100 as described herein.

With regard to kerning confusables, malicious actors can use confusion of adjacent lower-case characters to look like different characters. E.g., “bankofarnerica” could be confused with “bankofamerica” visually. The former has the letters “r” and “n” positioned adjacent to each other, which can be visually confused with the letter “m”. Such a scenario can constitute a “kerning confusable.” An exemplary table of example kerning confusables is shown in the table 800 of FIG. 8. Thus, in a manner similar to how the technique described above that involves creating a “canonical Latin URL copy” to enable efficient comparison to any number of lists of authoritative terms, using the kerning confusables can be used to create a “canonical kerning confusables URL copy” for matching by the system 100. The foregoing capability reveals deceptions used by malicious actors using the kerning confusables techniques. In certain embodiments, the system 100 can detect matches against lists of authoritative strings that can be used to generate additional features to be used in the machine learning models, or can be used directly to create additional components of a suspicious URL score.

In certain embodiments, the system 100 can be utilized for error correcting matches for canonical URLs (or other identifiers, such as FQDNs, addresses, etc.). As described in the present disclosure, the system 100 can enable a matching process to determine whether a canonical form of the URL contains terms from one or more lists of authoritative strings. For example, the system 100 can look for any exact matches of terms from the lists within the canonical form of the URL. However, a malicious actor can have gone further in their attempt to deceive a user, and in addition to using confusables, the malicious actor can be using typographical changes, substitutions, and/or insertions, and/or deletions. In certain embodiments, an edit distance to compute the distance between two strings in terms of the number of (e.g., possibly weighted sum) edit operations (e.g., insert a character, delete a character, substitute a character, transpose two characters). In certain embodiments, any of the preceding comparisons of any sort of canonical form of a URL can utilize the edit distance to consider not just exact matches, but also matches which are a configurable amount of edit distance away from each other. For example, an acceptable match can be an edit distance that is less than or equal to one quarter of the length to the matched string in the canonical form a URL or the matched string in an authoritative list. The foregoing can be used to create suspicious score components (which are combined to yield a composite “suspicious score”). In certain embodiments, the foregoing can be used to generate additional features for use in a machine learning process of the system 100.

Another scenario that the system 100 can be utilized to thwart malicious actors is enabling the system 100 to factor the type of device on which a URL (or other identifiers, such as FQDN, link, address, or other access mechanism) is displayed. For example, the type of device (e.g., a mobile device where it can be more difficult to read a complete URL, where it can be more difficult to detect an attacker's use of a Unicode confusable) can be an additional feature factored by the system 100 described above. For example, there can be more risk if the candidate URL is viewed on a mobile device versus a desktop device, where the complete URL can be more readily viewed or perceived.

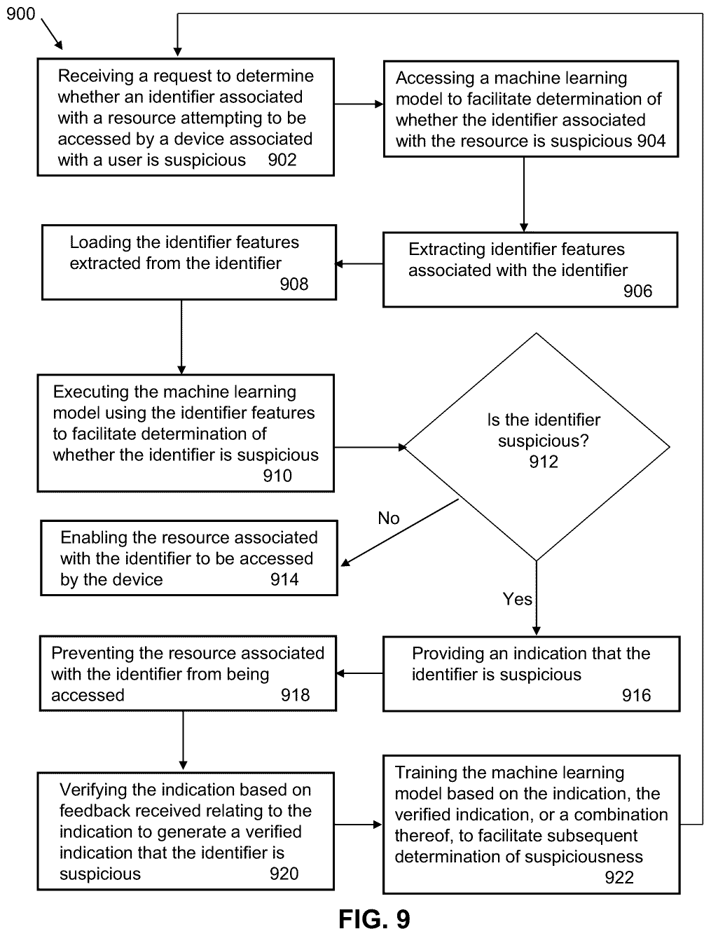

Referring now also to FIG. 9, FIG. 9 illustrates an exemplary method 900 for providing automated detection of suspicious identifiers (e.g., URLs, FQDNs, etc.) according to embodiments of the present disclosure. In certain embodiments, the method of FIG. 9 can be implemented in the system 100 of FIGS. 1-6 and/or any of the other systems, devices, and/or componentry illustrated in the Figures. In certain embodiments, the method of FIG. 9 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 9 can be performed at least in part by one or more processing devices (e.g., processor 102, processor 122, processor 141, processor 146, processor 151, and processor 161 of FIG. 1) and/or other devices, systems, components, or a combination thereof, of FIGS. 2-6. Although shown in a particular sequence or order, unless otherwise specified, the order of the operations in the method 900 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Generally, the method 900 can include operations for providing automated detection of suspicious identifiers. Notably, the method 900 can include operations for receiving request to determine whether an identifier (e.g., an address, URL, FQDN, and/or other access or input mechanism) associated with a resource attempting to be accessed by a device is suspicious. In certain embodiments, the method 900 can include accessing an optimal machine learning model to facilitate determination regarding suspiciousness of the identifier. The method 900 can include computing and/or loading identifier features extracted from the identifier. In certain embodiments, the method 900 can include executing the machine learning model using identifier features to facilitate determination regarding suspiciousness of the identifier. If the identifier is not suspicious, the method 900 includes enabling the identifier and referenced resource to be accessed by the device. If, however, the identifier is determined to be suspicious, the method 900 can include providing an indication that the identifier is suspicious. In certain embodiments, the method 900 can include verifying the indication, such as based on feedback by experts or other systems. If the identifier is verified to be suspicious, the method 900 can prevent the resource associated with the identifier from being accessed and/or notify the device attempting to access the resource that the identifier is suspicious. In certain embodiments, the method 900 can include training the machine learning model and/or other machine learning models based on the indication, the verified indication, or a combination thereof, to facilitate subsequent determinations of suspiciousness for other requests that arrive.

At 902, the method 900 can include receiving a request(s) to determine whether an identifier (e.g., address, URL, FQDN, link, or other access mechanism) associated with a resource attempting to be accessed by a device (e.g., first user device 102) associated with a user (e.g., first user 101) is suspicious. In certain embodiments, any number of requests can be received and the requests can be provided by a client, such as a PCP classifier 202, to the automated suspicious URL/FQDN detection system 206. In certain embodiments, when a request is received, the inference pipeline service 208 can be activated for operation. In certain embodiments, the receiving of the request(s) can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. At 904, the method 900 can include accessing and/or obtaining a machine learning model to facilitate determination of whether the identifier associated with the resource is suspicious. In certain embodiments, an optimal machine learning model can be obtained from a model registry 212 by the inference pipeline service 208 that has a capability for detecting suspiciousness for the particular identifier (e.g., address, URL, FQDN, or other access mechanism). In certain embodiments, the accessing and/or the obtaining can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At 906, the method 900 can include computing and/or extracting identifier features from the identifier associated with the resource. In certain embodiments, for example, the identifier features can be computed from the identifier itself, however, in certain embodiments, the identifier features can be computed from sample addresses having a correlation to the address. In certain embodiments, the features can comprise any type of features (e.g., of the identifier and/or resource, applications, systems, and/or devices that the identifier points to or references) and can include, but are not limited to, lexical features (e.g., length of identifier, length of top level domain, length of primary domain, length of hostname, length of path, number of vowels, number of consonants, whether the IP address is used as the domain name, number of non-alphanumeric characters, etc.), file name features (e.g., length of file name to be accessed, number of detainers, etc.), directory-related features (e.g., length of directory, number of sub-directory tokens, etc.), the Kolmogrov Complexity or the Shannon Entropy of an address string, bag-of-word features, etc.), host-based features (e.g., WHOIS information (e.g., domain name registration date, information relating to the registrar, information about the registrant), domain name properties (e.g., time-to-live (TTL) values from a domain registration date), geographic properties (e.g., location of the IP address), content-based features (e.g., presence of HTML forms, presence of <input> tags, presence of keywords can ask users to provide credit card information, password, social security number etc., length of HTML form, length of <style>, length of <script>, length of the whole document, average length of words, word count, distinct word count, number of words in text, number of words in title, number of images, number of iframes, number of zero size iframes, number of hyperlinks, link to remote source of script, number of null characters, usage of string concatenation, number of times domain names appear in the HTML content, number of unique subdomains (of primary domain of the URL) is present in the HTML content, number of unique directory paths for all referenced files in the HTML content, Javascript features (e.g., extensive usage of eval( ), extensive usage of unescapeo, number of long strings, number of event attachments, number of “iframe” strings), any use of non-alphanumeric Javascript obfuscation (as described, e.g., in the book “Web Application Obfuscation” by Mario Heiderich, Eduardo Alberto Vela Nava, Gareth Heyes, David Lindsay), webpage screenshot-based features (e.g., earth mover's distance between images, contrast context histogram features, scale invariant feature transform features, deep learning based features of images), character features (e.g., characters in the identifier), features relating to the edit distance between strings and/or characters in the identifier, HTML content in the identifier features, other features, or a combination thereof. In certain embodiments, the computing of the features (e.g., identifier features) can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At 908, the method 900 can include loading the identifier features extracted from the identifier associated with the resource (and/or the resource to which the identifier refers to). In certain embodiments, if the identifier features (or features having a similarity to the identifier features) already existed in the system 100, 906 can have been skipped, and the method 900 can have proceed from 904 directly to 908. In certain embodiments, the identifier features can be loaded from the feature store 214 into the inference pipeline service 208, and, in certain embodiments, can be directly provided to the inference pipeline service 208 after computation of the features. In certain embodiments, the loading of the identifier features can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At 910, the method 900 can include executing the machine learning model using the identifier features to facilitate determination of whether the identifier is suspicious. In certain embodiments, the executing of the machine learning model to facilitate the determination of suspiciousness can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

At 912, the method 900 can include determining if the identifier is suspicious based on execution of the machine learning model and identifier features. In certain embodiments, the determining can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. If, at 912, the identifier is determined to not be suspicious, the method 900 can proceed to 914. At 914, the method 900 can include enabling the resource associated with the identifier to be accessed by the device attempting to access the resource via the identifier. In certain embodiments, the enabling can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

If, however, at 912, the identifier is determined to be suspicious, the method 900 can proceed to 916. At 916, the method 900 can include providing an indication that the identifier is suspicious. For example, the indication can be included in a response that indicates that the identifier that is the subject of the request from the PCP classifier 202 is suspicious. In certain embodiments, for example, the inference pipeline service 208 can be configured to provide the response including the indication to the PCP classifier 202. In certain embodiments, the providing of the indication performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At 918, the method 900 can include preventing the resource associated with the identifier from being accessed. In certain embodiments, the method 900 can also include preventing interaction with an identifier determined to be suspicious. In certain embodiments, the preventing can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device.

In certain embodiments, for example, the system 100 can transmit a notification to the device indicating that the identifier is suspicious and automatically redirect the device to a different identifier and/or resource. In certain embodiments, the user can be prompted to change the identifier or access a different resource. In certain embodiments, the preventing of the accessing of the resource can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At 920, the method can include verifying the indication that the identifier is suspicious, such as based on feedback received relating to the indication to generate a verified indication that the identifier is suspicious. In certain embodiments, the verifying can be performed and/or facilitated by utilizing the server 140, the server 145, the server 150, the server 160, the communications network 135, the inference pipeline service 208, the automated suspicious URL/FQDN detection system 206, any component of the system 100, any combination thereof, or by utilizing any other appropriate program, network, system, or device. At 922, the method 900 can include training the machine learning model and/or other machine learning models based on the indication, the verified indication, or a combination thereof, to facilitate subsequent determinations of suspiciousness for addresses (or URLs, FQDNs, links, and/or other access or input mechanisms).

In certain embodiments, the method 900 can be repeated as desired, which can be on a continuous basis, periodic basis, or at designated times. Notably, the method 900 can incorporate any of the other functionality as described herein and can be adapted to support the functionality of the system 100. In certain embodiments, functionality of the method 900 can be combined with other methods and/or functionality described in the present disclosure. In certain embodiments, certain portions of the method 900 can be replaced with other functionality of the present disclosure and the sequence of operations can be adjusted as desired.

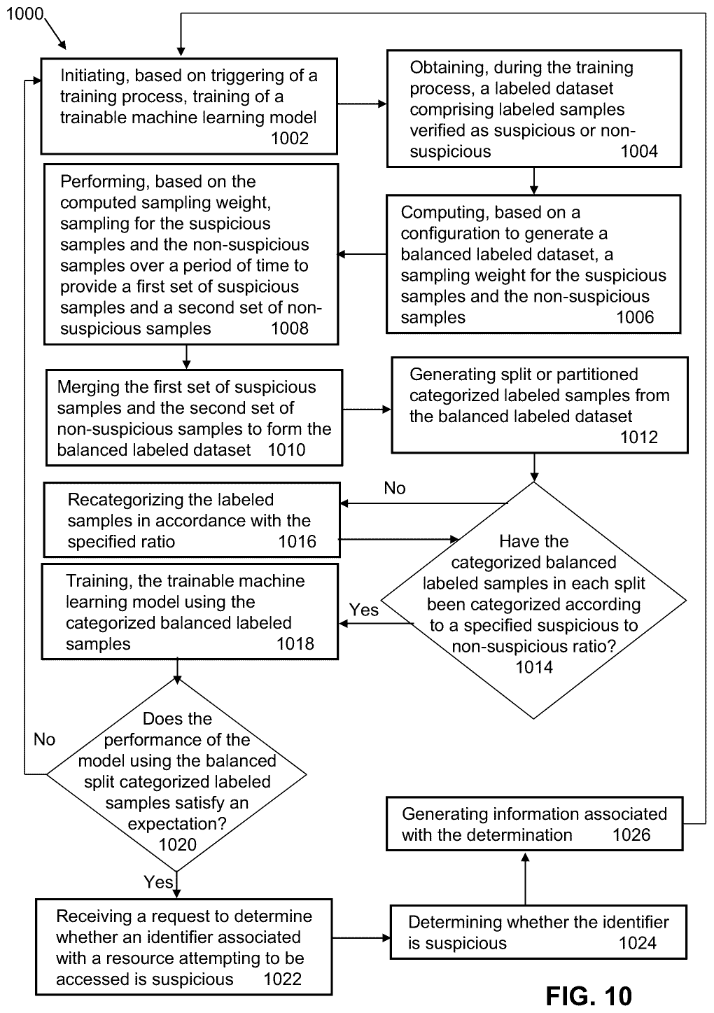

Referring now also to FIG. 10, FIG. 10 illustrates an exemplary method 1000 for generating samples to generate machine learning models to facilitate detection of suspicious identifiers (e.g., URLs, FQDNs, etc.) according to embodiments of the present disclosure. In certain embodiments, the method of FIG. 10 can be implemented in the system 100 of FIGS. 1-6 and/or any of the other systems, devices, and/or componentry illustrated in the Figures. In certain embodiments, the method of FIG. 10 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 10 can be performed at least in part by one or more processing devices (e.g., processor 102, processor 122, processor 141, processor 146, processor 151, and processor 161 of FIG. 1) and/or other devices, systems, components, or a combination thereof, of FIGS. 2-6. Although shown in a particular sequence or order, unless otherwise specified, the order of the operations in the method 1000 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. For example, in certain embodiments, the method 1000 can be combined with the method 900 and/or method 1100. In certain embodiments, the method 1000 can provide further details relating to 922 of the method 900. In certain embodiments, one or more operations of the method 1000 can be incorporated into any desired operation or position within the sequence of operations of methods 900 and/or 1100. In certain embodiments, a greater or fewer number of operations as illustrated in FIG. 10 can be incorporated into method 1000. In certain embodiments, the method 1000 can be modified to incorporate any of the functionality described in the present disclosure.

Generally, the method 1000 can include operations for generating samples to generate and/or train machine learning models to facilitate the detection of suspicious identifiers. Notably, the method 1000 can include operations for generating categorized labeled samples that can be utilized to train machine learning models to enhance detection capabilities over time. In certain embodiments, a training process can be triggered for training one or more machine learning models to perform the suspiciousness determinations. Once the training process is triggered, the method 1000 can include obtaining a labeled dataset from a database (e.g., PCP database 204). In certain embodiments, the labeled dataset can include samples that are labeled as suspicious or non-suspicious, which can be imbalanced (e.g., there can be significantly more suspicious samples versus non-suspicious samples or vice versa). In certain embodiments, the samples from the labeled dataset can be samples that include information that result from processing prior requests to determine whether identifiers are suspicious and verifying the accuracies of such determinations. In certain embodiments, the method 1000 can include computing, such as based on a configuration to facilitate generation of a balanced labeled dataset, a sampling weight for the suspicious samples and the non-suspicious samples of the labeled dataset. In certain embodiments, the configuration can specify a minimum sample size for creating the balanced labeled dataset, the maximum sample size for create the balanced labeled dataset, the fraction of suspicious samples (i.e., the number of suspicious samples desired/the total number of samples), any other configuration information, or a combination thereof.

In certain embodiments, the method 1000 can include performing, based on the computed sampling weight, sampling (e.g., stratified sampling) for the suspicious samples to generate a first set of suspicious samples and the non-suspicious samples to generate a second set of suspicious samples over a period of time (e.g., a week, a month, or other period of time). In certain embodiments, the method 1000 can include merging the first set of suspicious samples and the second set of non-suspicious samples to form the balanced labeled dataset. In certain embodiments, the method 1000 can include generating categorized labeled samples from the balanced labeled dataset. In embodiments, the categories for the categorized labeled samples can include training samples, validation samples, testing samples, other types of samples, or a combination thereof. In certain embodiments, the categorized labeled samples can be split from the balanced labeled dataset with a constraint of preserving the ratio of suspicious and non-suspicious samples (or records/points). In certain embodiments, each of the categories can have its own corresponding ratio specified for the category. Once the categorized samples are generated based on the constraint(s), the method 1000 can include developing and/or training the trainable machine learning model using features extracted from the categorized labeled samples. The method 1000 can include receiving a request to determine whether an identifier (e.g., an address, URL, FQDN, and/or other access or input mechanism) attempting to be accessed by an individual or system is suspicious. In certain embodiments, the method 1000 can include having the training machine learning model determine whether the identifier associated with the request is suspicious.

In certain embodiments, first information can be generated based on the determination regarding the lusciousness of the identifier associated with the request. For example, such first information can include a verification of whether the determination was accurate (e.g., by an expert, a system, or a combination thereof), metadata associated with the determination (e.g., how long the determination took, the type of attack associated with the identifier, etc.). In certain embodiments, the method 1000 can include determining which of the trained machine learning models (or algorithms) is the optimal machine learning model from the trained machine learning models (discussed further below). In certain embodiments, the trainable and/or trained machine learning models can be trained using the first information. In certain embodiments, the machine learning models can be trained using the labeled dataset (and/or information generated from suspiciousness determinations) to learn the model parameters (e.g., the weights, coefficients, biases, thresholds, leaf values, intercepts, support vectors, multipliers, etc. for variables learned during the training process) for the machine learning model (i.e., the model that has a highest performance with regard to the specified evaluation measures that are utilized for measuring suspiciousness determination capability). As additional requests to perform determinations regarding suspiciousness are received over time, the machine learning model(s) can be trained to enhance suspiciousness determination capability.

At 1002, the method 1000 can include initiating training of a trainable machine learning model (or any number of trainable machine learning models). In certain embodiments, the triggering of the training may occur upon the expiration of a time limit, at scheduled intervals, upon request, upon the occurrence of a specified condition (e.g., a new labeled dataset is in the PCP database 204, a request to perform a suspiciousness determination has arrived and/or been processed, the presence of other conditions, etc.). In certain embodiments, the triggering of the training may be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device. At 1004, the method 1000 can include obtaining, during the training process, a labeled dataset including labeled samples that have been verified as suspicious or non-suspicious. In certain embodiments, the label can indicate whether a particular sample is suspicious or non-suspicious. In certain embodiments, the samples can be verified as suspicious or non-suspicious by an expert, a system, a device, or a combination thereof. In certain embodiments, the verification can be a verification of a determination of suspiciousness made by the system 100 for an identifier, such as a determination made in response to a receipt of a request to access a resource associated with the identifier. In certain embodiments, the verified suspicious and/or non-suspicious samples can also contain metadata. For example, the metadata can include, but is not limited to, data indicating whether an identifier is associated with a particular type of malicious attack, whether an identifier is associated with a certain severity of attack, whether an identifier has been successful in deceiving a user or convincing the user to perform an action, the types of resources that an identifier is utilized to access (e.g., web content, streaming content, software modules, specific types of data, financially-related content, etc.), any other information, or a combination thereof. In certain embodiments, the labeled dataset can be a balanced dataset where the non-suspicious samples and suspicious samples are balanced perfectly or within a certain specified standard deviation of each other. For example, if there are an equal number of suspicious and non-suspicious samples, the labeled dataset can be perfectly balanced. As another example, if the percentage of non-suspicious samples is 52% and the percentage of suspicious samples is 48% and the difference between the percentage of suspicious samples and the percentage of non-suspicious samples fits within a specified standard deviation, the labeled dataset can still be deemed as balanced. In certain embodiments, the labeled dataset can be an imbalanced dataset where the non-suspicious samples and suspicious samples are not balanced perfectly or are not within a certain specified standard deviation of each other. Often times, when a labeled dataset is stored in the PCP database 204, the labeled dataset can be imbalanced and can then be balanced using the operative functionality of the system 100. In certain embodiments, at 1004, the method 1000 can include fetching, such as by utilizing the data loader 330, the labeled dataset including the samples and loading the into a memory. In certain embodiments, the data loader 330 can be configured to have configuration information including location information that specifies the location in the PCP database 204 from where to obtain the labeled dataset as well as date range related information (e.g., when to start sampling and when to end sampling). In certain embodiments, the obtaining of the labeled dataset can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device.

Once the labeled dataset is obtained, the method 1000 can include, at 1006, computing a sampling weight for the suspicious samples and the non-suspicious samples. In certain embodiments, the computing of the sampling weight can be based on a configuration specified for generating a balanced labeled dataset. In certain embodiments, the sampling weight can be specified by a user, the system, or a combination thereof. In certain embodiments, a balanced labeled dataset can be a dataset containing an equal number of suspicious samples and non-suspicious samples. In certain embodiments, a balanced labeled dataset does not have to be a dataset that includes an equal number of suspicious samples and non-suspicious samples. For example, the balanced labeled dataset can include a different number of suspicious samples from the number of non-suspicious samples, however, despite the difference, the difference does not result in bias (e.g., where a machine learning model would determine that an identifier is suspicious when the identifier is actually not suspicious because the model was trained using too many suspicious versus non-suspicious samples) in suspiciousness determinations when training a machine learning model using features extracted from using the non-equal numbers of suspicious and non-suspicious samples. In certain embodiments, the balanced labeled dataset can have a specified standard deviation between the numbers of suspicious samples and non-suspicious samples that are acceptable to the system 100, a user, or a combination thereof, that result in limited or no bias in suspiciousness determinations. In certain embodiments, the sampling weight can be a specified fraction of suspicious samples to the overall total number of samples that are to be in the balanced dataset. For example, in certain embodiments, the sampling weight can be computed as a number from 0 to 1 and can be calculated as (specified number of suspicious samples/(total number of suspicious and non-suspicious samples that are in the balanced labeled dataset)). In certain embodiments, the sampling weight can be a number including, but not limited to, a fraction, integer, or other number. In certain embodiments, for example, the labeled dataset can be imbalanced (i.e., there can be an imbalance with regard to non-suspicious versus suspicious samples), and the data sampler 332 can be configured to balance the samples based on the specified configuration. In certain embodiments, the configuration may specify a minimum sample size, a maximum sample size, the fraction of suspicious samples (i.e., the sampling weight (e.g., 50% of samples should be suspicious)), any other information (e.g., restrictions), or a combination thereof. For example, the minimum sample size can be specified as 1000 records for the balanced labeled dataset, the maximum sample size can be specified as 1,000,000 records for the balanced labeled dataset, and that 50% of the samples should be suspicious for the balanced labeled dataset. The data sampler 332 can be configured to leverage weighted random sampling over a time period, while implementing a failover strategy. In certain embodiments, prior to computing the sampling weight for the suspicious and/or non-suspicious samples, the method 1000 can include grouping the suspicious samples separately from the non-suspicious samples and storing the samples in separate in-memory data structures. When the computation of the sampling weight for the samples is to be performed, the samples can be retrieved from their respective in-memory data structures. In certain embodiments, the sampling weight can be computed based on the fraction of suspicious samples specified in the configuration. In certain embodiments, the suspicious samples and non-suspicious samples can be maintained in the same in-memory data structure. In such a scenario, 1010 of the method 1000 can be bypassed. In certain embodiments, the computing of the sampling weight can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device.

At 1008, the method 1000 can include performing, based on the computed sampling weight, sampling for the suspicious samples and the non-suspicious samples over a period of time (or time period) to select a first set of suspicious samples and a second set of non-suspicious samples from the labeled dataset. In certain embodiments, the period of time can be any period of time, such as a day, a week, a month, a quarter of a year, or any other period of time. In certain embodiments, period of time a timeframe during which labeled samples from a labeled dataset have been generated based on operation of the system 100 and/or stored in the PCT database 204. For example, if the period of time is the month of August, the sampling can be conducted for all the samples that are stored in the PCP database 204 during the month of August or are present in the database in the month of August. In certain embodiments, the sampling can be any type of sampling technique. In certain embodiments, the sampling technique can be stratified sampling. In certain embodiments, the sampling can be randomly sampling. In certain embodiments, the sampling over the time period can fail to meet the requirements of the configuration for the balanced labeled dataset. For example, random weight sampling for a time period of a month can fail to meet the sample size requirement for a balanced sample within a particular group. In such a scenario, the sampling can be conducted over a greater data range, such as over a quarter, half a year, or even a year until the specified size from the configuration is satisfied. In certain embodiments, the sampling over the period of time can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device.

In certain embodiments, any desired sampling strategy can be utilized for the sampling of the suspicious samples and the non-suspicious samples. In certain embodiments, the sampling strategy can include, but is not limited to including, nonprobability sampling (e.g., where certain elements of the sample population have no chance of selection or where the probability of selection cannot be accurately determined), simple random sampling (e.g., where each of the samples in the dataset have an equal chance of being selected), systematic sampling (e.g., where samples in the dataset can be arranged in a specific ordering scheme and selecting samples at regular intervals through the ordered samples), stratified sampling (e.g., where samples in the dataset have different categories (e.g., suspicious or non-suspicious) and the categories of samples can be organized into separate strata where each strum is sampled as an independent sub-population of the dataset, out of which individual samples can be randomly selected), probability proportional to size sampling (where the selection probability for each sample in the dataset is set to be proportional to its size measure), cluster sampling (e.g., where samples are selected in groups, such as by time period or other variable), quota sampling (e.g., where samples are segmented into mutually-exclusive groups and samples are selected based on a specified proportion and the selections are not random), minimax sampling (e.g., where the dataset is resampled), accidental sampling (e.g., where samples are selected based on being readily available), theoretical sampling (e.g., where samples are selected on the basis of results associated with the dataset), any other type of sampling, or a combination thereof. In certain embodiments, the sampling strategy can involve utilizing any number of training samples, validation samples, and/or test samples during the training process. In certain embodiments, the sampling strategy can include selecting only certain types and/or quantities of the samples for the training process. For example, the sampling strategy may involve only selecting a certain amount of validation samples, a greater amount of testing samples, and a lesser amount of training samples. In certain embodiments, the sampling strategy can comprise utilizing only certain subsets of the samples in the labeled dataset. For example, certain non-suspicious samples and/or suspicious samples can be selected at random or based on information contained in and/or associated with the samples (e.g., metadata associated with the samples, etc.). In certain embodiments, the sampling strategy can comprise utilizing only samples having certain types of features (e.g., lexical, etc.). In certain embodiments, the sampling strategy can be changed automatically based on time intervals, types of data present in new labeled datasets, and/or at will. In certain embodiments, the computed samples can be persisted into a sample store.

At 1010, the method 1000 can include merging the first set of suspicious samples and the second set of non-suspicious samples to form the balanced labeled dataset. As an example, the original imbalanced dataset-->X, Y→X_w, Y_w→(X_w+Y_w)→N_b (50:50) 100K. In the foregoing example, X can be the number of suspicious samples in the labeled dataset, Y can be the number of non-suspicious samples in the labeled dataset, X_w can be the first set of suspicious samples obtained from X according to the sampling weight, Y_w can be second set of the suspicious samples obtained from Y according to the sampling weight, (X_w+Y_w) can represent the merging of the of the first and second set of suspicious samples, and N_b (50:50) can represent the balanced labeled dataset, which in this case has 50% suspicious samples and 50% non-suspicious samples. In certain embodiments, the merging can include combining the first set of suspicious samples with the second set of non-suspicious samples to form the dataset. In certain embodiments, the merging can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device. At 1012, the method 1000 can include generating categorized balanced labeled samples from the balanced labeled dataset, such as by utilizing the data splitter 334 to split or partition the balanced labeled dataset into separate categories of samples based on sample type. In certain embodiments, the types of categories for the balanced labeled samples can include, but are not limited to, training samples, validation samples, testing samples, and/or other types of samples. In certain embodiments, the training samples can be samples utilized to train the trainable machine learning models to facilitate generation of a trained machine learning model, the validation samples can be samples relating to validation of a determination of suspiciousness and/or samples for use in a process to evaluate a developed or updated machine learning model with a testing dataset, and the test samples can be samples to test functionality of the machine learning models, or a combination thereof. Based on at least the foregoing, a categorized balanced labeled sample can be a sample that has been categorized as a training sample, a validation sample, or a testing sample and which also indicates whether the particular sample is suspicious or non-suspicious. For example, a training sample can be described as follows: (identifier: test.com; label: suspicious; category: training sample). Similar descriptions can be utilized for testing and validation samples.

In certain embodiments, the categorizing can be according to a constraint that includes preserving a particular suspicious to non-suspicious samples (or records/points). In certain embodiments, each category of sample can have its own separate ratio specified for the sample. In certain embodiments, for example, there can be ratios for the training split ratio (e.g., 60%), validation split ratio (e.g., 20%) and testing split ratio (e.g., 20%). For example, using the example above, the categories can be split as follows: N_b->Output: Tr_b (50:50) 60K, V_b(50:50) 20K, Te_b(50:50) 20K. In certain embodiments, stratified sampling techniques can be utilized to preserve the proportion of suspicious and non-suspicious samples in each split category split from the balanced labeled dataset. In certain embodiments, once the categorizing is completed, the categories balanced labeled samples can be stored in a sample store 310 for any downstream task in the model training process. In certain embodiments, the data exporter 336 can persist the categorized balanced labeled samples and can have configuration information identifying the location of the sample stores where categories balanced labeled samples can be persisted. In certain embodiments, the generating of the categorized balanced labeled samples can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device.

At 1014, the method 100 can include determining whether the categorized balanced labeled samples in each split or partition have been categorized according to the specified suspicious to non-suspicious ratio specified for the type of sample. In certain embodiments, the determination can be performed by comparing the achieved ratio resulting from the splitting to the ratio specified for the categorization type. In certain embodiments, the determining can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device. If one or more of the categorized types of labeled samples have not been categorized according to the specified suspicious to non-suspicious ratio, the method 1000 can proceed to 1016. At 1016, the method 1000 can include recategorizing the labeled samples in accordance with the specified suspicious to non-suspicious ratio. For example, if the ratio of suspicious to non-suspicious samples is specified as 50% and the categorizing of the labeled samples resulted in training samples at 50%, validation samples at 50%, and testing samples at 40%, the system 100 can recategorize the testing samples by reducing the number of non-suspicious samples used for the testing samples and/or obtain additional samples to cause the ratio to move from 40% to 50%. In certain embodiments, the recategorizing can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device. In certain embodiments, once the labeled samples are recategorized at 1016, the method 1000 can proceed back to 1014 to confirm that the samples have been categorized according to the specified suspicious to non-suspicious ratio(s).

If, at 1014, the categorized balanced labeled samples have been correctly categorized according to the specified suspicious to non-suspicious ratio, the method 100 can proceed to 1018. At 1018, the method can include training and/or developing the trainable machine learning model(s) using the categorized balanced labeled samples. In certain embodiments, the training and/or developing can include training the trainable machine learning model(s) to perform determinations relating to the suspiciousness of digital identifiers, such as URLs, FQDNs, and the like. By using the categorized labeled samples that are verified as being suspicious or non-suspicious for training the trainable machine learning models to become trained machine learning models, the trained machine learning models are able to perform suspiciousness determinations in response to receiving requests for determining the suspiciousness of identifiers associated with resources attempting to be accessed by a user, a system, or a combination thereof.

In certain embodiments and as otherwise described herein, various features can be extracted from the categorized balanced labeled samples. For example, in certain embodiments, features (e.g., lexical, host based, content-based, etc.) corresponding to each sample type (e.g., training samples, validation samples, testing samples, etc.) can be computed and the features (e.g., training featureset, validation featureset and test featureset) can also be persisted into a feature store, such as for use by other components of the system 100. In certain embodiments, the features can include, but are not limited to, a lexical feature (e.g., word length, frequency, language, density, complexity, formality, any feature that distinguishes a malicious identifier from a benign identifier, other lexical feature, or a combination thereof), a host-based feature (e.g., host feature as described in the present disclosure), a webpage screenshot feature (e.g., an image of a resource that the identifier references), a word character feature (e.g., symbols, letters, punctuation and/or other characters in the identifier), a number feature (e.g., numbers present in the identifier), a protocol feature (e.g., a protocol associated with the identifier), a domain feature (e.g., a type of the domain, the specific domain present in the identifier, and/or the characters present in the domain), another type of feature, or a combination thereof. Once the features extraction and/or computation is completed, one or more supervised learning techniques can be utilized to develop and/or train the trainable and/or trained machine learning models based on use case specific optimization criteria targeting certain evaluation metrics. Such criteria and/or metrics can relate to the required amount of computer resources that can be used by a model, whether the model is capable of making a determination relating to suspiciousness, whether the model is of a certain size, whether the model has certain functionality, whether the model has a particular machine learning and/or artificial intelligence algorithm, whether the model is capable of provide higher accuracy determinations (e.g., a threshold level), whether the model is more efficient than other models, and/or any other criteria and/or evaluation metrics. In certain embodiments, the training and/or developing can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device.

At 1020, the method 1000 can include determining whether the performance of the trained machine learning models that are developed using the categorized balanced labeled samples (e.g., categorized labeled samples that are balanced within each category) that are split or partitioned from the balanced labeled dataset satisfies or exceeds a performance expectation. In certain embodiments, any type of performance expectation can be specified by a user, the system 100, or a combination thereof. For example, potential performance expectations can include, but are not limited to, requiring a threshold speed for determining whether an identifier is suspicious (i.e., how quickly the determination is made), requiring a threshold amount of and/or types of computing resources when performing a suspiciousness determination, requiring a threshold accuracy of a suspiciousness determination (e.g., can be expressed as a percentage), any other performance metric and/or evaluation measure, or a combination thereof. In certain embodiments, the determining of whether the performance of the trained machine learning model(s) satisfies or exceeds the performance expectation(s) can be performed and/or facilitated by utilizing the server 140, the server 145, the server 150, the server 160, the communications network 135, the PCP classifier 202, the training pipeline service 210, the automated suspicious URL/FQDN detection system 206, any component of the system 100, any combination thereof, or by utilizing any other appropriate program, network, system, or device. If, however, the performance expectation is not satisfied, the method can trigger the training process by proceeding back to 1002 to further train the trained machine learning model and the training can continue until the performance expectation is satisfied. In certain embodiments, if the expectation relating to performance of the trained machine learning model is satisfied or exceeded, the method 1000 can proceed to performing suspiciousness determinations in response to receiving a request to determine whether an identifier associated with a resource attempting to be accessed is suspicious.

For example, once the trainable machine learning models are trained using the categorized labeled samples that are split or partitioned from the balanced labeled dataset and the performance of the optimal machine learning model (and/or other trained machine learning models) satisfy the performance expectation, the optimal machine learning model (as discussed in the present disclosure) can be persisted in the model registry 314 for use by the system 100, such as in response to the receipt of a request to determine whether an identifier associated with a resource attempting to be accessed is suspicious or non-suspicious. At 1022, the method 1000 can include receiving a request to determine whether an identifier associated with a resource attempting to be access is suspicious. In certain embodiments, the request, for example, may be issued by and arrive from the PCP classifier 202 to the inference pipeline service 208 of the automated suspicious URL/FQDN detection system 206, which can then retrieve the optimal machine learning model from the model registry 212 that was trained by the training pipeline service 210. In certain embodiments, the receiving of the request can be performed and/or facilitated by utilizing the server 140, the server 145, the server 150, the server 160, the communications network 135, the PCP classifier 202, the inference pipeline service 208, the training pipeline service 210, the automated suspicious URL/FQDN detection system 206, any component of the system 100, any combination thereof, or by utilizing any other appropriate program, network, system, or device.

At 1024, the method 1000 can include determining whether identifier associated with the request is suspicious or non-suspicious. In certain embodiments, the determination can be performed by the optimal machine learning model retrieved and/or accessed from the model registry 212. In certain embodiments, the determining can be performed and/or facilitated by utilizing the server 140, the server 145, the server 150, the server 160, the communications network 135, the PCP classifier 202, the inference pipeline service 208, the training pipeline service 210, the automated suspicious URL/FQDN detection system 206, any component of the system 100, any combination thereof, or by utilizing any other appropriate program, network, system, or device. In certain embodiments, at 1026, the method 1000 can include generating information based on the processing of the request and/or the suspiciousness determination made by the machine learning model. For example, in certain embodiments, the information can include, but is not limited to, a verification of whether the determination was accurate (e.g., by an expert, a system, or a combination thereof), metadata associated with the determination (e.g., how long the determination took, the type of attack associated with the identifier, etc.), whether the determination was suspicious or non-suspicious for an identifier, the similarity of the identifier to another identifier, any other information, or a combination thereof. In certain embodiments, the verified information can be utilized to update the labeled dataset stored in the PCP database 204. In certain embodiments, when the training process is triggered on a subsequent occasion by proceeding to 1002, the updated labeled dataset can be utilized to further train trainable machine learning models and/or trained machine learning models. For example, once the training process is initiated again at 1002, the method 1000 can proceed to compute the sampling weight, such as based on a desired configuration, for the updated suspicious samples and non-suspicious samples at 1006. The method 1000 can proceed to 1008 and perform sampling for the suspicious samples and the non-suspicious samples over a period of time, merge the first set of suspicious samples and the second set of non-suspicious samples to form a balanced labeled dataset at 1010, generate categorized labeled samples from the balanced labeled dataset at 1012, and train the trained and/or trainable machine learning model(s) using the categorized labeled samples. The method 1000 can proceed to 1020 and receive a further request to determine whether another identifier associated with a resource attempting to be accessed is suspicious. Information associated with the determination and/or processing of the request can be generated and the process can be repeated as desired to further enhance the suspiciousness determination capabilities of the machine learning model(s).

In certain embodiments, the method 1000 can be repeated as desired, which can be on a continuous basis, periodic basis, or at designated times. Notably, the method 1000 can incorporate any of the other functionality as described herein and can be adapted to support the functionality of the system 100. In certain embodiments, functionality of the method 1000 can be combined with other methods and/or functionality described in the present disclosure. In certain embodiments, certain operations of the method 1100 can be replaced with other functionality of the present disclosure and the sequence of operations can be adjusted as desired.

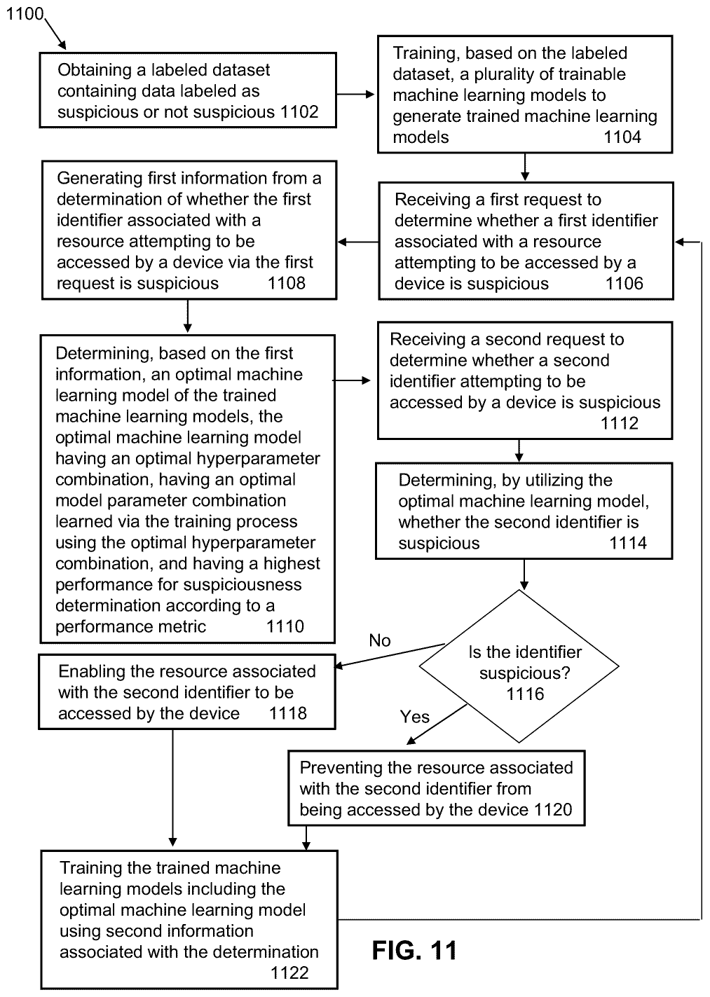

Referring now also to FIG. 11, FIG. 11 illustrates an exemplary method 1100 for providing automated machine learning model selection to facilitate automated detection of suspicious identifiers (e.g., URLs, FQDNs, etc.) according to embodiments of the present disclosure. In certain embodiments, the method of FIG. 11 can be implemented in the system 100 of FIGS. 1-6 and/or any of the other systems, devices, and/or componentry illustrated in the Figures. In certain embodiments, the method of FIG. 11 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 11 can be performed at least in part by one or more processing devices (e.g., processor 102, processor 122, processor 141, processor 146, processor 151, and processor 161 of FIG. 1) and/or other devices, systems, components, or a combination thereof, of FIGS. 2-6. Although shown in a particular sequence or order, unless otherwise specified, the order of the operations in the method 1100 can be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. For example, in certain embodiments, the method 1100 can be combined with the method 900 and/or method 1000. In certain embodiments, the method 1100 can provide further details relating to 904 of the method 900. In certain embodiments, one or more operations of the method 1100 can be incorporated into any desired operation or position within the sequence of operations of method 900. In certain embodiments, a greater or fewer number of operations as illustrated in FIG. 11 can be incorporated into method 900. In certain embodiments, the method 1100 can be modified to incorporate any of the functionality described in the present disclosure.

Generally, the method 1100 can include operations for providing automated machine learning model selection to facilitate the detection of suspicious identifiers. Notably, the method 1100 can include operations for conducting automated machine learning model selection to determine whether an identifier is suspicious. In certain embodiments, the selection can be in response to receiving a request to determine whether an identifier (e.g., an address, URL, FQDN, and/or other access or input mechanism) associated with a resource attempting to be accessed by a device is suspicious. In certain embodiments, the method 1100 can include obtaining a labeled dataset. In certain embodiments, the labeled dataset can include data that is labeled as suspicious or not suspicious (e.g., verified as being suspicious or not suspicious) and can serve as training data during a training process for training any number of trainable machine learning models (or algorithms) that can be utilized by the system 100 to generate a plurality of trained machine learning models that may serve as candidates to detect whether an identifier attempting to be accessed by a user or device is suspicious or not suspicious. In certain embodiments, a determination can be made by a trained machine learning model regarding whether the identifier associated with the request is suspicious. In certain embodiments, first information can be generated based on the determination regarding suspicious. For example, such first information can include a verification of whether the determination was accurate (e.g., by an expert, a system, or a combination thereof), metadata associated with the determination (e.g., how long the determination took, the type of attack associated with the identifier, etc.). In certain embodiments, the method 1100 can include determining which of the trained machine learning models (or algorithms) is the optimal machine learning model from the trained machine learning models. In certain embodiments, the first information can be utilized by the system 100 to determine which model is the optimal machine learning model. In certain embodiments, the trained machine learning models can be trained using the first information. In certain embodiments, the optimal machine learning model (or algorithm) can be the trained machine learning model that has a highest performance according to specified evaluation measures, which are discussed in further detail below. In certain embodiments, the optimal machine learning model can be trained using the labeled dataset (and/or information generated from suspiciousness determinations) to learn the optimal model parameters (e.g., the weights, coefficients, biases, thresholds, leaf values, intercepts, support vectors, multipliers, etc. for variables learned during the training process) for the optimal machine learning model (i.e., the model that has a highest performance with regard to the specified evaluation measures that are utilized for measuring suspiciousness determination capability). In certain embodiments, hyperparameters (described in further detail below) for each of the trainable machine learning models can be specified by the system 100 and/or a user and can be utilized to determine or estimate model parameters (e.g., the weights, coefficients, biases, thresholds, leaf values, intercepts, support vectors, multipliers, etc. for variables learned during the training process) for the trained machine learning models to be generated for performing the suspiciousness determinations.

The optimal hyperparameter combination and the optimal model parameter combination, which can be learned using the optimal hyperparameter combination via the training process, can be determined. In certain embodiments, the optimal machine learning model having the optimal model parameter combination can be the trained machine learning model that has the highest performance for suspicious determination according to a performance metric, such as a performance metric or evaluation measure specified by the system 100, a user of the system 100, or a combination thereof. The optimal machine learning model can be determined based on its performance relative to other trained machine learning models using the performance metric and/or evaluation measures, and the method 1100 can include selecting the optimal machine learning model from the trained machine learning models to perform suspiciousness determinations. The method 1100 can then include executing the optimal machine learning model to determine whether an identifier associated with a request is suspicious or not suspicious. In certain embodiments, if the identifier is determined to not be suspicious, the method 1100 can include enabling the resource associated with the identifier to be accessed by the device attempting to access the resource using the identifier. If, however, the identifier is determined to be suspicious, the method 1100 can include preventing the resource associated with the identifier attempting to be accessed by the device from being accessed. In certain embodiments, the method 1100 can include training the trained machine learning models (including the optimal machine learning models), trainable machine learning models, or a combination thereof, to enhance determinations of suspiciousness of identifiers for future requests.

At 1102, the method 1100 can include obtaining a labeled dataset containing data. In certain embodiments, the labeled dataset can be obtained from any number of data sources including, but not limited to, PCP database 204. In certain embodiments, the data contained in the labeled dataset can be labeled as being suspicious (e.g., value 1) or not suspicious (e.g., value 0). For example, the data can include a list of identifiers that have been previously analyzed by the system 100 that can be organized in a table that includes columns indicating whether each particular identifier in the table is suspicious or not suspicious. In certain embodiments, the labeled dataset and/or table can include any other information. In certain embodiments, for example, in addition to indicating whether a particular identifier is suspicious or not suspicious, there can be data (e.g., metadata) indicating whether a particular identifier is associated with a particular type of malicious attack, whether a particular identifier is associated with a certain severity of attack (e.g., low severity can only involve redirecting a user to a different website, moderate severity can involve redirecting the user to a website that attempts to emulate an intended website, and high severity can involve an identifier that has been utilized to conduct a distributed denial of service attack on an enterprise), whether a particular identifier has been successful deceiving a user, the types of resources that a particular identifier is used to access (e.g., web content, streaming content, software modules, specific types of data, financially-related content, etc.), any other information, or a combination thereof. In certain embodiments, the obtaining of the labeled dataset can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device.

In certain embodiments, the obtaining of the labeled dataset can be enabled based on a signal transmitted via the training orchestrator 302 of the training pipeline service 210, which can be utilized request the labeled dataset from the PCP database 204. At 1104, the method 1100 can include training a plurality of trainable machine learning models based on the labeled dataset to generate trained machine learning models to perform suspiciousness determinations. In certain embodiments, the trainable machine learning models can be a computing process, procedure, program and/or algorithm (e.g., untrained) having a computing structure to combine a given input (e.g., labeled dataset) with a set of adjustable and/or trainable parameters to generate an output that is responsive to the given input. In certain embodiments, the trainable machine learning models can be computer procedures that are run on labeled or other datasets to recognize patterns and rules that can be trained to generate trained machine learning models. In certain embodiments, a trained machine learning model can be a trained trainable machine learning model that can be a computing process, algorithm, program, having a computing structure to combine a given input with a previously trained set of parameters to generate an output in response to a given input. In certain embodiments, the trained machine learning models can be the output resulting from training the trainable machine learning models and the trained machine learning models can be utilized to make predictions, such as predictions regarding the suspiciousness of an identifier associated with a request.

In certain embodiments, each of the trainable machine learning models (or algorithms) can have combinations of hyperparameters specified for them, such as by a user, the system 100, or a combination thereof. For example, hyperparameters can include, but are not limited to, a machine learning model rate (e.g., a hyperparameter controlling the rate or step size at which model parameters are updated during a training process), a number of epochs and/or iterations (e.g., the number of times the machine learning algorithm iterates over the training dataset), a number of layers and/or units in a neural network of the system 100 (e.g., the number of hidden layers and/or the number of units in each layer that define the architecture and complexity of the neural network utilized to generate the model), regularization parameters (e.g., regularization utilized to prevent overfitting by adding a penalty term to a loss function, regularization strength or type to control the amount of regularization applied during the training process), kernel parameters (e.g., the type of kernel function and its associated parameters, such as, but not limited to, the kernel width or degree that can affect model performance and/or behavior), the dropout rate (e.g., a technique to randomly set a portion of inputs to zero during the training process to determine the probability of dropping a unit in a neural network layer associated with the machine learning model), the batch size (e.g., the number of training samples utilized in each iteration or update of the model parameters of the machine learning model generated by the system 100), the number of neighbors (e.g., the number of neighbors utilized for classification or regression that can be utilized to influence decisions made by the generated machine learning model), the parameters utilized for a support vector machine, a maximum number of splits and/or depth of a decision tree, other hyperparameters, or a combination thereof. Such hyperparameters can be specified by the system 100, a user, or a combination thereof. In certain embodiments, the hyperparameters can include configuration settings that can be specified prior to the training process to determine how a trained machine learning model that is generated by using one or more of the trainable machine learning models learns and updates model parameters of the trained machine learning model. In certain embodiments, an optimal combination of hyperparameters can be determined by conducting tuning on the hyperparameters to determine which combination of hyperparameters results in learning the optimal model parameters of the generated trained machine learning model that provide a highest performance according to a performance metric (e.g., evaluation measure) for determining suspiciousness of digital identifiers when compared to other generated trained machine learning models. In certain embodiments, the training can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device.

In certain embodiments, as part of the training process, the model monitoring service 318, CronJob 316, and/or other components of the system 100 can be configured to transmit a signal to the training orchestrator 302, which can request the labeled dataset from the PCP database 204. In certain embodiments, the signal can be utilized to trigger the training process to train the trainable machine learning models to output the trained machine learning models, which can also be trained. In certain embodiments, the PCP database 204 can be configured to automatically transmit the labeled datasets to the training pipeline service 210 at scheduled intervals, at random times, or upon the occurrence of a triggering condition (e.g., a threshold amount of data is in the PCP database 204, the trainable machine learning models have not been trained for a threshold period of time, a new candidate machine learning model (or algorithm) has been uploaded into the system 100, etc.). In certain embodiments, regardless of how the labeled dataset arrives at the training pipeline service 210, the labeled dataset can be provided to the model development sample generator 304. For example, in certain embodiments, the training orchestrator 302 can transmit a control signal activating and/or controlling the operation of the model development sample generator 304. In certain embodiments, the model development sample generator 304 can be configured to receive the labeled datasets from the PCP database 204 and then generate a plurality of samples from the labeled datasets. In certain embodiments, the model development sample generator 304 can be configured to deploy a sampling strategy to compute data samples from the labeled datasets. In certain embodiments, the data samples can include, but are not limited to, training samples (e.g., samples to train the trainable machine learning models to facilitate generation of a trained machine learning model), validation samples (e.g., samples relating to validation of a determination of suspiciousness and/or samples for use in a process to evaluate a developed or updated machine learning model with a testing dataset), test samples (e.g., samples to test functionality of the machine learning models), or a combination thereof.

In certain embodiments, the model development sample generator 304 can generate the training samples, validation samples, and/or testing samples so that the various samples can be utilized by the other components of the training pipeline service 120, the system 100, or a combination thereof, to generate machine learning models to perform suspiciousness determinations, update existing machine learning models (or algorithms) to enhance suspiciousness determinations, or a combination thereof. In certain embodiments, the model development sample generator 304 can perform in-memory sampling on the labeled dataset using any number and/or types of sampling strategies to produce balanced labeled samples. For example, the in-memory sampling can be utilized to generate a set of samples that have a ratio of suspicious and non-suspicious data that are proportionate (e.g., 50% suspicious samples and 50% non-suspicious samples) from imbalanced samples. In certain embodiments, the model development sample generator 304 can be further configured to split the in-memory samples into the different categories (i.e., training samples, validation samples, and testing samples). In certain embodiments, once the samples are generated or as the samples are being generated, the model development sample generator 304 can store the samples in the sample store 310 for access by other components of the training pipeline service 210. In certain embodiments, once the samples are generated from the labeled dataset by the model development sample generator 304, the model development sample generator 304 can transfer control of the training pipeline service 310 to the training orchestrator 302. In certain embodiments, the model development sample generator 304 can provide information relating to the samples, such as, but not limited to, the amount of samples, the ratio of suspicious versus non-suspicious samples, the quantity of each category of samples (e.g., the quantity of validation samples, the quantity of testing samples, and the quantity of training samples), and an identification of the locations in memory (e.g., the sample store 310 memory addresses) where the samples are stored.

Once the samples are generated by the model development sample generator 304, the training orchestrator 302 of the training pipeline service 302 can be configured to transmit a control signal to activate and/or control operation of the feature extractor 306. In certain embodiments, the feature extractor 306 can be configured to extract features (e.g., identifier features) from each labeled sample category. For example, the feature extractor 306 can fetch the various samples generated by the model development sample generator 304 from the sample store 310 and can be configured to extract features from the training samples, validation samples, and testing samples. In certain embodiments, the feature extractor 306 can be configured to compute feature matrices for each sample of each sample category (i.e., training samples, validation samples, and testing samples) to generate features for each sample category. In certain embodiments, for example, the feature extractor 306 can generate features that can be obtained using lexical information associated with a particular identifier (e.g., address, URL, FQDN, link, or other access mechanism), host-based information of the identifier (e.g., the particular host that is hosting a resource accessible via an identifier), information associated with the resource (e.g. HTML information of a web page accessible via an identifier), subdomain information, top-level domain information, port information, protocol information, any other information, or a combination thereof. In certain embodiments, the feature matrices generated by the feature extractor 306 can be configured to include rows that correspond to a numeric vector that represents a particular identifier. As an example, for an example identifier such as www[.]atesturl[.]com, an N-dimensional numerical vector can be utilized to represent “atesturl.com”. In certain embodiments, for example, the value of N can be a fixed default number or a user-provided number. In certain embodiments, each feature matrix computed for each of the samples for each of the categories of samples can be persisted into the feature store 312. Once the feature matrices are stored in the feature store 312, the feature extractor 306 can transmit a signal transferring control back to the training orchestrator 302. In certain embodiments, the training orchestrator 302 can be configured to activate and/or transfer control the learner 308, such as by transmitting a control signal to the learner 308. In certain embodiments, the learner 308 can be configured to train any number of candidate trainable machine learning models (or algorithms) using the features computed by the feature extractor 306 to generate trained machine learning models, which can include an optimal machine learning model. In certain embodiments, the system 100 can utilize hyperparameters specified for one or more of the candidate trainable machine learning models to estimate (or learn) the model parameters (e.g., the weights, coefficients, biases, thresholds, leaf values, intercepts, support vectors, multipliers, etc. for variables learned during the training process) for the trained machine learning models that are generated during the training process.

At 1106, the method 1100 can include receiving a first request to determine whether a first identifier associated with a resource attempting to be accessed by a device is suspicious. In certain embodiments, the receiving of the request can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. At 1108, the method 1100 can include generating first information from a determination of whether the first identifier associated with the resource attempting to be accessed by the device via the first request is suspicious. In certain embodiments, the first information can include a verification of whether the determination made by a trained machine learning model was accurate or not (e.g., a verification by an expert, a system, or a combination thereof), metadata associated with the processing of the first request (e.g., how long the system 100 took to process the request and make the determination, types of attacks associated with the identifier, the level of suspiciousness, any other information, or a combination thereof), any other information, or a combination thereof. At 1110, the method 1100 can include determining and/or identifying an optimal machine learning model from the trained machine learning models to be utilized in determining whether an identifier is suspicious. In certain embodiments, the determining and/or identifying can be performed by utilizing the first information (which can be used to train the models), evaluation measures and/or performance metrics, or a combination thereof. In certain embodiments, the determining and/or identifying of the optimal machine learning model can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. In certain embodiments, the learner 308 can be configured to obtain the feature matrices for each sample category (i.e., the validation samples, the training samples, and the validation samples). In certain embodiments, the learner 308 can be configured to use any type of auto-machine learning technique to generate, determine, and/or identify the optimal machine learning model to process a request by utilizing the feature matrices of the training and validation samples obtained from the feature store 312. In certain embodiments, the learner 308 can be configured to determine or identify the optimal machine learning model for processing a request based on the optimal machine learning model having a highest performance based on a defined performance metric (or evaluation measure) in comparison to other trained machine learning models. In certain embodiments, the optimal machine learning model (or algorithm) can have an optimal hyperparameter combination, which can be utilized by during the training process to estimate and learn the optimal model parameters (e.g., the weights, coefficients, biases, thresholds, leaf values, intercepts, support vectors, multipliers, etc. for variables learned during the training process) for the optimal machine learning model.

In certain embodiments, the learner 308 can determine the optimal machine learning model with a focus on optimizing for user-provided and/or system-provided model evaluation measures (or performance metrics). In certain embodiments, for example, the evaluation measures for determining and/or selecting the optimal machine learning model can include, but are not limited to, precision capability, recall capability, accuracy capability, F-measure capability (e.g., F1 Score, F-Beta score, etc.), speed capability (e.g., how fast the predictions are made by the machine learning model), resource-usage (e.g., processor, network, and/or memory usage), any other evaluation measures, or a combination thereof. In certain embodiments, the evaluation measures can serve to provide data-driven decisions to select the optimal machine learning model during offline evaluation. In certain embodiments, the evaluation measures can be utilized to assist in monitoring the performance of the optimal machine learning model (or other models) and/or the algorithms utilized to generate the model. In certain embodiments, the evaluation measures can be utilized to compare the performance of different trained machine learning models in conducting suspiciousness determinations considering the evaluation measures.

In certain embodiments, evaluation measures utilized for determining and/or selecting the optimal machine learning model can be divided into any number of categories. For example, the evaluation measures can be divided into two categories, offline evaluation metrics and online evaluation metrics. In certain embodiments, offline evaluation metrics can be used to select the optimal machine learning model (i.e., best performing) along with the optimal hyperparameters (if any) of the model on the validation samples during the model development phase. On the other hand, in certain embodiments, online evaluation metrics can be utilized to measure the model's performance on live production data. In certain embodiments, the choice of which type of evaluation metric is utilized may be adjusted based on preferences.

In certain embodiments, with regard to offline evaluation metrics or measures, it can be assumed that a suspicious identifier can be treated as a positive class with label “1” and a non-suspicious or benign identifier can be treated as a negative class having a label “0”. Based on the foregoing assumption, various terms can be defined to explain the evaluation measures (i.e., performance metrics) utilized to determine and/or select an optimal machine learning model to perform suspiciousness determinations in response to receipt of requests. A first term can be a True Positive, which can be the total number of positive class predictions (i.e., predictions that an identifier is suspicious) made by the machine learning model that are actually suspicious. A second term can be a True Negative, which can be the total number of negative class predictions (i.e., predictions that an identifier is not suspicious) made by the machine learning model that are actually not suspicious. A third term can be a False Positive, which can be the total number of positive class predictions (i.e., predictions that an identifier is suspicious) made by the machine learning model that are actually non-suspicious. A fourth term can be a False Negative, which can be the total number of negative class predictions (i.e., non-suspicious) made by the machine learning model that are actually suspicious.

In certain embodiments, there can be various types of candidate performance metrics that can be utilized for the evaluation measures that are utilized to determine and/or select an optimal machine learning model. An example candidate metric (e.g., offline) for the evaluation measure can be accuracy. In certain embodiments, accuracy can be utilized to indicate how many predicted classes (i.e., both suspicious and non-suspicious determinations) were correctly classified by a trained machine learning model. The accuracy measure can indicate the proportion of correct predictions through accuracy. In certain embodiments, the accuracy capability can be the ratio of the total number of correct predictions over the total number of predictions (e.g., (True Positives+True Negatives)/(True Positives+False Positives+True Negatives+False Negatives). In certain embodiments, accuracy can be an effective metric for an evaluation measure if the dataset utilized to train the machine learning models are balanced (i.e., the samples generated from the labeled dataset are balanced). If, however, the dataset is imbalanced, such as when one of the classes significantly fewer observations (e.g., significantly fewer suspicious versus suspicious in the dataset), the accuracy evaluation measure may not provide trustworthy model performance information. As an example, if there are only 1% of identifier instances are suspicious (i.e., labeled class “1”) in a sample where 99% of identifier instances are benign (i.e., labeled class “0”) in the sample, the distribution can be highly skewed towards benign identifiers. In certain embodiments, if the objective of the machine learning model is to detect suspicious identifiers, training a machine learning model using an imbalanced dataset that results in a trained machine learning model that always predicts the class of the identifier to be benign (i.e., class “0”), will have an accuracy score of 99%. In such a scenario, even though the accuracy appears to be very high, the machine learning model fails to detect suspicious identifiers because the model was trained on an imbalanced dataset.

Another example candidate metric (e.g., offline) for the evaluation measure can be precision. In certain embodiments, precision can be the proportion of positive (i.e., determined as suspicious) class predictions among all of the predictions made by the learned machine learning model in the validation dataset. Precision can indicate the fraction of true positive predictions from all predictions. In certain embodiments, for example, a precision evaluation measure can be a metric that equals the number of correct positive predictions made by a candidate machine learning module divided by the total number of positive predictions (e.g., (True Positive)/(True Positive+False Positive)). As an example, if the learned machine learning model generates predictions including the following labels for identifiers: [1,0,0,0,1] and the true actual labels are [0,0,0,0,1], the precision equals 1/(1+1), which equals 0.5. In certain embodiments, if precision is the evaluation metric (or performance metric) utilized, the trained machine learning model within the set of trained machine learning models with the highest precision may be selected and may have the optimal model parameters (i.e., weights, biases, etc.) for performing the suspiciousness determination. The precision evaluation measure can indicate machine learning model performance well for both balanced and imbalanced datasets and can be utilized to detect true positives (i.e., suspicious determinations), while also reducing false positives (i.e., suspicious determinations that are not actually suspicious).

A further example candidate metric (e.g., offline) for the evaluation measure can be recall. In certain embodiments, recall can be the proportion of positive predictions (i.e., suspicious determinations) made by the learned/trained machine learning model out of all the actual positive classes in the validation dataset derived from the labeled dataset. Recall can indicate the fraction of true positive predictions among all positive samples in a given dataset. In certain embodiments, the recall evaluation measure can be a metric that equals the number of correct positive predictions made by a candidate machine learning model out of all positive predictions that could have been made by a candidate machine learning model (e.g., Recall=(True Positive)/(True Positive+False Negatives)). As an example, if the learned machine learning model generates the following predictions for the labels for identifiers: [1,0,0,0,1], but the actual correct labels are [1,0,0,1,1], the recall can be calculated as 2/(2+1), which equals 0.66. The recall metric indicates machine learning model performance well for both imbalanced and balanced datasets and can be a preferable evaluation measure if the objective is to detect true positives.

Another example candidate metric (e.g., offline) for the evaluation measure are F-measure metrics, such as F1 scores and F-Beta scores. In certain embodiments, the F1 score can be the harmonic mean of the precision and recall evaluation measures (e.g., F1=2*(Precision*Recall)/(Precision+Recall)). The F1 score works successfully for balanced and imbalanced datasets. In certain embodiments, the F-Beta score, may be similar to the F1 score, however, the F-Beta score can utilize a real factor “beta” that is selected such that the recall is beta times more important than precision. In certain embodiments, F-Beta can be represented with the following mathematical expression: F-Beta=(1+Beta²)*Precision*Recall/(Beta²*Precision+Recall). As with the F1 score, the F-Beta score works successfully for balanced and imbalanced datasets. In certain embodiments, the F-Beta score can provide configuration options to balance between the precision and recall evaluation measures. For example, if Beta is greater than 1, then greater weight can be placed on the recall evaluation measure. As another example, if Beta is less than 1, then greater weight can be placed on the precision evaluation measure. In certain embodiments, the Beta value can be started at 1, which is essentially the F1 score, to perform well in both precision and recall evaluation measures. If the objective is to focus more on precision, then the Beta value can be adjusted accordingly.

With regard to online evaluation measures, there can also be a variety of candidate metrics utilized by the system 100 to measure the performance of learned or trained machine learning models. An example online evaluation measure can be the Precision@K metric, which can measure the relevancy of the predicted ranked list of specious identifiers. Precision@K can be expressed using an expression: N=Number of true suspicious identifiers in the Top K list, and Precision@K=N/K. As an example, the machine learning model learned by the system 100 may have predicted labels on the Top-K list as [1,1,1,1] and true and actual labels for the identifiers are [1,0,0,1,1]. The Precision@K for the foregoing example can be Precision@4=2/4, which equals 0.5 and Precision@5 can be 3/5, which equals 0.6. In certain embodiments, the Precision@K evaluation measure can be utilized to measure on a daily, weekly, monthly, or other time-based basis.

Another example of an online evaluation measure can be the Recall@K metric, which can measure the relevancy of the predicted ranked list of suspicious identifiers with respect to true (i.e., actual) suspicious identifiers that are observed. In certain embodiments, Recall@K can be expressed using an expression: N=Number of true suspicious identifiers in the Top K list; M=Total number of true suspicious identifiers; and Recall@K=N/M. As an example, the predicted labels for identifiers on the Top K list can be [1,1,1,1,1], the true (i.e., actual) labels for the identifiers can be [1,0,0,1,1], and the total number of true suspicious identifiers can be 3. Using the foregoing example, Recall@4=2/3, which equals 0.66 and Recall@5=3/3, which equals 1. In certain scenarios, individuals, such as researchers, can verify the accuracy or legitimacy of the returned list of suspicious identifiers generated by the machine learning model.

A further example of an online evaluation measure can be the Daily False Positives Rate (DFPR). In certain embodiments, the online evaluation measure can be a metric that is utilized to measure the rate of daily false positives calculated from the returned list of Top K identifiers. As an example, if the machine learning model predicts labels for identifiers in a given day on the Top K list as being: [1,1,1,1,1,] and the true labels for the identifiers are [1,0,0,1,1], the DFPR=2/5, which equals 0.4. The DFPR metric can be utilized particularly if the objective is to minimize or reduce false positives. An exemplary proposed metric can be where the default value of K is set to 300 where, if necessary, a team of users can conduct around 300 overrides of predictions.

Notably, any one or more of the foregoing evaluation measures can be utilized to generate, determine, and/or select the optimal machine learning model to perform suspiciousness determinations for identifiers. In certain embodiments, any combination of the evaluation measures can be utilized and can be specified by the system 100, users, or a combination thereof. In certain embodiments, the system 100 itself can learn over time and determine which evaluation measures result in the optimal machine learning model at a particular time or timeframe. In certain embodiments, the evaluation measures can be utilized determine, such as during the training process, the optimal hyperparameter combination for a particular candidate machine learning model, the optimal model parameters for the optimal machine learning model, or a combination thereof.

When developing, determining, and/or locating the optimal machine learning model based on and/or using the specified evaluation measures, the machine learning techniques utilized by the learner 308 can be utilized to determine the optimal (i.e., best performing) machine learning model, along with the optimal hyperparameter combination for that particular model from a predefined list of candidate machine learning models. In certain embodiments, the hyperparameter combination can be a combination of hyperparameters having values that are used to control the machine learning process and can be utilized to determine the values of machine learning model parameters that a machine learning model (or algorithm) learns. In certain embodiments, a hyperparameter can be a top-level parameter that controls the learning process and the model parameters that result from the learning process that define the graph for the trained machine learning model resulting from the learning process.

In certain embodiments, the candidate machine learning models (or algorithms) in the list of candidate algorithms can include, but are not limited to, support vector machine, logistic regression, random forest classifier, deep-learning-based classifier, transformer-based classifier, decision trees, artificial neural networks, any other type of machine learning model (or algorithm), or a combination thereof. In certain embodiments, support vector machine algorithms can be supervised learning algorithms that can be utilized to analyze the labeled dataset for classification and/or regression analysis, such as to perform suspiciousness determinations for identifiers. In certain embodiments, logistic regression can be a statistical algorithm that can be utilized for classification and predictions and can be utilized to estimate the probability of an event occurring (e.g., whether an identifier is suspicious or non-suspicious) based on a given labeled dataset. In certain embodiments, random forest classifier can be an algorithm that combines the output of multiple decision trees to reach a single result. In certain embodiments, the random forest classifier can utilize supervised learning and can be applied to both classification and regression, such as for determining suspiciousness of an identifier. In certain embodiments, the random forest classifier can contain decision trees on various subsets of the labeled dataset and utilizes the average result to enhance the predicted accuracy. For example, instead of relying on a single decision tree, the random forest classifier can collect the result from each tree and the final output (e.g., suspiciousness determination) can be based on the majority vote of the predictions made. In certain embodiments, deep-learning-based classifiers can include convolutional neural networks, long short-term memory networks, recurrent neural networks, generative adversarial networks, multilayer perceptrons, self-organizing maps, deep-belief networks, restricted Boltzmann machines, autoencoders, and/or other types of deep-learning-based classifiers. In certain embodiments, transformer-based classifiers can utilize self-attention and can differentially weight the significance of each part of an input data (e.g., the labeled dataset). In certain embodiments, the transformer-based classifiers can be neural networks that learn context and understanding through sequential data analysis of the data in the labeled dataset.

In certain embodiments, the learner 308 can be configured to be customizable and can be configured to support adding new trainable machine learning models and/or updating existing models (or algorithms), whether trained or untrained, to the system 100 over time. In determining and/or locating the optimal machine learning model to process a request, the learner 308 can deploy any type of searching strategy, such as, but not limited to, blended search, randomized direct search, Bayesian optimization, other search strategies, or a combination thereof. In certain embodiments, blended search can involve combining global and local search strategies. For example, a global search strategy can be utilized to decide the starting point of a local search, and the local search can be utilized to intervene the global search method's configuration selection to avoid configurations that can incur large evaluation costs. In certain embodiments, randomized direct search can include utilizing random combinations of hyperparameters to identify the optimal trainable machine learning model (or algorithm) from the candidate machine learning models (or algorithms) to produce the optimal trained machine learning model to perform the suspicious determination. In certain embodiments, Bayesian optimization can include using the Bayes Theorem to direct a search of a global optimization problem by using a probabilistic model of an objective function (i.e., surrogate function) that is then searched efficiently with an acquisition function before candidate algorithms are chosen for evaluation on a real objective function. In certain embodiments, the Bayesian optimization can used Bayes Theorem to direct a search to find the minimum or maximum of an objective function.

In certain embodiments, the learner 308 can utilize the feature matrices of the test samples obtained from the labeled dataset to represent an unseen sample that can be utilized to obtain the performance of the optimal machine learning model during the machine learning model training process conducted by the training pipeline service 210. In certain embodiments, the performance metrics (e.g., evaluation measures) obtained by utilizing the test samples can provide insight to the user and/or the system 100 to determine whether to utilize the trained machine learning model in the production environment or not. Once the optimal machine learning model is determined and metadata associated with the model is generated (e.g., metadata indicating how long it took to complete the machine learning model training, information identifying the optimal machine learning algorithm and corresponding hyperparameters, an identification of when the training of the model was triggered, an accuracy of the model when used with the test samples, any other metadata, or a combination thereof), the method 1100 can include persisting the optimal machine learning model and associated metadata in the model registry 314 for future retrieval and/or use, such as by the inference pipeline service 208. In certain embodiments, once the optimal machine learning model is identified, the metadata is generated, and the model is stored in the model registry 314, the learner 308 can transfer, such as via a control signal, control back to the training orchestrator 302 of the training pipeline service 210.

In certain embodiments, once control is given back to the training orchestrator 302, the method 1100 can include, at 1112, receiving a second request to determine whether a second identifier attempting to be accessed by a device is suspicious. In certain embodiments, the second request can be received by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. selecting the optimal machine learning model from the trained machine learning models to process the second request. In certain embodiments, the optimal machine learning model can be constructed using optimal model parameters that are learned during the training process using the labeled dataset and based on the specified hyperparameters for the candidate trainable machine learning models (or algorithms) and the performance metrics associated with the evaluation measures specified for the model. In certain embodiments, the determining, identifying, and/or selecting of the optimal machine learning model can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. Once the optimal machine learning model is determined, identified, and/or selected, the method 1100 can include, at 1114, executing the optimal machine learning model to determine whether the second identifier associated with the second request is suspicious or not suspicious. In certain embodiments, the determining can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device.

At 1116, if the second identifier is determined to not be suspicious, the method 1100 can proceed to 1118. At 1118, the method 1100 can include enabling the resource associated with the second identifier to be accessed by the device that is attempting to access the resource. In certain embodiments, the enabling can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. The method 1100 can then proceed to 1122, which can include training the trained machine learning models, new trainable machine learning models, or a combination thereof, based on second information generated based on processing the second request, which can include a verified determination made by the optimal machine learning model (e.g., a human expert, system, or both, verified that the suspiciousness determination was accurate), metadata associated with the determination (e.g., how long the determination took, how much processing resources were used, etc.), and/or other data. In certain embodiments, the training can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device.

At 1114, if the method 1100 includes determining that the second identifier is suspicious, the method 1100 can proceed to 1120 instead of 1118. At 1120, the method 1100 can include preventing the device from accessing the resource associated with the identifier. In certain embodiments, the preventing can be performed and/or facilitated by utilizing the server 140, the server 145, the server 150, the server 160, the communications network 135, the PCP classifier 202, the inference pipeline service 208, the automated suspicious URL/FQDN detection system 206, any component of the system 100, any combination thereof, or by utilizing any other appropriate program, network, system, or device. The method 1100 can then proceed to 1122 where the existing trained machine learning models, new trainable machine learning models (e.g., uploaded into and/or generated within the system 100 after the prior training process), or a combination thereof can be trained. In certain embodiments, the machine learning models can be trained based on information associated with a verification of the suspiciousness determination made by the optimal machine learning model. For example, if a human expert and/or component of the system 100 verifies the accuracy (or rejects the accuracy) of the suspiciousness determination made by the optimal machine learning model in response to the second request (and/or other requests), such information can be used to train the trained machine learning models, new trainable machine learning models, or a combination thereof, so that a future determination for a future request to determine suspiciousness of an identifier is enhanced. In certain embodiments, the training may be based on the determination made by the optimal machine learning model, metadata associated with the determination (e.g., how long the determination took, how much processing resources were used, etc.), and/or other data.

Based on at least the present description, the system 100 incrementally improves the scale and quality of the training dataset utilized to train the trainable machine learning models, the existing trained machine learning models, or a combination thereof, which ultimately enhances the results of the training and the suspicious determination capabilities of the trained models over time. After the processing of a request to determine the suspiciousness of an identifier, the information resulting from such processing (e.g., the optimal machine learning model's determination regarding suspiciousness of the identifier, whether the determination was verified or rejected by an expert, system, or both, metadata associated with the processing (e.g., time to process, etc.), etc.) can be used to train (e.g., using supervised learning, reinforcement learning, and/or other learning techniques) the trainable machine learning models, the trained machine learning models, new trainable machine learning models, or a combination thereof, to enhance suspiciousness determinations as time progresses. After or during each training session, the performance of the generated and/or updated trained machine learning models can be compared using the evaluation measures and/or performance metrics, to identify and/or select the optimal machine learning model for each subsequent request for suspiciousness determination that is received.

As an illustrative example, the initial labeled dataset including data verified as suspicious or not suspicious can train a plurality of trainable machine learning models (or algorithms), which, for example, can be a decision tree and an artificial neural network to generate an initial trained decision tree and an initial trained artificial neural network. In certain scenarios, for example, due to the structural and/or other differences between the trained decision tree and trained artificial neural network, the trained decision tree can be superior to the trained artificial neural network based on the evaluation measures utilized to measure suspiciousness determination capability—at least initially. In certain embodiments, in response to receiving a request to determine the suspiciousness of an identifier, the current trained decision tree having model parameters can be selected based on it having a higher present performance for suspiciousness determination than the trained artificial neural network. The trained decision tree, which is the optimal machine learning model for the initial request, can perform the suspiciousness determination. The suspiciousness determination can be verified by an expert, system, or a combination thereof, and the verification and any information (e.g., as otherwise described herein) associated with processing the initial request can be stored in the PCP database 204 to update the labeled dataset. When the training process is triggered again by the system 100, the updated labeled dataset can be utilized to train the existing trained machine learning models (including the optimal machine learning model), new trainable models, or a combination thereof, to generate a new set of trained machine learning models. For example, the trained decision tree and the trained artificial neural network can be trained again using the updated labeled dataset. The performance of the further trained decision tree, the further trained artificial neural network, trained new trainable models, further trained other existing models, or a combination thereof, can be compared using evaluation measures. When a subsequent request to perform a suspiciousness determination for another identifier comes into the system 100, the performance of the newly trained machine learning models can be compared, and the current optimal machine learning model can be selected based on having a highest performance according to the performance metric and/or evaluation measures. The current optimal machine learning model can be selected to perform the suspiciousness determination and information associated with the processing of the subsequent request can be utilized to train the machine learning models again.

In certain embodiments, the method 1100 can be repeated as desired, which can be on a continuous basis, periodic basis, or at designated times. Notably, the method 1100 can incorporate any of the other functionality as described herein and can be adapted to support the functionality of the system 100. In certain embodiments, functionality of the method 1100 can be combined with other methods and/or functionality described in the present disclosure. In certain embodiments, certain operations of the method 1100 can be replaced with other functionality of the present disclosure and the sequence of operations can be adjusted as desired.

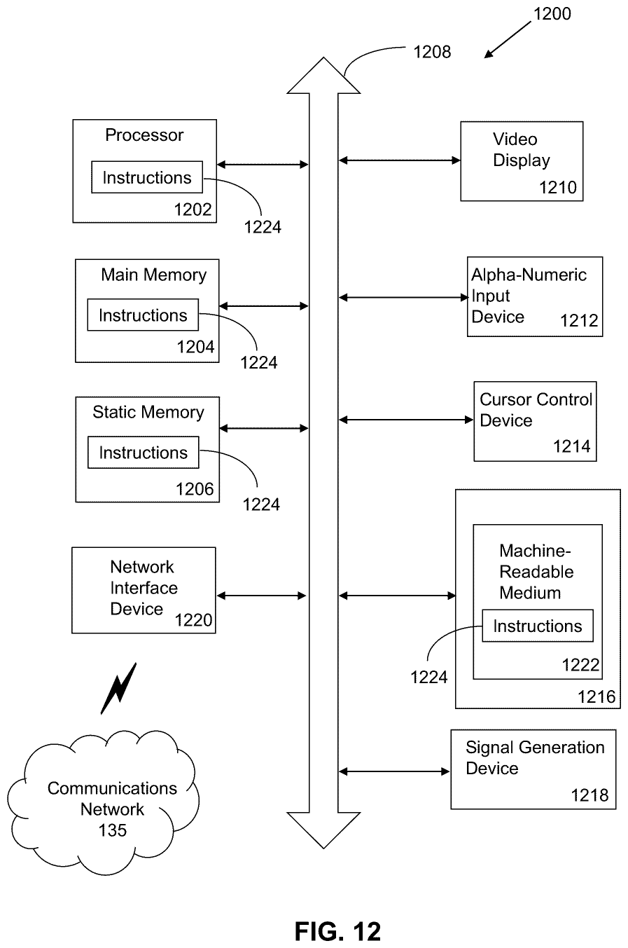

Referring now also to FIG. 12, at least a portion of the methodologies and techniques described with respect to the exemplary embodiments of the system 100 and/or method 800 can incorporate a machine, such as, but not limited to, computer system 1000, or other computing device within which a set of instructions, when executed, can cause the machine to perform any one or more of the methodologies or functions discussed above. The machine can be configured to facilitate various operations conducted by the system 100. For example, the machine can be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 1200 can assist in receiving requests to determine whether an identifier (e.g., an address, link, URL, FQDN and/or other interactable mechanism) for accessing resources (e.g., web pages, applications, content, etc.) is suspicious; accessing and/or obtaining machine learning models to determine whether the identifier (e.g., address, link, URL, FQDN, and/or other interactable mechanism) is suspicious; loading a plurality of features extracted from the identifier; determining whether the identifier (e.g., address, link, URL, FQDN, and/or other interactable mechanism) is suspicious based on execution of the machine learning model using the loaded features; providing an indication that the identifier (e.g., address, link, URL, FQDN, and/or other interactable mechanism) is suspicious; verifying that the indication based on feedback relating to the indication to generate a verified indication that the identifier is suspicious; outputting the verified indication; training models based on the verified indication; preventing access to resources for which the indication indicates that the identifier (e.g., address, link, URL, FQDN, and/or other interactable mechanism) is suspicious; and/or performing any other operations of the system 100. In certain embodiments, the computer system 1200 can be configured to assist in training trainable machine learning models (or algorithms) utilized to generate trained machine learning models, determining and/or selecting an optimal machine learning model from the trained machine learning models to determine whether an identifier is suspicious or not suspicious, executing the optimal machine learning model to determine whether the identifier is suspicious, preventing and/or enabling access to a resource attempting to be accessed by a device based on the suspiciousness determination, training the optimal machine learning model and/or other trained and/or trainable machine learning models (or algorithms) supporting the functionality of the machine learning model, performing any other operations, or a combination thereof.

In certain embodiments, the computer system 1200 can be configured to assist in further functionality of the present disclosure. For example, the computer system 1200 can be configured to assist with initiating the triggering of a training process to train trainable machine learning models, trained machine learning models, or a combination thereof. In certain embodiments, the computer system 1200 can be configured to assist with obtaining a labeled dataset(s) that include labeled samples that have been verified as suspicious or non-suspicious. In certain embodiments, the computer system 1200 can be configured to assist with performing any type of sampling technique to sample the suspicious samples and non-suspicious samples over a period of time, such as based on a sampling weight computed based on a configuration specified to generate a balanced labeled dataset. In certain embodiments, the computer system 1200 can be configured to assist with merge the first set of suspicious samples and the second set of non-suspicious samples to create the balanced labeled dataset. In certain embodiments, the computer system 1200 can be configured to generate categorized labeled samples from the balanced labeled dataset, such as based on a constraint to preserve a ratio (e.g., suspicious to non-suspicious ratio) for each of the categories resulting from the categorizing (e.g., training samples, validation samples, testing samples, etc.). In certain embodiments, the computer system 1200 can be configured to training, such as by utilizing features extracted from the categorized labeled samples machine learning models to determine whether an identifier is suspicious.

In some embodiments, the machine can operate as a standalone device. In some embodiments, the machine can be connected (e.g., using communications network 135, another network, or a combination thereof) to and assist with operations performed by other machines and systems, such as, but not limited to, the first user device 102, the second user device 122, the communications network 133, the communications network 135, the server 140, the server 145, the server 150, the server 160, edge devices 120, 132, the database 155, the PCP classifier 202, the PCP database 204, the automated suspicious detection system 206, the inference pipeline service 208, the training pipeline service 210, any other system, program, and/or device, or any combination thereof. The machine can be connected with any component in the system 100. In a networked deployment, the machine can operate in the capacity of a server or a client user machine in a server-client user network environment, or as a peer machine in a peer-to-peer (or distributed) network environment. The machine can comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1200 can include a processor 1202 (e.g., a central processing unit (CPU), a graphics processing unit (GPU, or both), a main memory 1204 and a static memory 1206, which communicate with each other via a bus 1208. The computer system 1200 can further include a video display unit 1210, which can be, but is not limited to, a liquid crystal display (LCD), a flat panel, a solid-state display, or a cathode ray tube (CRT). The computer system 1200 can include an input device 1212, such as, but not limited to, a keyboard, a cursor control device 1214, such as, but not limited to, a mouse, a disk drive unit 1216, a signal generation device 1218, such as, but not limited to, a speaker or remote control, and a network interface device 1220.

The disk drive unit 1216 can include a machine-readable medium 1222 on which is stored one or more sets of instructions 1224, such as, but not limited to, software embodying any one or more of the methodologies or functions described herein, including those methods illustrated above. The instructions 1224 can also reside, completely or at least partially, within the main memory 1204, the static memory 1206, or within the processor 1202, or a combination thereof, during execution thereof by the computer system 1200. The main memory 1204 and the processor 1202 also can constitute machine-readable media.

Dedicated hardware implementations including, but not limited to, application specific integrated circuits, programmable logic arrays and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1222 containing instructions 1224 so that a device connected to the communications network 133, the communications network 135, another network, or a combination thereof, can send or receive voice, video or data, and communicate over the communications network 135, another network, or a combination thereof, using the instructions. The instructions 1224 can further be transmitted or received over the communications network 133, the communications network 135, another network, or a combination thereof, via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” can be non-transitory, and, in certain embodiments, cannot include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements can be utilized and derived therefrom, such that structural and logical substitutions and changes can be made without departing from the scope of this disclosure. Figures are also merely representational and cannot be drawn to scale. Certain proportions thereof can be exaggerated, while others can be minimized. Accordingly, the specification and drawings are to be regarded in an illustrative rather than a restrictive sense.

Thus, although specific arrangements have been illustrated and described herein, it should be appreciated that any arrangement calculated to achieve the same purpose can be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and can be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
a memory storing instructions; and
a processor configured to execute the instructions to cause the processor to be configured to:
initiate, based on triggering of a training process, training of a trainable machine learning model;
obtain, during the training process, a labeled dataset comprising labeled samples verified as either suspicious samples or non-suspicious samples;
compute, based on a configuration to facilitate generation of a balanced labeled dataset, a sampling weight for the suspicious samples and the non-suspicious samples;
perform, based on the sampling weight, sampling for the suspicious samples and the non-suspicious samples over a time period to provide a first set suspicious samples and a second set of non-suspicious samples;
merge the first set of suspicious samples and the second set of non-suspicious samples to form the balanced labeled dataset;
generate categorized balanced labeled samples from the balanced labeled dataset; and
train, by utilizing the categorized balanced labeled samples from the balanced labeled dataset, the trainable machine learning model to generate a trained machine learning model for identifying whether identifiers are suspicious.

2. The system of claim 1, wherein the processor is further configured to:
modify the configuration to create a modified configuration; and
compute a new sampling weight for use in sampling based on the modified configuration.

3. The system of claim 2, wherein the processor is further configured to:
specify at least one split ratio for samples to be split from the balanced labeled dataset; and
split the samples from the balanced labeled dataset in accordance with the at least one split ratio.

4. The system of claim 1, wherein the processor is further configured to:
receive an indication of a storage location to obtain the labeled dataset and when to initiate and terminate sampling of the labeled dataset; and
obtain the labeled dataset from the storage location.

5. The system of claim 1, wherein the processor is further configured to:
define the configuration to facilitate generation of the balanced labeled dataset, wherein the configuration specifies a minimum sample size, a maximum sample size, a required fraction of suspicious samples for the balanced labeled dataset, a required split ratio for categorized balanced labeled datasets to be split from the balanced labeled dataset, a time period, or a combination thereof.

6. The system of claim 1, wherein the processor is further configured to persist the non-suspicious samples and the suspicious samples in a storage location.

7. The system of claim 1, wherein the configuration specifies a required fraction of suspicious samples, and wherein the sampling weight corresponds to the required fraction of suspicious samples.

8. The system of claim 1, wherein the processor is further configured to:
determine whether the sampling over the time period fails to satisfy a minimum sample size requirement associated with the configuration; and
perform, if the sampling over the time period fails to satisfy the minimum sample size requirement, an additional sampling over a different time period greater than the time period for the suspicious samples and the non-suspicious sample, from a third-party database, from a crowdsourced database, or a combination thereof.

9. The system of claim 1, wherein the processor is further configured to:
generate the categorized balanced labeled samples from the balanced labeled dataset by splitting the balanced labeled dataset into categories of samples, wherein the categories of samples are split from the balanced labeled dataset in accordance with a constraint of preserving a suspicious to non-suspicious ratio.

10. The system of claim 9, wherein the processor is further configured to preserve the suspicious to non-suspicious ratio by utilizing at least one sampling technique.

11. The system of claim 1, wherein the processor is further configured to persist the categorized balanced labeled samples from the balanced labeled dataset into a sample store accessible by a feature extractor configured to extract features from the categorized balanced labeled samples to train the trainable machine learning model.

12. The system of claim 1, wherein the processor is further configured to:
obtain an updated labeled dataset; and
rebalance the balanced labeled dataset based on the updated labeled dataset.

13. A method, comprising:
initiating training of a trainable machine learning model;
obtaining, during the training, a labeled dataset comprising labeled samples verified as either suspicious samples or non-suspicious samples;
computing, based on a configuration to facilitate generation of a balanced labeled dataset and by utilizing instructions from a memory that are executed by a processor, a sampling weight for the suspicious samples and the non-suspicious samples;
performing, based on the sampling weight, sampling for the suspicious samples and the non-suspicious samples over a time period to provide a first set of suspicious samples and a second set of non-suspicious samples;
combining the first set of suspicious samples and the second set of non-suspicious samples to form the balanced labeled dataset;
generating categorized balanced labeled samples from the balanced labeled dataset; and
training, by utilizing the categorized balanced labeled samples from the balanced labeled dataset, the trainable machine learning model to generate a trained machine learning model for identifying whether identifiers are suspicious.

14. The method of claim 13, further comprising:
determining whether a performance of the trained machine learning model satisfies a required expectation; and
triggering, if the performance does not satisfy the required expectation, additional training for the trained machine learning model until the performance satisfies the required expectation.

15. The method of claim 13, further comprising specifying a minimum sample size, a maximum sample size, a fraction of suspicious samples, a time period, or a combination thereof, for the configuration.

16. The method of claim 13, further comprising grouping suspicious samples and the non-suspicious samples from the labeled dataset into separate storage locations.

17. The method of claim 13, wherein the categorized balanced labeled samples are split from the balanced labeled dataset in accordance with a constraint of preserving a suspicious to non-suspicious ratio.

18. The method of claim 13, further comprising determining whether the labeled samples from the labeled dataset are imbalanced.

19. The method of claim 13, further comprising performing the sampling by utilizing a sampling technique.

20. A system, comprising:
a memory storing instructions; and
a processor configured to execute the instructions to cause the processor to be configured to:
trigger training of a trainable machine learning model;
obtain, in response to the triggering, a labeled dataset comprising labeled samples verified as either suspicious samples or non-suspicious samples;
calculate, based on a configuration to facilitate generation of a balanced labeled dataset, a sampling weight for the suspicious samples and the non-suspicious samples;
conduct, based on the sampling weight, sampling for the suspicious samples and the non-suspicious samples over a time period to provide a first set of suspicious samples and a second set of non-suspicious samples;
combine the first set of suspicious samples and the second set of non-suspicious samples to form the balanced labeled dataset;
generate categorized balanced labeled samples from the balanced labeled dataset; and
train, by utilizing the categorized balanced labeled samples from the balanced labeled dataset, the trainable machine learning model to generate a trained machine learning model for identifying whether identifiers are suspicious.
